(19) United States
(12) Patent Application Publication
(10) Pub. No.: US 2014/0274823 A1
(43) Pub. Date: Sep. 18, 2014

(54) HYDROCARBON REMOVAL COMPOSITIONS AND METHODS OF USE

(71) Applicant: U.S. O'Neill Industries, Inc., Cantonment, FL (US)

(72) Inventor: Anthony Westenberg, Cantonment, FL (US)

(73) Assignee: U.S. O'Neill Industries, Inc., Cantonment, FL (US)

(21) Appl. No.: 14/216,841

(22) Filed: Mar. 17, 2014

Related U.S. Application Data
(60) Provisional application No. 61/801,689, filed on Mar. 15, 2013.
(60) Provisional application No. 61/937,387, filed on Feb. 7, 2014.

(51) Int. Cl. C09K 8/58

(52) U.S. Cl. CPC C09K 8/58
USPC 507/262

(57) ABSTRACT

Hydrocarbon recovery compounds that can be used as flowback agents and other purposes are disclosed. The compounds reduce water blockage when injected into a fractured reservoir. The composition includes a sorbitan emulsifier, ethoxylated wetting agent, and detergent.

### CROSS-REFERENCE TO RELATED APPLICATIONS

The present application claims the benefit of U.S. Provisional Patent Application No. 61/801,689, entitled “Hydrocarbon Removal Compositions and Methods of Use”, filed on Mar. 15, 2013, and U.S. Patent Application No. 61/937,387, filed Feb. 7, 2014, both of which are incorporated herein by reference in their entirety.

### FIELD

The present disclosure relates to hydrocarbon removal compositions for and methods of hydrocarbon removal, including for hydraulic fracturing, flowback, guar slurry, and tar sand applications.

### BACKGROUND

Fluids uses in the removal of hydrocarbons during various stages of extraction are of increasing importance in the energy industry. During primary recovery, hydrocarbons are placed under pressure and forced to the top of a reservoir. Typically, less than 20% of hydrocarbons are recovered during primary recovery. Secondary recovery methods recover hydrocarbons either by external pumping or by injecting liquid or gas fluids to add pressure to the wellbore and force out hydrocarbons. Recovery after primary and secondary extraction methods, however, is typically limited to recovery of less than 50% of the hydrocarbons.

Tertiary recovery of hydrocarbon extraction provides substantially increased recovery of remaining hydrocarbons. Often this is accomplished by hydraulic fracturing. In hydraulic fracturing, a portion of the strata surrounding the wellbore is fractured using a combination of fracturing fluids, water, and proppants. The hydrocarbons can then be removed by using a flowback agent. To be most effective, fracturing fluids maintain their chemical compositions at high temperatures, pump rates, and/or shear rates to prevent or limit premature degradation. For efficient removal, the fluids can assess hydrocarbons in the wellbore. Often, these fluids often leave behind substantial polymer residue which is not only a contaminant but causes fracture conductivity loss.

There is an increased need for biodegradable compounds that can be used in hydrocarbon removal, especially in tertiary recovery methods. Conventional fracturing components are not biodegradable, which results in the possibility (whether real or perceived) that ground water can be contaminated. Often, conventional fracturing technologies do not allow hydrocarbons to be removed from a formation because aqueous solutions block the flow path between the hydrocarbon and the wellbore. Moreover, conventional fracturing technologies often include emulsifiers that do not provide for the easy release of hydrocarbons from an emulsion, resulting in reduced hydrocarbon recovery and increased potential for ground water contamination. Additional fracturing components, such as polymers, can remain in a bore hole, and also become exposed to ground water.

These and other problems with conventional removal systems are solved by the presently disclosed compounds.

### SUMMARY

In one aspect, the present disclosure is directed to a hydrocarbon removal composition comprising a sorbitan emulsifier, an ethoxylated wetting agent, and a detergent. The composition can further include water. The compositions can be provided in various combinations and quantities of components as described herein.

In various aspects, the hydrocarbon removal compositions can be combined with viscosity compounds such as guar to form a guar slurry. The hydrocarbon removal compositions can also be used as flowback agents, or combined with tar sands to remove tar.

Various specific aspects of the hydrocarbon removal compositions and their uses are described herein.

### BRIEF DESCRIPTION OF THE DRAWINGS

FIGS. 1A-1F depicts rheometric viscosity vs. time graphs for the samples tested according to Example 2.

FIG. 2A depicts a total ion current trace showing the approximate quantity of compounds being desorbed from a virgin sand sample with time (temperature).

FIG. 2B depicts a mass spectrum of the sample of FIG. 1A at 0 to 1 minutes in the heating cycle.

FIG. 2C depicts a mass spectrum of the sample of FIG. 1A at 1 to 2 minutes in the heating cycle.

FIG. 2D depicts a mass spectrum of the sample of FIG. 1A at 2 to 3 minutes in the heating cycle.

FIG. 3A depicts a total ion current trace showing the approximate quantity of compounds being desorbed from a contaminated sand sample with time (temperature).

FIG. 3B depicts a mass spectrum of the sample of FIG. 2A at 0 to 1 minutes in the heating cycle.

FIG. 3C depicts a mass spectrum of the sample of FIG. 2A at 1 to 2 minutes in the heating cycle.

FIG. 3D depicts a mass spectrum of the sample of FIG. 2A at 2 to 3 minutes in the heating cycle.

FIG. 4A depicts a total ion current trace showing the approximate quantity of compounds being desorbed from a partially cleaned sand sample with time (temperature).

FIG. 4B depicts a mass spectrum of the sample of FIG. 3A at 0 to 1 minutes in the heating cycle.

FIG. 4C depicts a mass spectrum of the sample of FIG. 3A at 1 to 2 minutes in the heating cycle.

FIG. 4D depicts a mass spectrum of the sample of FIG. 3A at 2 to 3 minutes in the heating cycle.

FIG. 5A depicts a total ion current trace showing the approximate quantity of compounds being desorbed from a further cleaned sand sample with time (temperature).

FIG. 5B depicts a mass spectrum of the sample of FIG. 4A at 0 to 1 minutes in the heating cycle.

FIG. 5C depicts a mass spectrum of the sample of FIG. 4A at 1 to 2 minutes in the heating cycle.

FIG. 5D is a mass spectrum of the sample of FIG. 4A at 2 to 3 minutes in the heating cycle.

FIG. 6 shows the results of direct probe mass spectrometry analysis of an exemplary hydrocarbon removal composition according to Example 3C.

FIG. 6A is a total ion current trace showing the approximate quantity of compounds acquired from sand using an exemplary hydrocarbon removal composition with time (temperature).

FIG. 6B is a mass spectrum of the sample of FIG. 5A at 0 to 1 minutes in the heating cycle.

FIG. 6C is a mass spectrum of the sample of FIG. 5A at 1 to 2 minutes in the heating cycle.

FIG. 6D is a mass spectrum of the sample of FIG. 5A at 2 to 3 minutes in the heating cycle.

### DETAILED DESCRIPTION

The present disclosure provides hydrocarbon removal compositions and methods that result in improved recovery of hydrocarbons in a variety of contexts.

Hydraulic fracturing is a technique used to stimulate productivity in a well. A hydraulic fracture is a superimposed structure that remains undisturbed outside of the fracture, so the effective permeability of a reservoir remains unchanged by this process. The increased wellbore radius increases its productivity, because a large contact surface between the well and the reservoir is created.

The presently disclosed hydrocarbon removal compositions are directed to the combination of components that can be used to recover hydrocarbons in surprisingly higher quantities than by previously known compositions and methods. Hydrocarbons can be released from inaccessible formations and systems, including fracture formations and tar sands. In fracture formations, the hydrocarbon removal composition can be used in combination with guar or other viscosity agents during introduction of proppants as a flowback agent. Previous efforts have not combined a guar slurry with a flowback agent. In various embodiments, the hydrocarbon removal compositions and methods do not introduce toxic compounds to hydrocarbon-containing wells, and meet government specifications for ground water contamination. As a result, the hydrocarbon removal compositions and methods described herein provide for improved hydrocarbon recovery while protecting ground water safety and purity.

### Hydrocarbon Removal Compositions

The hydrocarbon removal compositions disclosed herein include a sorbitan emulsifier, an ethoxylated wetting agent, and a detergent. The combination of components provides improved ability to dissolve and deliver hydrocarbons for recovery in greater quantities, at increased efficiency, and with increased purity what has been previously developed in the art.

The present hydrocarbon removal compositions use interspatial colloidal interference surface technology (ICIS) to remove hydrocarbons from surfaces and enhance flowback capabilities. In various embodiments, the hydrocarbon removal compositions have low emulsification rate (i.e. form imperfect emulsions). The emulsion rate allows hydrocarbons, such as oil or petroleum products, to release from emulsion without adding additional steps to recover or treat the hydrocarbon. Further, detergents adsorb onto the surface of the soil, sand, or proppant particles, creating a negative charge on both surfaces causing electrostatic repulsion, preventing redepositing of hydrocarbons. Non-ionic surface active agents adsorb onto the contaminants surface, long ethoxylated chains extend into the water phase to prevent contaminant particles from unifying by steric hindrance. The wettability conferred by the ethoxylated wetting agent allows entry into pores and fissures of surfaces that are otherwise inaccessible to aqueous media. This allows further recovery of hydrocarbons.

Unlike other compounds used in fracturing methods, the disclosed hydrocarbon removal compositions are biodegradable. As such, the hydrocarbon removal compositions described herein address substantial limitations of conventional hydrocarbon recovery components, including conventional compounds used in hydrocarbon recovery. The hydrocarbon removal composition components are separately and collectively capable of meeting government clean water standards.

The present compositions meet clean water standards. For example, the presently disclosed compositions meet Florida clean groundwater requirements of benzene 1 ppb, ethyl benzene 20 ppb, toluene 20 ppb, xylene 20 ppb. When the above levels are achieved, this site is deemed clean.

### Sorbitan Emulsifiers

In various aspects, the presently disclosed hydrocarbon removal composition includes a sorbitan emulsifier.

The sorbitan emulsifier can be any sorbitan emulsifier known in the art. Sorbitan emulsifiers are typically derived from low molecular weight alcohols. In some embodiments, the sorbitan emulsifier is sorbitan polyethoxylate. In some embodiments, the sorbitan emulsifier is isosorbine polyethoxylate. In some embodiments, the sorbitan emulsifier is polysorbate monester (PME). In some embodiments, the sorbitan emulsifier is polysorbate monolaurate. In some embodiments, the sorbitan emulsifier is Protachem SML. In some embodiments, the sorbitan emulsifier is Protachem SMO. In some embodiments, the sorbitan emulsifier is Protachem SMS-NF. In some embodiments, the sorbitan emulsifier is Protachem SMP. In some embodiments, the sorbitan emulsifier is a sorbitan laurate. In some embodiments, the sorbitan emulsifier is Sorbitan oleate such as Tween 80, Tween 20, or Avapol 80. In some embodiments, the sorbitan emulsifier is a sorbitan palmitate. In some embodiments, the sorbitan emulsifier is a orbitan stearate. In some embodiments, the sorbitan emulsifier is a sorbitan sesquioleate. In some embodiments, the sorbitan emulsifier is a sorbitan trioleate. In some embodiments, the sorbitan emulsifier is a sorbitan tristearate.

Ethyoxylated Wetting Agent

In various aspects, the presently disclosed hydrocarbon removal compositions include an ethoxylated wetting agent.

The ethoxylates in the present hydrocarbon removal composition has wetting that reduce the surface tension of an aqueous medium. Without wishing to be limited to any theory or mechanism of action, reduced surface tension allows the hydrocarbon removal composition to access hydrocarbons found in small spaces or fissures that otherwise would not be accessible.

By choosing the presently disclosed wetting agents, additional toxic components do not have to be added to the hydrocarbon removal composition. For example, aluminum hydroxide and/or other contaminants are not required to be added as flocculating agents. The wetting agent thus provides for accessibility of hydrocarbons in underground locations without addition, or with reduced addition, of toxic compounds.

In certain variations, the ethoxylated wetting agent can be an ethoxylated alcohol. In various embodiments, the ethoxylated alcohol is includes a C₉₋₁₁ ethoxylated alcohol. In other embodiments, the ethoxylated alcohol includes a C₁₀₋₁₆ ethoxylated alcohol. In various embodiments, the ethoxylated wetting agent can include a C₉₋₁₂ ethoxylated alcohol. In various embodiments, the ethoxylated wetting agent can include a C₁₀₋₁₆ ethoxylated alcohol In various embodiments, the ethoxylated wetting agent can include both a C₉₋₁₂ ethoxylated alcohol and a C₁₀₋₁₆ ethoxylated alcohol. various other embodiments, the ethoxylated wetting agent is in the ratios described herein. It will be understood that an ethoxylated wetting agent can include more than one component, or ethoxylated component.

The ethoxylated wetting agent can be any ethoxylated wetting agent known in the art. In some embodiments, the ethoxylated wetting agent is Dyno 607. In some embodiments, the ethoxylated wetting agent is Surfynol 420. In some embodiments, the ethoxylated wetting agent is Surfynol 440. In some embodiments, the ethoxylated wetting agent is Surfynol 465. In some embodiments, the ethoxylated wetting agent is Surfynol 485. In some embodiments, the ethoxylated wetting agent is Dyno 604. In some embodiments, the ethoxylated wetting agent is Tomadol 91-2.5. In some embodiments, the ethoxylated wetting agent is Tomadol 91-6. In some embodiments, the ethoxylated wetting agent is Tomadol 91-8. In some embodiments, the ethoxylated wetting agent is Tomadol 1-3. In some embodiments, the ethoxylated wetting agent is Tomadol 1-5. In some embodiments, the ethoxylated wetting agent is Tomadol 1-7. In some embodiments, the ethoxylated wetting agent is Tomadol 1-73B. In some embodiments, the ethoxylated wetting agent is Tomadol 1-9. In some embodiments, the ethoxylated wetting agent is Tomadol 23-1. In some embodiments, the ethoxylated wetting agent is Tomadol 23-3. In some embodiments, the ethoxylated wetting agent is Tomadol 23-5. In some embodiments, the ethoxylated wetting agent is Tomadol 23-6.5. In some embodiments, the ethoxylated wetting agent is Tomadol 25-3. In some embodiments, the ethoxylated wetting agent is Tomadol 25-7. In some embodiments, the ethoxylated wetting agent is Tomadol 25-9. In some embodiments, the ethoxylated wetting agent is Tomadol 25-12. In some embodiments, the ethoxylated wetting agent is Tomadol 45-7. In some embodiments, the ethoxylated wetting agent is Tomadol 45-13. In some embodiments, the ethoxylated wetting agent is Triton X-207. In some embodiments, the ethoxylated wetting agent is Triton CA. In some embodiments, the ethoxylated wetting agent is Plurafac S305LF. In some embodiments, the ethoxylated wetting agent is Plurafac S505LF. In some embodiments, the ethoxylated wetting agent is Plurafac SL 62. In some embodiments, the ethoxylated wetting agent is Plurafac SL 92. In some embodiments, the ethoxylated wetting agent is Plurafac SL-22. In some embodiments, the ethoxylated wetting agent is Plurafac SL-42. In some embodiments, the ethoxylated wetting agent is Plurafac SLF 37. In some embodiments, the ethoxylated wetting agent is Plurafac SLF-18. In some embodiments, the ethoxylated wetting agent is Plurafac SLF-18B-45. In some embodiments, the ethoxylated wetting agent is Plurafac L1220. In some embodiments, the ethoxylated wetting agent is Pluronic 10R5. In some embodiments, the ethoxylated wetting agent is Pluronic 17R2. In some embodiments, the ethoxylated wetting agent is Pluronic 17R4. In some embodiments, the ethoxylated wetting agent is Pluronic 25R2. In some embodiments, the ethoxylated wetting agent is Pluronic 25R4. In some embodiments, the ethoxylated wetting agent is Pluronic 31R1. In some embodiments, the ethoxylated wetting agent is Pluronic F108. In some embodiments, the ethoxylated wetting agent is Pluronic F108NF. In some embodiments, the ethoxylated wetting agent is Pluronic F108 NF PRILL. In some embodiments, the ethoxylated wetting agent is Pluronic F108. In some embodiments, the ethoxylated wetting agent is Pluronic F127. In some embodiments, the ethoxylated wetting agent is Pluronic F127 NF PRILL. In some embodiments, the ethoxylated wetting agent is Pluronic F127NF 500BHT. In some embodiments, the ethoxylated wetting agent is Pluronic F38. In some embodiments, the ethoxylated wetting agent is Pluronic F68 LF. In some embodiments, the ethoxylated wetting agent is Pluronic F68. In some embodiments, the ethoxylated wetting agent is Pluronic F77. In some embodiments, the ethoxylated wetting agent is Pluronic F-77 micro-pastille. In some embodiments, the ethoxylated wetting agent is Pluronic F87. In some embodiments, the ethoxylated wetting agent is Pluronic F88. In some embodiments, the ethoxylated wetting agent is Pluronic F98. In some embodiments, the ethoxylated wetting agent is Pluronic L10. In some embodiments, the ethoxylated wetting agent is Pluronic L101. In some embodiments, the ethoxylated wetting agent is Pluronic L121. In some embodiments, the ethoxylated wetting agent is Pluronic L31. In some embodiments, the ethoxylated wetting agent is Pluronic L92. In some embodiments, the ethoxylated wetting agent is Pluronic N-3. In some embodiments, the ethoxylated wetting agent is Pluronic P103. In some embodiments, the ethoxylated wetting agent is Pluronic P105. In some embodiments, the ethoxylated wetting agent is Pluronic P123. In some embodiments, the ethoxylated wetting agent is Pluronic P65. In some embodiments, the ethoxylated wetting agent is Pluronic P84. In some embodiments, the ethoxylated wetting agent is Pluronic P85. In some embodiments, the ethoxylated wetting agent is Tetronic 1107 micro-pastile. In some embodiments, the ethoxylated wetting agent is Tetronic 1107. In some embodiments, the ethoxylated wetting agent is Tetronic 1301. In some embodiments, the ethoxylated wetting agent is Tetronic 1304. In some embodiments, the ethoxylated wetting agent is Tetronic 1307. In some embodiments, the ethoxylated wetting agent is Tetronic 1307. In some embodiments, the ethoxylated wetting agent is Tetronic 150R1. In some embodiments, the ethoxylated wetting agent is Tetronic 304. In some embodiments, the ethoxylated wetting agent is Tetronic 701. In some embodiments, the ethoxylated wetting agent is Tetronic 901. In some embodiments, the ethoxylated wetting agent is Tetronic 904. In some embodiments, the ethoxylated wetting agent is Tetronic 908. In some embodiments, the ethoxylated wetting agent is and Tetronic 908 pastille. In some embodiments, the ethoxylated wetting agent is Tomadol 1200. In some embodiments, the ethoxylated wetting agent is T Det A 267. In some embodiments, the ethoxylated wetting agent is Ecosurf SA-9. In some embodiments, the ethoxylated wetting agent is Ecosurf SA-7. In some embodiments, the ethoxylated wetting agent is a mixture of any of the foregoing.

It will be understood that any of the separately articulated ethoxylated wetting agents listed above can be combined with any component, in any proportion, as recited herein.

Detergents

In various embodiments, the presently disclosed hydrocarbon removal compositions include a detergent. Unlike anionic surfactants that are incompatible with brine solutions, the presently disclosed hydrocarbon removal compositions are compatible. The presently disclosed hydrocarbon removal compositions were tested in a 2% KCL solution with no compatibility issues.

Examples of detergents include but are not restricted to sodium lauryl sulfate, sodium lauryl ether sulfates, sodium octyl sulfosuccinate, di sodium octyl sulfosuccinate, sodium oleyl ether carboxylates, sodium lauryl carboxylates, cocoamidopropyl betaine, cocodimethyl betaine, oleylamidopropyl betaine, oleyl dimethyl betaine, erucylamidopropyl betaine, erucyldimethyl betaine, lauryl amine oxide, myristyl amine oxide, oleyl amine oxide, erucyl amine oxide, sulfosuccinate esters, naphthalene succinate, alkyl sulfonate, linear alkylbenzene sulfonate, and a branched alkylbenzene sulfonate.

In some more specific embodiments, the detergent is a linear alkylbenzene sulfonate. selected from Calimulse PRS, Witconate P-1059, Calimulse PR. In some more specific embodiments, the detergent is Calimulse PR. In other specific embodiments, the detergent is Calimulse PRS. Ecosurf

In various aspects, the detergent is a linear sulfonated alkylbenzene or a non-linear sulfonated alkylbenzene. Linear sulfonated alkyl benzenes can be used with lower API gravity hydrocarbons. A branched alkylbenzene sulfonate (BAS) are “hard”, or slowly degraded by microorganisms. Linear alkylbenzene sulfonate (LAS) are “soft”, or quickly degraded (less than 28 days) by microorganisms. LAS also have a higher boiling point and are shown to be less toxic to both aquatic organisms and humans.

Linear alkylbenzene sulfonate can be prepared by several methods based on the reaction of an alpha olefin (i.e., R—CH═CH₂) with benzene, in the presence of sulphuric acid (SO₃), with or without a catalyst. Sodium hydroxide (NaOH) or some other salt is used to neutralize. In some examples, the linear alkyl benzene is an isopropylamine linear alkylbenzene sulfonate. Commercial examples include Calmulse PRS, Witconate P-1059, and Calmulse PR. It will be understood that any one of the foregoing can be selected. Branched alkylbenzene structures (ABS) can also be prepared by several methods. These include the reaction of propylene (CH₃CH:CH₂) oligomers with benzene, or CH₃—(CH) 11-phenol ring, in the presence of sulphuric acid (SO₃), with or without a catalyst. Sodium hydroxide (NaOH) or some other salt can be used to neutralize.

Without being limited to any mechanism or mode of action, various detergents form unstable emulsions when combined with hydrocarbons. The detergents dissociate almost completely up to the critical micelle concentration. At or above the critical micelle concentration, the detergent exists in micelle form and the counter ions are somewhat associated. LAS and BAS detergents form micelles with an apolar core of alkyl tails and a surface consisting of sulfonate groups, thus rendering the surface negatively charged. Counterions are attracted by this negatively charged layer, thereby forming a now positively charged layer around the micelle (electronic double layer). Semi-dissociation is observed for the LAS and BAS substances in aqueous solution above the critical micelle concentration. As such, LAS and BAS can dissolve hydrocarbons, and instead of retaining hydrocarbons in an emulsion, release the hydrocarbons into a well. The compositions thus facilitate the formation of imperfect emulsions that enable capture of hydrocarbons and release to the surface.

Similarly, the hydrocarbon removal compositions disclosed herein are capable of removing more hydrocarbons from sand or other proppant particles than other compositions. The hydrocarbon removal compositions mix with water on the sand grain. The sand carries a slightly negative charge, and the hydrocarbon dissolving agent is negatively charged. Because the hydrocarbon removal compositions have reduced surface tension, the sand particle and hydrocarbon dissolving agent repel each other. The hydrocarbons are thereby removed efficiently.

In some variations, the hydrocarbon removal composition includes Sorbitan oleate, Dyno 607, and sodium lauryl sulfate. In some variations, the hydrocarbon removal composition includes Sorbitan oleate, Dyno 607, and sodium lauryl ether sulfates. In some variations, the hydrocarbon removal composition includes Sorbitan oleate, Dyno 607, and sodium octyl sulfosuccinate. In some variations, the hydrocarbon removal composition includes Sorbitan oleate, Dyno 607, and di sodium octyl sulfosuccinate. In some variations, the hydrocarbon removal composition includes Sorbitan oleate, Dyno 607, and sodium oleyl ether carboxylates. In some variations, the hydrocarbon removal composition includes Sorbitan oleate, Dyno 607, and alkyl sulfonate. In some variations, the hydrocarbon removal composition includes Sorbitan oleate, Dyno 607, and linear alkylbenzene sulfonate. In some variations, the hydrocarbon removal composition includes Sorbitan oleate, Dyno 607, and a branched alkylbenzene sulfonate. In some variations, the hydrocarbon removal composition includes Sorbitan oleate, Dyno 607, and a linear alkylbenzene sulfonate. In some variations, the hydrocarbon removal composition includes Sorbitan oleate, Dyno 607, and Calimulse PRS. In some variations, the hydrocarbon removal composition includes Sorbitan oleate, Dyno 607, and Calimulse PR. In some variations, the hydrocarbon removal composition includes Sorbitan oleate, Dyno 607, and Witconate P-1059. In some variations, the hydrocarbon removal composition includes Sorbitan oleate, Surfynol 420, and sodium lauryl sulfate. In some variations, the hydrocarbon removal composition includes Sorbitan oleate, Surfynol 420, and sodium lauryl ether sulfates. In some variations, the hydrocarbon removal composition includes Sorbitan oleate, Surfynol 420, and sodium octyl sulfosuccinate. In some variations, the hydrocarbon removal composition includes Sorbitan oleate, Surfynol 420, and di sodium octyl sulfosuccinate. In some variations, the hydrocarbon removal composition includes Sorbitan oleate, Surfynol 420, and sodium oleyl ether carboxylates. In some variations, the hydrocarbon removal composition includes Sorbitan oleate, Surfynol 420, and alkyl sulfonate. In some variations, the hydrocarbon removal composition includes Sorbitan oleate, Surfynol 420, and linear alkylbenzene sulfonate. In some variations, the hydrocarbon removal composition includes Sorbitan oleate, Surfynol 420, and a branched alkylbenzene sulfonate. In some variations, the hydrocarbon removal composition includes Sorbitan oleate, Surfynol 420, and a linear alkylbenzene sulfonate. In some variations, the hydrocarbon removal composition includes Sorbitan oleate, Surfynol 420, and Calimulse PRS. In some variations, the hydrocarbon removal composition includes Sorbitan oleate, Surfynol 420, and Calimulse PR. In some variations, the hydrocarbon removal composition includes Sorbitan oleate, Surfynol 420, and Witconate P-1059. In some variations, the hydrocarbon removal composition includes Sorbitan oleate, Surfynol 440, and sodium lauryl sulfate. In some variations, the hydrocarbon removal composition includes Sorbitan oleate, Surfynol 440, and sodium lauryl ether sulfates. In some variations, the hydrocarbon removal composition includes Sorbitan oleate, Surfynol 440, and sodium octyl sulfosuccinate. In some variations, the hydrocarbon removal composition includes Sorbitan oleate, Surfynol 440, and di sodium octyl sulfosuccinate. In some variations, the hydrocarbon removal composition includes Sorbitan oleate, Surfynol 440, and sodium oleyl ether carboxylates. In some variations, the hydrocarbon removal composition includes Sorbitan oleate, Surfynol 440, and alkyl sulfonate. In some variations, the hydrocarbon removal composition includes Sorbitan oleate, Surfynol 440, and linear alkylbenzene sulfonate. In some variations, the hydrocarbon removal composition includes Sorbitan oleate, Surfynol 440, and a branched alkylbenzene sulfonate. In some variations, the hydrocarbon removal composition includes Sorbitan oleate, Surfynol 440, and a linear alkylbenzene sulfonate. In some variations, the hydrocarbon removal composition includes Sorbitan oleate, Surfynol 440, and Calimulse PRS. In some variations, the hydrocarbon removal composition includes Sorbitan oleate, Surfynol 440, and Calimulse PR. In some variations, the hydrocarbon removal composition includes Sorbitan oleate, Surfynol 440, and Witconate P-1059. In some variations, the hydrocarbon removal composition includes Sorbitan oleate, Surfynol 465, and sodium lauryl sulfate. In some variations, the hydrocarbon removal composition includes Sorbitan oleate, Surfynol 465, and sodium lauryl ether sulfates. In some variations, the hydrocarbon removal composition includes Sorbitan oleate, Surfynol 465, and sodium octyl sulfosuccinate. In some variations, the hydrocarbon removal composition includes Sorbitan oleate, Surfynol 465, and di sodium octyl sulfosuccinate. In some variations, the hydrocarbon removal composition includes Sorbitan oleate, Surfynol 465, and sodium oleyl ether carboxylates. In some variations, the hydrocarbon removal composition includes Sorbitan oleate, Surfynol 465, and alkyl sulfonate. In some variations, the hydrocarbon removal composition includes Sorbitan oleate, Surfynol 465, and linear alkylbenzene sulfonate. In some variations, the hydrocarbon removal composition includes Sorbitan oleate, Surfynol 465, and a branched alkylbenzene sulfonate. In some variations, the hydrocarbon removal composition includes Sorbitan oleate, Surfynol 465, and a linear alkylbenzene sulfonate. In some variations, the hydrocarbon removal composition includes Sorbitan oleate, Surfynol 465, and Calimulse PRS. In some variations, the hydrocarbon removal composition includes Sorbitan oleate, Surfynol 465, and Calimulse PR. In some variations, the hydrocarbon removal composition includes Sorbitan oleate, Surfynol 465, and Witconate P-1059. In some variations, the hydrocarbon removal composition includes Sorbitan oleate, Surfynol 485, and sodium lauryl sulfate. In some variations, the hydrocarbon removal composition includes Sorbitan oleate, Surfynol 485, and sodium lauryl ether sulfates. In some variations, the hydrocarbon removal composition includes Sorbitan oleate, Surfynol 485, and sodium octyl sulfosuccinate. In some variations, the hydrocarbon removal composition includes Sorbitan oleate, Surfynol 485, and di sodium octyl sulfosuccinate. In some variations, the hydrocarbon removal composition includes Sorbitan oleate, Surfynol 485, and sodium oleyl ether carboxylates. In some variations, the hydrocarbon removal composition includes Sorbitan oleate, Surfynol 485, and alkyl sulfonate. In some variations, the hydrocarbon removal composition includes Sorbitan oleate, Surfynol 485, and linear alkylbenzene sulfonate. In some variations, the hydrocarbon removal composition includes Sorbitan oleate, Surfynol 485, and a branched alkylbenzene sulfonate. In some variations, the hydrocarbon removal composition includes Sorbitan oleate, Surfynol 485, and a linear alkylbenzene sulfonate. In some variations, the hydrocarbon removal composition includes Sorbitan oleate, Surfynol 485, and Calimulse PRS. In some variations, the hydrocarbon removal composition includes Sorbitan oleate, Surfynol 485, and Calimulse PR. In some variations, the hydrocarbon removal composition includes Sorbitan oleate, Surfynol 485, and Witconate P-1059. In some variations, the hydrocarbon removal composition includes Sorbitan oleate, Dyno 604, and sodium lauryl sulfate. In some variations, the hydrocarbon removal composition includes Sorbitan oleate, Dyno 604, and sodium lauryl ether sulfates. In some variations, the hydrocarbon removal composition includes Sorbitan oleate, Dyno 604, and sodium octyl sulfosuccinate. In some variations, the hydrocarbon removal composition includes Sorbitan oleate, Dyno 604, and di sodium octyl sulfosuccinate. In some variations, the hydrocarbon removal composition includes Sorbitan oleate, Dyno 604, and sodium oleyl ether carboxylates. In some variations, the hydrocarbon removal composition includes Sorbitan oleate, Dyno 604, and alkyl sulfonate. In some variations, the hydrocarbon removal composition includes Sorbitan oleate, Dyno 604, and linear alkylbenzene sulfonate. In some variations, the hydrocarbon removal composition includes Sorbitan oleate, Dyno 604, and a branched alkylbenzene sulfonate. In some variations, the hydrocarbon removal composition includes Sorbitan oleate, Dyno 604, and a linear alkylbenzene sulfonate. In some variations, the hydrocarbon removal composition includes Sorbitan oleate, Dyno 604, and Calimulse PRS. In some variations, the hydrocarbon removal composition includes Sorbitan oleate, Dyno 604, and Calimulse PR. In some variations, the hydrocarbon removal composition includes Sorbitan oleate, Dyno 604, and Witconate P-1059. In some variations, the hydrocarbon removal composition includes Sorbitan oleate, Tomadol 91-2.5, and sodium lauryl sulfate. In some variations, the hydrocarbon removal composition includes Sorbitan oleate, Tomadol 91-2.5, and sodium lauryl ether sulfates. In some variations, the hydrocarbon removal composition includes Sorbitan oleate, Tomadol 91-2.5, and sodium octyl sulfosuccinate. In some variations, the hydrocarbon removal composition includes Sorbitan oleate, Tomadol 91-2.5, and di sodium octyl sulfosuccinate. In some variations, the hydrocarbon removal composition includes Sorbitan oleate, Tomadol 91-2.5, and sodium oleyl ether carboxylates. In some variations, the hydrocarbon removal composition includes Sorbitan oleate, Tomadol 91-2.5, and alkyl sulfonate. In some variations, the hydrocarbon removal composition includes Sorbitan oleate, Tomadol 91-2.5, and linear alkylbenzene sulfonate. In some variations, the hydrocarbon removal composition includes Sorbitan oleate, Tomadol 91-2.5, and a branched alkylbenzene sulfonate. In some variations, the hydrocarbon removal composition includes Sorbitan oleate, Tomadol 91-2.5, and a linear alkylbenzene sulfonate. In some variations, the hydrocarbon removal composition includes Sorbitan oleate, Tomadol 91-2.5, and Calimulse PRS. In some variations, the hydrocarbon removal composition includes Sorbitan oleate, Tomadol 91-2.5, and Calimulse PR. In some variations, the hydrocarbon removal composition includes Sorbitan oleate, Tomadol 91-2.5, and Witconate P-1059. In some variations, the hydrocarbon removal composition includes Sorbitan oleate, Tomadol 91-6, and sodium lauryl sulfate. In some variations, the hydrocarbon removal composition includes Sorbitan oleate, Tomadol 91-6, and sodium lauryl ether sulfates. In some variations, the hydrocarbon removal composition includes Sorbitan oleate, Tomadol 91-6, and sodium octyl sulfosuccinate. In some variations, the hydrocarbon removal composition includes Sorbitan oleate, Tomadol 91-6, and di sodium octyl sulfosuccinate. In some variations, the hydrocarbon removal composition includes Sorbitan oleate, Tomadol 91-6, and sodium oleyl ether carboxylates. In some variations, the hydrocarbon removal composition includes Sorbitan oleate, Tomadol 91-6, and alkyl sulfonate. In some variations, the hydrocarbon removal composition includes Sorbitan oleate, Tomadol 91-6, and linear alkylbenzene sulfonate. In some variations, the hydrocarbon removal composition includes Sorbitan oleate, Tomadol 91-6, and a branched alkylbenzene sulfonate. In some variations, the hydrocarbon removal composition includes Sorbitan oleate, Tomadol 91-6, and a linear alkylbenzene sulfonate. In some variations, the hydrocarbon removal composition includes Sorbitan oleate, Tomadol 91-6, and Calimulse PRS. In some variations, the hydrocarbon removal composition includes Sorbitan oleate, Tomadol 91-6, and Calimulse PR. In some variations, the hydrocarbon removal composition includes Sorbitan oleate, Tomadol 91-6, and Witconate P-1059. In some variations, the hydrocarbon removal composition includes Sorbitan oleate, Tomadol 91-8, and sodium lauryl sulfate. In some variations, the hydrocarbon removal composition includes Sorbitan oleate, Tomadol 91-8, and sodium lauryl ether sulfates. In some variations, the hydrocarbon removal composition includes Sorbitan oleate, Tomadol 91-8, and sodium octyl sulfosuccinate. In some variations, the hydrocarbon removal composition includes Sorbitan oleate, Tomadol 91-8, and di sodium octyl sulfosuccinate. In some variations, the hydrocarbon removal composition includes Sorbitan oleate, Tomadol 91-8, and sodium oleyl ether carboxylates. In some variations, the hydrocarbon removal composition includes Sorbitan oleate, Tomadol 91-8, and alkyl sulfonate. In some variations, the hydrocarbon removal composition includes Sorbitan oleate, Tomadol 91-8, and linear alkylbenzene sulfonate. In some variations, the hydrocarbon removal composition includes Sorbitan oleate, Tomadol 91-8, and a branched alkylbenzene sulfonate. In some variations, the hydrocarbon removal composition includes Sorbitan oleate, Tomadol 91-8, and a linear alkylbenzene sulfonate. In some variations, the hydrocarbon removal composition includes Sorbitan oleate, Tomadol 91-8, and Calimulse PRS. In some variations, the hydrocarbon removal composition includes Sorbitan oleate, Tomadol 91-8, and Calimulse PR. In some variations, the hydrocarbon removal composition includes Sorbitan oleate, Tomadol 91-8, and Witconate P-1059. In some variations, the hydrocarbon removal composition includes Sorbitan oleate, Tomadol 1200, and sodium lauryl sulfate. In some variations, the hydrocarbon removal composition includes Sorbitan oleate, Tomadol 1200, and sodium lauryl ether sulfates. In some variations, the hydrocarbon removal composition includes Sorbitan oleate, Tomadol 1200, and sodium octyl sulfosuccinate. In some variations, the hydrocarbon removal composition includes Sorbitan oleate, Tomadol 1200, and di sodium octyl sulfosuccinate. In some variations, the hydrocarbon removal composition includes Sorbitan oleate, Tomadol 1200, and sodium oleyl ether carboxylates. In some variations, the hydrocarbon removal composition includes Sorbitan oleate, Tomadol 1200, and alkyl sulfonate. In some variations, the hydrocarbon removal composition includes Sorbitan oleate, Tomadol 1200, and linear alkylbenzene sulfonate. In some variations, the hydrocarbon removal composition includes Sorbitan oleate, Tomadol 1200, and a branched alkylbenzene sulfonate. In some variations, the hydrocarbon removal composition includes Sorbitan oleate, Tomadol 1200, and a linear alkylbenzene sulfonate. In some variations, the hydrocarbon removal composition includes Sorbitan oleate, Tomadol 1200, and Calimulse PRS. In some variations, the hydrocarbon removal composition includes Sorbitan oleate, Tomadol 1200, and Calimulse PR. In some variations, the hydrocarbon removal composition includes Sorbitan oleate, Tomadol 1200, and Witconate P-1059. In some variations, the hydrocarbon removal composition includes Sorbitan oleate, T Det A 267, and sodium lauryl sulfate. In some variations, the hydrocarbon removal composition includes Sorbitan oleate, T Det A 267, and sodium lauryl ether sulfates. In some variations, the hydrocarbon removal composition includes Sorbitan oleate, T Det A 267, and sodium octyl sulfosuccinate. In some variations, the hydrocarbon removal composition includes Sorbitan oleate, T Det A 267, and di sodium octyl sulfosuccinate. In some variations, the hydrocarbon removal composition includes Sorbitan oleate, T Det A 267, and sodium oleyl ether carboxylates. In some variations, the hydrocarbon removal composition includes Sorbitan oleate, T Det A 267, and alkyl sulfonate. In some variations, the hydrocarbon removal composition includes Sorbitan oleate, T Det A 267, and linear alkylbenzene sulfonate. In some variations, the hydrocarbon removal composition includes Sorbitan oleate, T Det A 267, and a branched alkylbenzene sulfonate. In some variations, the hydrocarbon removal composition includes Sorbitan oleate, T Det A 267, and a linear alkylbenzene sulfonate. In some variations, the hydrocarbon removal composition includes Sorbitan oleate, T Det A 267, and Calimulse PRS. In some variations, the hydrocarbon removal composition includes Sorbitan oleate, T Det A 267, and Calimulse PR. In some variations, the hydrocarbon removal composition includes Sorbitan oleate, T Det A 267, and Witconate P-1059. In some variations, the hydrocarbon removal composition includes Sorbitan oleate, Tomadol 1-3, and sodium lauryl sulfate. In some variations, the hydrocarbon removal composition includes Sorbitan oleate, Tomadol 1-3, and sodium lauryl ether sulfates. In some variations, the hydrocarbon removal composition includes Sorbitan oleate, Tomadol 1-3, and sodium octyl sulfosuccinate. In some variations, the hydrocarbon removal composition includes Sorbitan oleate, Tomadol 1-3, and di sodium octyl sulfosuccinate. In some variations, the hydrocarbon removal composition includes Sorbitan oleate, Tomadol 1-3, and sodium oleyl ether carboxylates. In some variations, the hydrocarbon removal composition includes Sorbitan oleate, Tomadol 1-3, and alkyl sulfonate. In some variations, the hydrocarbon removal composition includes Sorbitan oleate, Tomadol 1-3, and linear alkylbenzene sulfonate. In some variations, the hydrocarbon removal composition includes Sorbitan oleate, Tomadol 1-3, and a branched alkylbenzene sulfonate. In some variations, the hydrocarbon removal composition includes Sorbitan oleate, Tomadol 1-3, and a linear alkylbenzene sulfonate. In some variations, the hydrocarbon removal composition includes Sorbitan oleate, Tomadol 1-3, and Calimulse PRS. In some variations, the hydrocarbon removal composition includes Sorbitan oleate, Tomadol 1-3, and Calimulse PR. In some variations, the hydrocarbon removal composition includes Sorbitan oleate, Tomadol 1-3, and Witconate P-1059.

In some variations, the hydrocarbon removal composition includes sorbitan palmitate, Dyno 607, and sodium lauryl sulfate. In some variations, the hydrocarbon removal composition includes sorbitan palmitate, Dyno 607, and sodium lauryl ether sulfates. In some variations, the hydrocarbon removal composition includes sorbitan palmitate, Dyno 607, and sodium octyl sulfosuccinate. In some variations, the hydrocarbon removal composition includes sorbitan palmitate, Dyno 607, and di sodium octyl sulfosuccinate. In some variations, the hydrocarbon removal composition includes sorbitan palmitate, Dyno 607, and sodium oleyl ether carboxylates. In some variations, the hydrocarbon removal composition includes sorbitan palmitate, Dyno 607, and alkyl sulfonate. In some variations, the hydrocarbon removal composition includes sorbitan palmitate, Dyno 607, and linear alkylbenzene sulfonate. In some variations, the hydrocarbon removal composition includes sorbitan palmitate, Dyno 607, and a branched alkylbenzene sulfonate. In some variations, the hydrocarbon removal composition includes sorbitan palmitate, Dyno 607, and a linear alkylbenzene sulfonate. In some variations, the hydrocarbon removal composition includes sorbitan palmitate, Dyno 607, and Calimulse PRS. In some variations, the hydrocarbon removal composition includes sorbitan palmitate, Dyno 607, and Calimulse PR. In some variations, the hydrocarbon removal composition includes sorbitan palmitate, Dyno 607, and Witconate P-1059. In some variations, the hydrocarbon removal composition includes sorbitan palmitate, Surfynol 420, and sodium lauryl sulfate. In some variations, the hydrocarbon removal composition includes sorbitan palmitate, Surfynol 420, and sodium lauryl ether sulfates. In some variations, the hydrocarbon removal composition includes sorbitan palmitate, Surfynol 420, and sodium octyl sulfosuccinate. In some variations, the hydrocarbon removal composition includes sorbitan palmitate, Surfynol 420, and di sodium octyl sulfosuccinate. In some variations, the hydrocarbon removal composition includes sorbitan palmitate, Surfynol 420, and sodium oleyl ether carboxylates. In some variations, the hydrocarbon removal composition includes sorbitan palmitate, Surfynol 420, and alkyl sulfonate. In some variations, the hydrocarbon removal composition includes sorbitan palmitate, Surfynol 420, and linear alkylbenzene sulfonate. In some variations, the hydrocarbon removal composition includes sorbitan palmitate, Surfynol 420, and a branched alkylbenzene sulfonate. In some variations, the hydrocarbon removal composition includes sorbitan palmitate, Surfynol 420, and a linear alkylbenzene sulfonate. In some variations, the hydrocarbon removal composition includes sorbitan palmitate, Surfynol 420, and Calimulse PRS. In some variations, the hydrocarbon removal composition includes sorbitan palmitate, Surfynol 420, and Calimulse PR. In some variations, the hydrocarbon removal composition includes sorbitan palmitate, Surfynol 420, and Witconate P-1059. In some variations, the hydrocarbon removal composition includes sorbitan palmitate, Surfynol 440, and sodium lauryl sulfate. In some variations, the hydrocarbon removal composition includes sorbitan palmitate, Surfynol 440, and sodium lauryl ether sulfates. In some variations, the hydrocarbon removal composition includes sorbitan palmitate, Surfynol 440, and sodium octyl sulfosuccinate. In some variations, the hydrocarbon removal composition includes sorbitan palmitate, Surfynol 440, and di sodium octyl sulfosuccinate. In some variations, the hydrocarbon removal composition includes sorbitan palmitate, Surfynol 440, and sodium oleyl ether carboxylates. In some variations, the hydrocarbon removal composition includes sorbitan palmitate, Surfynol 440, and alkyl sulfonate. In some variations, the hydrocarbon removal composition includes sorbitan palmitate, Surfynol 440, and linear alkylbenzene sulfonate. In some variations, the hydrocarbon removal composition includes sorbitan palmitate, Surfynol 440, and a branched alkylbenzene sulfonate. In some variations, the hydrocarbon removal composition includes sorbitan palmitate, Surfynol 440, and a linear alkylbenzene sulfonate. In some variations, the hydrocarbon removal composition includes sorbitan palmitate, Surfynol 440, and Calimulse PRS. In some variations, the hydrocarbon removal composition includes sorbitan palmitate, Surfynol 440, and Calimulse PR. In some variations, the hydrocarbon removal composition includes sorbitan palmitate, Surfynol 440, and Witconate P-1059. In some variations, the hydrocarbon removal composition includes sorbitan palmitate, Surfynol 465, and sodium lauryl sulfate. In some variations, the hydrocarbon removal composition includes sorbitan palmitate, Surfynol 465, and sodium lauryl ether sulfates. In some variations, the hydrocarbon removal composition includes sorbitan palmitate, Surfynol 465, and sodium octyl sulfosuccinate. In some variations, the hydrocarbon removal composition includes sorbitan palmitate, Surfynol 465, and di sodium octyl sulfosuccinate. In some variations, the hydrocarbon removal composition includes sorbitan palmitate, Surfynol 465, and sodium oleyl ether carboxylates. In some variations, the hydrocarbon removal composition includes sorbitan palmitate, Surfynol 465, and alkyl sulfonate. In some variations, the hydrocarbon removal composition includes sorbitan palmitate, Surfynol 465, and linear alkylbenzene sulfonate. In some variations, the hydrocarbon removal composition includes sorbitan palmitate, Surfynol 465, and a branched alkylbenzene sulfonate. In some variations, the hydrocarbon removal composition includes sorbitan palmitate, Surfynol 465, and a linear alkylbenzene sulfonate. In some variations, the hydrocarbon removal composition includes sorbitan palmitate, Surfynol 465, and Calimulse PRS. In some variations, the hydrocarbon removal composition includes sorbitan palmitate, Surfynol 465, and Calimulse PR. In some variations, the hydrocarbon removal composition includes sorbitan palmitate, Surfynol 465, and Witconate P-1059. In some variations, the hydrocarbon removal composition includes sorbitan palmitate, Surfynol 485, and sodium lauryl sulfate. In some variations, the hydrocarbon removal composition includes sorbitan palmitate, Surfynol 485, and sodium lauryl ether sulfates. In some variations, the hydrocarbon removal composition includes sorbitan palmitate, Surfynol 485, and sodium octyl sulfosuccinate. In some variations, the hydrocarbon removal composition includes sorbitan palmitate, Surfynol 485, and di sodium octyl sulfosuccinate. In some variations, the hydrocarbon removal composition includes sorbitan palmitate, Surfynol 485, and sodium oleyl ether carboxylates. In some variations, the hydrocarbon removal composition includes sorbitan palmitate, Surfynol 485, and alkyl sulfonate. In some variations, the hydrocarbon removal composition includes sorbitan palmitate, Surfynol 485, and linear alkylbenzene sulfonate. In some variations, the hydrocarbon removal composition includes sorbitan palmitate, Surfynol 485, and a branched alkylbenzene sulfonate. In some variations, the hydrocarbon removal composition includes sorbitan palmitate, Surfynol 485, and a linear alkylbenzene sulfonate. In some variations, the hydrocarbon removal composition includes sorbitan palmitate, Surfynol 485, and Calimulse PRS. In some variations, the hydrocarbon removal composition includes sorbitan palmitate, Surfynol 485, and Calimulse PR. In some variations, the hydrocarbon removal composition includes sorbitan palmitate, Surfynol 485, and Witconate P-1059. In some variations, the hydrocarbon removal composition includes sorbitan palmitate, Dyno 604, and sodium lauryl sulfate. In some variations, the hydrocarbon removal composition includes sorbitan palmitate, Dyno 604, and sodium lauryl ether sulfates. In some variations, the hydrocarbon removal composition includes sorbitan palmitate, Dyno 604, and sodium octyl sulfosuccinate. In some variations, the hydrocarbon removal composition includes sorbitan palmitate, Dyno 604, and di sodium octyl sulfosuccinate. In some variations, the hydrocarbon removal composition includes sorbitan palmitate, Dyno 604, and sodium oleyl ether carboxylates. In some variations, the hydrocarbon removal composition includes sorbitan palmitate, Dyno 604, and alkyl sulfonate. In some variations, the hydrocarbon removal composition includes sorbitan palmitate, Dyno 604, and linear alkylbenzene sulfonate. In some variations, the hydrocarbon removal composition includes sorbitan palmitate, Dyno 604, and a branched alkylbenzene sulfonate. In some variations, the hydrocarbon removal composition includes sorbitan palmitate, Dyno 604, and a linear alkylbenzene sulfonate. In some variations, the hydrocarbon removal composition includes sorbitan palmitate, Dyno 604, and Calimulse PRS. In some variations, the hydrocarbon removal composition includes sorbitan palmitate, Dyno 604, and Calimulse PR. In some variations, the hydrocarbon removal composition includes sorbitan palmitate, Dyno 604, and Witconate P-1059. In some variations, the hydrocarbon removal composition includes sorbitan palmitate, Tomadol 91-2.5, and sodium lauryl sulfate. In some variations, the hydrocarbon removal composition includes sorbitan palmitate, Tomadol 91-2.5, and sodium lauryl ether sulfates. In some variations, the hydrocarbon removal composition includes sorbitan palmitate, Tomadol 91-2.5, and sodium octyl sulfosuccinate. In some variations, the hydrocarbon removal composition includes sorbitan palmitate, Tomadol 91-2.5, and di sodium octyl sulfosuccinate. In some variations, the hydrocarbon removal composition includes sorbitan palmitate, Tomadol 91-2.5, and sodium oleyl ether carboxylates. In some variations, the hydrocarbon removal composition includes sorbitan palmitate, Tomadol 91-2.5, and alkyl sulfonate. In some variations, the hydrocarbon removal composition includes sorbitan palmitate, Tomadol 91-2.5, and linear alkylbenzene sulfonate. In some variations, the hydrocarbon removal composition includes sorbitan palmitate, Tomadol 91-2.5, and a branched alkylbenzene sulfonate. In some variations, the hydrocarbon removal composition includes sorbitan palmitate, Tomadol 91-2.5, and a linear alkylbenzene sulfonate. In some variations, the hydrocarbon removal composition includes sorbitan palmitate, Tomadol 91-2.5, and Calimulse PRS. In some variations, the hydrocarbon removal composition includes sorbitan palmitate, Tomadol 91-2.5, and Calimulse PR. In some variations, the hydrocarbon removal composition includes sorbitan palmitate, Tomadol 91-2.5, and Witconate P-1059. In some variations, the hydrocarbon removal composition includes sorbitan palmitate, Tomadol 91-6, and sodium lauryl sulfate. In some variations, the hydrocarbon removal composition includes sorbitan palmitate, Tomadol 91-6, and sodium lauryl ether sulfates. In some variations, the hydrocarbon removal composition includes sorbitan palmitate, Tomadol 91-6, and sodium octyl sulfosuccinate. In some variations, the hydrocarbon removal composition includes sorbitan palmitate, Tomadol 91-6, and di sodium octyl sulfosuccinate. In some variations, the hydrocarbon removal composition includes sorbitan palmitate, Tomadol 91-6, and sodium oleyl ether carboxylates. In some variations, the hydrocarbon removal composition includes sorbitan palmitate, Tomadol 91-6, and alkyl sulfonate. In some variations, the hydrocarbon removal composition includes sorbitan palmitate, Tomadol 91-6, and linear alkylbenzene sulfonate. In some variations, the hydrocarbon removal composition includes sorbitan palmitate, Tomadol 91-6, and a branched alkylbenzene sulfonate. In some variations, the hydrocarbon removal composition includes sorbitan palmitate, Tomadol 91-6, and a linear alkylbenzene sulfonate. In some variations, the hydrocarbon removal composition includes sorbitan palmitate, Tomadol 91-6, and Calimulse PRS. In some variations, the hydrocarbon removal composition includes sorbitan palmitate, Tomadol 91-6, and Calimulse PR. In some variations, the hydrocarbon removal composition includes sorbitan palmitate, Tomadol 91-6, and Witconate P-1059. In some variations, the hydrocarbon removal composition includes sorbitan palmitate, Tomadol 91-8, and sodium lauryl sulfate. In some variations, the hydrocarbon removal composition includes sorbitan palmitate, Tomadol 91-8, and sodium lauryl ether sulfates. In some variations, the hydrocarbon removal composition includes sorbitan palmitate, Tomadol 91-8, and sodium octyl sulfosuccinate. In some variations, the hydrocarbon removal composition includes sorbitan palmitate, Tomadol 91-8, and di sodium octyl sulfosuccinate. In some variations, the hydrocarbon removal composition includes sorbitan palmitate, Tomadol 91-8, and sodium oleyl ether carboxylates. In some variations, the hydrocarbon removal composition includes sorbitan palmitate, Tomadol 91-8, and alkyl sulfonate. In some variations, the hydrocarbon removal composition includes sorbitan palmitate, Tomadol 91-8, and linear alkylbenzene sulfonate. In some variations, the hydrocarbon removal composition includes sorbitan palmitate, Tomadol 91-8, and a branched alkylbenzene sulfonate. In some variations, the hydrocarbon removal composition includes sorbitan palmitate, Tomadol 91-8, and a linear alkylbenzene sulfonate. In some variations, the hydrocarbon removal composition includes sorbitan palmitate, Tomadol 91-8, and Calimulse PRS. In some variations, the hydrocarbon removal composition includes sorbitan palmitate, Tomadol 91-8, and Calimulse PR. In some variations, the hydrocarbon removal composition includes sorbitan palmitate, Tomadol 91-8, and Witconate P-1059. In some variations, the hydrocarbon removal composition includes sorbitan palmitate, Tomadol 1200, and sodium lauryl sulfate. In some variations, the hydrocarbon removal composition includes sorbitan palmitate, Tomadol 1200, and sodium lauryl ether sulfates. In some variations, the hydrocarbon removal composition includes sorbitan palmitate, Tomadol 1200, and sodium octyl sulfosuccinate. In some variations, the hydrocarbon removal composition includes sorbitan palmitate, Tomadol 1200, and di sodium octyl sulfosuccinate. In some variations, the hydrocarbon removal composition includes sorbitan palmitate, Tomadol 1200, and sodium oleyl ether carboxylates. In some variations, the hydrocarbon removal composition includes sorbitan palmitate, Tomadol 1200, and alkyl sulfonate. In some variations, the hydrocarbon removal composition includes sorbitan palmitate, Tomadol 1200, and linear alkylbenzene sulfonate. In some variations, the hydrocarbon removal composition includes sorbitan palmitate, Tomadol 1200, and a branched alkylbenzene sulfonate. In some variations, the hydrocarbon removal composition includes sorbitan palmitate, Tomadol 1200, and a linear alkylbenzene sulfonate. In some variations, the hydrocarbon removal composition includes sorbitan palmitate, Tomadol 1200, and Calimulse PRS. In some variations, the hydrocarbon removal composition includes sorbitan palmitate, Tomadol 1200, and Calimulse PR. In some variations, the hydrocarbon removal composition includes sorbitan palmitate, Tomadol 1200, and Witconate P-1059. In some variations, the hydrocarbon removal composition includes sorbitan palmitate, T Det A 267, and sodium lauryl sulfate. In some variations, the hydrocarbon removal composition includes sorbitan palmitate, T Det A 267, and sodium lauryl ether sulfates. In some variations, the hydrocarbon removal composition includes sorbitan palmitate, T Det A 267, and sodium octyl sulfosuccinate. In some variations, the hydrocarbon removal composition includes sorbitan palmitate, T Det A 267, and di sodium octyl sulfosuccinate. In some variations, the hydrocarbon removal composition includes sorbitan palmitate, T Det A 267, and sodium oleyl ether carboxylates. In some variations, the hydrocarbon removal composition includes sorbitan palmitate, T Det A 267, and alkyl sulfonate. In some variations, the hydrocarbon removal composition includes sorbitan palmitate, T Det A 267, and linear alkylbenzene sulfonate. In some variations, the hydrocarbon removal composition includes sorbitan palmitate, T Det A 267, and a branched alkylbenzene sulfonate. In some variations, the hydrocarbon removal composition includes sorbitan palmitate, T Det A 267, and a linear alkylbenzene sulfonate. In some variations, the hydrocarbon removal composition includes sorbitan palmitate, T Det A 267, and Calimulse PRS. In some variations, the hydrocarbon removal composition includes sorbitan palmitate, T Det A 267, and Calimulse PR. In some variations, the hydrocarbon removal composition includes sorbitan palmitate, T Det A 267, and Witconate P-1059. In some variations, the hydrocarbon removal composition includes sorbitan palmitate, Tomadol 1-3, and sodium lauryl sulfate. In some variations, the hydrocarbon removal composition includes sorbitan palmitate, Tomadol 1-3, and sodium lauryl ether sulfates. In some variations, the hydrocarbon removal composition includes sorbitan palmitate, Tomadol 1-3, and sodium octyl sulfosuccinate. In some variations, the hydrocarbon removal composition includes sorbitan palmitate, Tomadol 1-3, and di sodium octyl sulfosuccinate. In some variations, the hydrocarbon removal composition includes sorbitan palmitate, Tomadol 1-3, and sodium oleyl ether carboxylates. In some variations, the hydrocarbon removal composition includes sorbitan palmitate, Tomadol 1-3, and alkyl sulfonate. In some variations, the hydrocarbon removal composition includes sorbitan palmitate, Tomadol 1-3, and linear alkylbenzene sulfonate. In some variations, the hydrocarbon removal composition includes sorbitan palmitate, Tomadol 1-3, and a branched alkylbenzene sulfonate. In some variations, the hydrocarbon removal composition includes sorbitan palmitate, Tomadol 1-3, and a linear alkylbenzene sulfonate. In some variations, the hydrocarbon removal composition includes sorbitan palmitate, Tomadol 1-3, and Calimulse PRS. In some variations, the hydrocarbon removal composition includes sorbitan palmitate, Tomadol 1-3, and Calimulse PR. In some variations, the hydrocarbon removal composition includes sorbitan palmitate, Tomadol 1-3, and Witconate P-1059.

In some variations, the hydrocarbon removal composition includes sorbitan stearate, Dyno 607, and sodium lauryl sulfate. In some variations, the hydrocarbon removal composition includes sorbitan stearate, Dyno 607, and sodium lauryl ether sulfates. In some variations, the hydrocarbon removal composition includes sorbitan stearate, Dyno 607, and sodium octyl sulfosuccinate. In some variations, the hydrocarbon removal composition includes sorbitan stearate, Dyno 607, and di sodium octyl sulfosuccinate. In some variations, the hydrocarbon removal composition includes sorbitan stearate, Dyno 607, and sodium oleyl ether carboxylates. In some variations, the hydrocarbon removal composition includes sorbitan stearate, Dyno 607, and alkyl sulfonate. In some variations, the hydrocarbon removal composition includes sorbitan stearate, Dyno 607, and linear alkylbenzene sulfonate. In some variations, the hydrocarbon removal composition includes sorbitan stearate, Dyno 607, and a branched alkylbenzene sulfonate. In some variations, the hydrocarbon removal composition includes sorbitan stearate, Dyno 607, and a linear alkylbenzene sulfonate. In some variations, the hydrocarbon removal composition includes sorbitan stearate, Dyno 607, and Calimulse PRS. In some variations, the hydrocarbon removal composition includes sorbitan stearate, Dyno 607, and Calimulse PR. In some variations, the hydrocarbon removal composition includes sorbitan stearate, Dyno 607, and Witconate P-1059. In some variations, the hydrocarbon removal composition includes sorbitan stearate, Surfynol 420, and sodium lauryl sulfate. In some variations, the hydrocarbon removal composition includes sorbitan stearate, Surfynol 420, and sodium lauryl ether sulfates. In some variations, the hydrocarbon removal composition includes sorbitan stearate, Surfynol 420, and sodium octyl sulfosuccinate. In some variations, the hydrocarbon removal composition includes sorbitan stearate, Surfynol 420, and di sodium octyl sulfosuccinate. In some variations, the hydrocarbon removal composition includes sorbitan stearate, Surfynol 420, and sodium oleyl ether carboxylates. In some variations, the hydrocarbon removal composition includes sorbitan stearate, Surfynol 420, and alkyl sulfonate. In some variations, the hydrocarbon removal composition includes sorbitan stearate, Surfynol 420, and linear alkylbenzene sulfonate. In some variations, the hydrocarbon removal composition includes sorbitan stearate, Surfynol 420, and a branched alkylbenzene sulfonate. In some variations, the hydrocarbon removal composition includes sorbitan stearate, Surfynol 420, and a linear alkylbenzene sulfonate. In some variations, the hydrocarbon removal composition includes sorbitan stearate, Surfynol 420, and Calimulse PRS. In some variations, the hydrocarbon removal composition includes sorbitan stearate, Surfynol 420, and Calimulse PR. In some variations, the hydrocarbon removal composition includes sorbitan stearate, Surfynol 420, and Witconate P-1059. In some variations, the hydrocarbon removal composition includes sorbitan stearate, Surfynol 440, and sodium lauryl sulfate. In some variations, the hydrocarbon removal composition includes sorbitan stearate, Surfynol 440, and sodium lauryl ether sulfates. In some variations, the hydrocarbon removal composition includes sorbitan stearate, Surfynol 440, and sodium octyl sulfosuccinate. In some variations, the hydrocarbon removal composition includes sorbitan stearate, Surfynol 440, and di sodium octyl sulfosuccinate. In some variations, the hydrocarbon removal composition includes sorbitan stearate, Surfynol 440, and sodium oleyl ether carboxylates. In some variations, the hydrocarbon removal composition includes sorbitan stearate, Surfynol 440, and alkyl sulfonate. In some variations, the hydrocarbon removal composition includes sorbitan stearate, Surfynol 440, and linear alkylbenzene sulfonate. In some variations, the hydrocarbon removal composition includes sorbitan stearate, Surfynol 440, and a branched alkylbenzene sulfonate. In some variations, the hydrocarbon removal composition includes sorbitan stearate, Surfynol 440, and a linear alkylbenzene sulfonate. In some variations, the hydrocarbon removal composition includes sorbitan stearate, Surfynol 440, and Calimulse PRS. In some variations, the hydrocarbon removal composition includes sorbitan stearate, Surfynol 440, and Calimulse PR. In some variations, the hydrocarbon removal composition includes sorbitan stearate, Surfynol 440, and Witconate P-1059. In some variations, the hydrocarbon removal composition includes sorbitan stearate, Surfynol 465, and sodium lauryl sulfate. In some variations, the hydrocarbon removal composition includes sorbitan stearate, Surfynol 465, and sodium lauryl ether sulfates. In some variations, the hydrocarbon removal composition includes sorbitan stearate, Surfynol 465, and sodium octyl sulfosuccinate. In some variations, the hydrocarbon removal composition includes sorbitan stearate, Surfynol 465, and di sodium octyl sulfosuccinate. In some variations, the hydrocarbon removal composition includes sorbitan stearate, Surfynol 465, and sodium oleyl ether carboxylates. In some variations, the hydrocarbon removal composition includes sorbitan stearate, Surfynol 465, and alkyl sulfonate. In some variations, the hydrocarbon removal composition includes sorbitan stearate, Surfynol 465, and linear alkylbenzene sulfonate. In some variations, the hydrocarbon removal composition includes sorbitan stearate, Surfynol 465, and a branched alkylbenzene sulfonate. In some variations, the hydrocarbon removal composition includes sorbitan stearate, Surfynol 465, and a linear alkylbenzene sulfonate. In some variations, the hydrocarbon removal composition includes sorbitan stearate, Surfynol 465, and Calimulse PRS. In some variations, the hydrocarbon removal composition includes sorbitan stearate, Surfynol 465, and Calimulse PR. In some variations, the hydrocarbon removal composition includes sorbitan stearate, Surfynol 465, and Witconate P-1059. In some variations, the hydrocarbon removal composition includes sorbitan stearate, Surfynol 485, and sodium lauryl sulfate. In some variations, the hydrocarbon removal composition includes sorbitan stearate, Surfynol 485, and sodium lauryl ether sulfates. In some variations, the hydrocarbon removal composition includes sorbitan stearate, Surfynol 485, and sodium octyl sulfosuccinate. In some variations, the hydrocarbon removal composition includes sorbitan stearate, Surfynol 485, and di sodium octyl sulfosuccinate. In some variations, the hydrocarbon removal composition includes sorbitan stearate, Surfynol 485, and sodium oleyl ether carboxylates. In some variations, the hydrocarbon removal composition includes sorbitan stearate, Surfynol 485, and alkyl sulfonate. In some variations, the hydrocarbon removal composition includes sorbitan stearate, Surfynol 485, and linear alkylbenzene sulfonate. In some variations, the hydrocarbon removal composition includes sorbitan stearate, Surfynol 485, and a branched alkylbenzene sulfonate. In some variations, the hydrocarbon removal composition includes sorbitan stearate, Surfynol 485, and a linear alkylbenzene sulfonate. In some variations, the hydrocarbon removal composition includes sorbitan stearate, Surfynol 485, and Calimulse PRS. In some variations, the hydrocarbon removal composition includes sorbitan stearate, Surfynol 485, and Calimulse PR. In some variations, the hydrocarbon removal composition includes sorbitan stearate, Surfynol 485, and Witconate P-1059. In some variations, the hydrocarbon removal composition includes sorbitan stearate, Dyno 604, and sodium lauryl sulfate. In some variations, the hydrocarbon removal composition includes sorbitan stearate, Dyno 604, and sodium lauryl ether sulfates. In some variations, the hydrocarbon removal composition includes sorbitan stearate, Dyno 604, and sodium octyl sulfosuccinate. In some variations, the hydrocarbon removal composition includes sorbitan stearate, Dyno 604, and di sodium octyl sulfosuccinate. In some variations, the hydrocarbon removal composition includes sorbitan stearate, Dyno 604, and sodium oleyl ether carboxylates. In some variations, the hydrocarbon removal composition includes sorbitan stearate, Dyno 604, and alkyl sulfonate. In some variations, the hydrocarbon removal composition includes sorbitan stearate, Dyno 604, and linear alkylbenzene sulfonate. In some variations, the hydrocarbon removal composition includes sorbitan stearate, Dyno 604, and a branched alkylbenzene sulfonate. In some variations, the hydrocarbon removal composition includes sorbitan stearate, Dyno 604, and a linear alkylbenzene sulfonate. In some variations, the hydrocarbon removal composition includes sorbitan stearate, Dyno 604, and Calimulse PRS. In some variations, the hydrocarbon removal composition includes sorbitan stearate, Dyno 604, and Calimulse PR. In some variations, the hydrocarbon removal composition includes sorbitan stearate, Dyno 604, and Witconate P-1059. In some variations, the hydrocarbon removal composition includes sorbitan stearate, Tomadol 91-2.5, and sodium lauryl sulfate. In some variations, the hydrocarbon removal composition includes sorbitan stearate, Tomadol 91-2.5, and sodium lauryl ether sulfates. In some variations, the hydrocarbon removal composition includes sorbitan stearate, Tomadol 91-2.5, and sodium octyl sulfosuccinate. In some variations, the hydrocarbon removal composition includes sorbitan stearate, Tomadol 91-2.5, and di sodium octyl sulfosuccinate. In some variations, the hydrocarbon removal composition includes sorbitan stearate, Tomadol 91-2.5, and sodium oleyl ether carboxylates. In some variations, the hydrocarbon removal composition includes sorbitan stearate, Tomadol 91-2.5, and alkyl sulfonate. In some variations, the hydrocarbon removal composition includes sorbitan stearate, Tomadol 91-2.5, and linear alkylbenzene sulfonate. In some variations, the hydrocarbon removal composition includes sorbitan stearate, Tomadol 91-2.5, and a branched alkylbenzene sulfonate. In some variations, the hydrocarbon removal composition includes sorbitan stearate, Tomadol 91-2.5, and a linear alkylbenzene sulfonate. In some variations, the hydrocarbon removal composition includes sorbitan stearate, Tomadol 91-2.5, and Calimulse PRS. In some variations, the hydrocarbon removal composition includes sorbitan stearate, Tomadol 91-2.5, and Calimulse PR. In some variations, the hydrocarbon removal composition includes sorbitan stearate, Tomadol 91-2.5, and Witconate P-1059. In some variations, the hydrocarbon removal composition includes sorbitan stearate, Tomadol 91-6, and sodium lauryl sulfate. In some variations, the hydrocarbon removal composition includes sorbitan stearate, Tomadol 91-6, and sodium lauryl ether sulfates. In some variations, the hydrocarbon removal composition includes sorbitan stearate, Tomadol 91-6, and sodium octyl sulfosuccinate. In some variations, the hydrocarbon removal composition includes sorbitan stearate, Tomadol 91-6, and di sodium octyl sulfosuccinate. In some variations, the hydrocarbon removal composition includes sorbitan stearate, Tomadol 91-6, and sodium oleyl ether carboxylates. In some variations, the hydrocarbon removal composition includes sorbitan stearate, Tomadol 91-6, and alkyl sulfonate. In some variations, the hydrocarbon removal composition includes sorbitan stearate, Tomadol 91-6, and linear alkylbenzene sulfonate. In some variations, the hydrocarbon removal composition includes sorbitan stearate, Tomadol 91-6, and a branched alkylbenzene sulfonate. In some variations, the hydrocarbon removal composition includes sorbitan stearate, Tomadol 91-6, and a linear alkylbenzene sulfonate. In some variations, the hydrocarbon removal composition includes sorbitan stearate, Tomadol 91-6, and Calimulse PRS. In some variations, the hydrocarbon removal composition includes sorbitan stearate, Tomadol 91-6, and Calimulse PR. In some variations, the hydrocarbon removal composition includes sorbitan stearate, Tomadol 91-6, and Witconate P-1059. In some variations, the hydrocarbon removal composition includes sorbitan stearate, Tomadol 91-8, and sodium lauryl sulfate. In some variations, the hydrocarbon removal composition includes sorbitan stearate, Tomadol 91-8, and sodium lauryl ether sulfates. In some variations, the hydrocarbon removal composition includes sorbitan stearate, Tomadol 91-8, and sodium octyl sulfosuccinate. In some variations, the hydrocarbon removal composition includes sorbitan stearate, Tomadol 91-8, and di sodium octyl sulfosuccinate. In some variations, the hydrocarbon removal composition includes sorbitan stearate, Tomadol 91-8, and sodium oleyl ether carboxylates. In some variations, the hydrocarbon removal composition includes sorbitan stearate, Tomadol 91-8, and alkyl sulfonate. In some variations, the hydrocarbon removal composition includes sorbitan stearate, Tomadol 91-8, and linear alkylbenzene sulfonate. In some variations, the hydrocarbon removal composition includes sorbitan stearate, Tomadol 91-8, and a branched alkylbenzene sulfonate. In some variations, the hydrocarbon removal composition includes sorbitan stearate, Tomadol 91-8, and a linear alkylbenzene sulfonate. In some variations, the hydrocarbon removal composition includes sorbitan stearate, Tomadol 91-8, and Calimulse PRS. In some variations, the hydrocarbon removal composition includes sorbitan stearate, Tomadol 91-8, and Calimulse PR. In some variations, the hydrocarbon removal composition includes sorbitan stearate, Tomadol 91-8, and Witconate P-1059. In some variations, the hydrocarbon removal composition includes sorbitan stearate, Tomadol 1200, and sodium lauryl sulfate. In some variations, the hydrocarbon removal composition includes sorbitan stearate, Tomadol 1200, and sodium lauryl ether sulfates. In some variations, the hydrocarbon removal composition includes sorbitan stearate, Tomadol 1200, and sodium octyl sulfosuccinate. In some variations, the hydrocarbon removal composition includes sorbitan stearate, Tomadol 1200, and di sodium octyl sulfosuccinate. In some variations, the hydrocarbon removal composition includes sorbitan stearate, Tomadol 1200, and sodium oleyl ether carboxylates. In some variations, the hydrocarbon removal composition includes sorbitan stearate, Tomadol 1200, and alkyl sulfonate. In some variations, the hydrocarbon removal composition includes sorbitan stearate, Tomadol 1200, and linear alkylbenzene sulfonate. In some variations, the hydrocarbon removal composition includes sorbitan stearate, Tomadol 1200, and a branched alkylbenzene sulfonate. In some variations, the hydrocarbon removal composition includes sorbitan stearate, Tomadol 1200, and a linear alkylbenzene sulfonate. In some variations, the hydrocarbon removal composition includes sorbitan stearate, Tomadol 1200, and Calimulse PRS. In some variations, the hydrocarbon removal composition includes sorbitan stearate, Tomadol 1200, and Calimulse PR. In some variations, the hydrocarbon removal composition includes sorbitan stearate, Tomadol 1200, and Witconate P-1059. In some variations, the hydrocarbon removal composition includes sorbitan stearate, T Det A 267, and sodium lauryl sulfate. In some variations, the hydrocarbon removal composition includes sorbitan stearate, T Det A 267, and sodium lauryl ether sulfates. In some variations, the hydrocarbon removal composition includes sorbitan stearate, T Det A 267, and sodium octyl sulfosuccinate. In some variations, the hydrocarbon removal composition includes sorbitan stearate, T Det A 267, and di sodium octyl sulfosuccinate. In some variations, the hydrocarbon removal composition includes sorbitan stearate, T Det A 267, and sodium oleyl ether carboxylates. In some variations, the hydrocarbon removal composition includes sorbitan stearate, T Det A 267, and alkyl sulfonate. In some variations, the hydrocarbon removal composition includes sorbitan stearate, T Det A 267, and linear alkylbenzene sulfonate. In some variations, the hydrocarbon removal composition includes sorbitan stearate, T Det A 267, and a branched alkylbenzene sulfonate. In some variations, the hydrocarbon removal composition includes sorbitan stearate, T Det A 267, and a linear alkylbenzene sulfonate. In some variations, the hydrocarbon removal composition includes sorbitan stearate, T Det A 267, and Calimulse PRS. In some variations, the hydrocarbon removal composition includes sorbitan stearate, T Det A 267, and Calimulse PR. In some variations, the hydrocarbon removal composition includes sorbitan stearate, T Det A 267, and Witconate P-1059. In some variations, the hydrocarbon removal composition includes sorbitan stearate, Tomadol 1-3, and sodium lauryl sulfate. In some variations, the hydrocarbon removal composition includes sorbitan stearate, Tomadol 1-3, and sodium lauryl ether sulfates. In some variations, the hydrocarbon removal composition includes sorbitan stearate, Tomadol 1-3, and sodium octyl sulfosuccinate. In some variations, the hydrocarbon removal composition includes sorbitan stearate, Tomadol 1-3, and di sodium octyl sulfosuccinate. In some variations, the hydrocarbon removal composition includes sorbitan stearate, Tomadol 1-3, and sodium oleyl ether carboxylates. In some variations, the hydrocarbon removal composition includes sorbitan stearate, Tomadol 1-3, and alkyl sulfonate. In some variations, the hydrocarbon removal composition includes sorbitan stearate, Tomadol 1-3, and linear alkylbenzene sulfonate. In some variations, the hydrocarbon removal composition includes sorbitan stearate, Tomadol 1-3, and a branched alkylbenzene sulfonate. In some variations, the hydrocarbon removal composition includes sorbitan stearate, Tomadol 1-3, and a linear alkylbenzene sulfonate. In some variations, the hydrocarbon removal composition includes sorbitan stearate, Tomadol 1-3, and Calimulse PRS. In some variations, the hydrocarbon removal composition includes sorbitan stearate, Tomadol 1-3, and Calimulse PR. In some variations, the hydrocarbon removal composition includes sorbitan stearate, Tomadol 1-3, and Witconate P-1059.

In some variations, the hydrocarbon removal composition includes sorbitan sesquioleate, Dyno 607, and sodium lauryl sulfate. In some variations, the hydrocarbon removal composition includes sorbitan sesquioleate, Dyno 607, and sodium lauryl ether sulfates. In some variations, the hydrocarbon removal composition includes sorbitan sesquioleate, Dyno 607, and sodium octyl sulfosuccinate. In some variations, the hydrocarbon removal composition includes sorbitan sesquioleate, Dyno 607, and di sodium octyl sulfosuccinate. In some variations, the hydrocarbon removal composition includes sorbitan sesquioleate, Dyno 607, and sodium oleyl ether carboxylates. In some variations, the hydrocarbon removal composition includes sorbitan sesquioleate, Dyno 607, and alkyl sulfonate. In some variations, the hydrocarbon removal composition includes sorbitan sesquioleate, Dyno 607, and linear alkylbenzene sulfonate. In some variations, the hydrocarbon removal composition includes sorbitan sesquioleate, Dyno 607, and a branched alkylbenzene sulfonate. In some variations, the hydrocarbon removal composition includes sorbitan sesquioleate, Dyno 607, and a linear alkylbenzene sulfonate. In some variations, the hydrocarbon removal composition includes sorbitan sesquioleate, Dyno 607, and Calimulse PRS. In some variations, the hydrocarbon removal composition includes sorbitan sesquioleate, Dyno 607, and Calimulse PR. In some variations, the hydrocarbon removal composition includes sorbitan sesquioleate, Dyno 607, and Witconate P-1059. In some variations, the hydrocarbon removal composition includes sorbitan sesquioleate, Surfynol 420, and sodium lauryl sulfate. In some variations, the hydrocarbon removal composition includes sorbitan sesquioleate, Surfynol 420, and sodium lauryl ether sulfates. In some variations, the hydrocarbon removal composition includes sorbitan sesquioleate, Surfynol 420, and sodium octyl sulfosuccinate. In some variations, the hydrocarbon removal composition includes sorbitan sesquioleate, Surfynol 420, and di sodium octyl sulfosuccinate. In some variations, the hydrocarbon removal composition includes sorbitan sesquioleate, Surfynol 420, and sodium oleyl ether carboxylates. In some variations, the hydrocarbon removal composition includes sorbitan sesquioleate, Surfynol 420, and alkyl sulfonate. In some variations, the hydrocarbon removal composition includes sorbitan sesquioleate, Surfynol 420, and linear alkylbenzene sulfonate. In some variations, the hydrocarbon removal composition includes sorbitan sesquioleate, Surfynol 420, and a branched alkylbenzene sulfonate. In some variations, the hydrocarbon removal composition includes sorbitan sesquioleate, Surfynol 420, and a linear alkylbenzene sulfonate. In some variations, the hydrocarbon removal composition includes sorbitan sesquioleate, Surfynol 420, and Calimulse PRS. In some variations, the hydrocarbon removal composition includes sorbitan sesquioleate, Surfynol 420, and Calimulse PR. In some variations, the hydrocarbon removal composition includes sorbitan sesquioleate, Surfynol 420, and Witconate P-1059. In some variations, the hydrocarbon removal composition includes sorbitan sesquioleate, Surfynol 440, and sodium lauryl sulfate. In some variations, the hydrocarbon removal composition includes sorbitan sesquioleate, Surfynol 440, and sodium lauryl ether sulfates. In some variations, the hydrocarbon removal composition includes sorbitan sesquioleate, Surfynol 440, and sodium octyl sulfosuccinate. In some variations, the hydrocarbon removal composition includes sorbitan sesquioleate, Surfynol 440, and di sodium octyl sulfosuccinate. In some variations, the hydrocarbon removal composition includes sorbitan sesquioleate, Surfynol 440, and sodium oleyl ether carboxylates. In some variations, the hydrocarbon removal composition includes sorbitan sesquioleate, Surfynol 440, and alkyl sulfonate. In some variations, the hydrocarbon removal composition includes sorbitan sesquioleate, Surfynol 440, and linear alkylbenzene sulfonate. In some variations, the hydrocarbon removal composition includes sorbitan sesquioleate, Surfynol 440, and a branched alkylbenzene sulfonate. In some variations, the hydrocarbon removal composition includes sorbitan sesquioleate, Surfynol 440, and a linear alkylbenzene sulfonate. In some variations, the hydrocarbon removal composition includes sorbitan sesquioleate, Surfynol 440, and Calimulse PRS. In some variations, the hydrocarbon removal composition includes sorbitan sesquioleate, Surfynol 440, and Calimulse PR. In some variations, the hydrocarbon removal composition includes sorbitan sesquioleate, Surfynol 440, and Witconate P-1059. In some variations, the hydrocarbon removal composition includes sorbitan sesquioleate, Surfynol 465, and sodium lauryl sulfate. In some variations, the hydrocarbon removal composition includes sorbitan sesquioleate, Surfynol 465, and sodium lauryl ether sulfates. In some variations, the hydrocarbon removal composition includes sorbitan sesquioleate, Surfynol 465, and sodium octyl sulfosuccinate. In some variations, the hydrocarbon removal composition includes sorbitan sesquioleate, Surfynol 465, and di sodium octyl sulfosuccinate. In some variations, the hydrocarbon removal composition includes sorbitan sesquioleate, Surfynol 465, and sodium oleyl ether carboxylates. In some variations, the hydrocarbon removal composition includes sorbitan sesquioleate, Surfynol 465, and alkyl sulfonate. In some variations, the hydrocarbon removal composition includes sorbitan sesquioleate, Surfynol 465, and linear alkylbenzene sulfonate. In some variations, the hydrocarbon removal composition includes sorbitan sesquioleate, Surfynol 465, and a branched alkylbenzene sulfonate. In some variations, the hydrocarbon removal composition includes sorbitan sesquioleate, Surfynol 465, and a linear alkylbenzene sulfonate. In some variations, the hydrocarbon removal composition includes sorbitan sesquioleate, Surfynol 465, and Calimulse PRS. In some variations, the hydrocarbon removal composition includes sorbitan sesquioleate, Surfynol 465, and Calimulse PR. In some variations, the hydrocarbon removal composition includes sorbitan sesquioleate, Surfynol 465, and Witconate P-1059. In some variations, the hydrocarbon removal composition includes sorbitan sesquioleate, Surfynol 485, and sodium lauryl sulfate. In some variations, the hydrocarbon removal composition includes sorbitan sesquioleate, Surfynol 485, and sodium lauryl ether sulfates. In some variations, the hydrocarbon removal composition includes sorbitan sesquioleate, Surfynol 485, and sodium octyl sulfosuccinate. In some variations, the hydrocarbon removal composition includes sorbitan sesquioleate, Surfynol 485, and di sodium octyl sulfosuccinate. In some variations, the hydrocarbon removal composition includes sorbitan sesquioleate, Surfynol 485, and sodium oleyl ether carboxylates. In some variations, the hydrocarbon removal composition includes sorbitan sesquioleate, Surfynol 485, and alkyl sulfonate. In some variations, the hydrocarbon removal composition includes sorbitan sesquioleate, Surfynol 485, and linear alkylbenzene sulfonate. In some variations, the hydrocarbon removal composition includes sorbitan sesquioleate, Surfynol 485, and a branched alkylbenzene sulfonate. In some variations, the hydrocarbon removal composition includes sorbitan sesquioleate, Surfynol 485, and a linear alkylbenzene sulfonate. In some variations, the hydrocarbon removal composition includes sorbitan sesquioleate, Surfynol 485, and Calimulse PRS. In some variations, the hydrocarbon removal composition includes sorbitan sesquioleate, Surfynol 485, and Calimulse PR. In some variations, the hydrocarbon removal composition includes sorbitan sesquioleate, Surfynol 485, and Witconate P-1059. In some variations, the hydrocarbon removal composition includes sorbitan sesquioleate, Dyno 604, and sodium lauryl sulfate. In some variations, the hydrocarbon removal composition includes sorbitan sesquioleate, Dyno 604, and sodium lauryl ether sulfates. In some variations, the hydrocarbon removal composition includes sorbitan sesquioleate, Dyno 604, and sodium octyl sulfosuccinate. In some variations, the hydrocarbon removal composition includes sorbitan sesquioleate, Dyno 604, and di sodium octyl sulfosuccinate. In some variations, the hydrocarbon removal composition includes sorbitan sesquioleate, Dyno 604, and sodium oleyl ether carboxylates. In some variations, the hydrocarbon removal composition includes sorbitan sesquioleate, Dyno 604, and alkyl sulfonate. In some variations, the hydrocarbon removal composition includes sorbitan sesquioleate, Dyno 604, and linear alkylbenzene sulfonate. In some variations, the hydrocarbon removal composition includes sorbitan sesquioleate, Dyno 604, and a branched alkylbenzene sulfonate. In some variations, the hydrocarbon removal composition includes sorbitan sesquioleate, Dyno 604, and a linear alkylbenzene sulfonate. In some variations, the hydrocarbon removal composition includes sorbitan sesquioleate, Dyno 604, and Calimulse PRS. In some variations, the hydrocarbon removal composition includes sorbitan sesquioleate, Dyno 604, and Calimulse PR. In some variations, the hydrocarbon removal composition includes sorbitan sesquioleate, Dyno 604, and Witconate P-1059. In some variations, the hydrocarbon removal composition includes sorbitan sesquioleate, Tomadol 91-2.5, and sodium lauryl sulfate. In some variations, the hydrocarbon removal composition includes sorbitan sesquioleate, Tomadol 91-2.5, and sodium lauryl ether sulfates. In some variations, the hydrocarbon removal composition includes sorbitan sesquioleate, Tomadol 91-2.5, and sodium octyl sulfosuccinate. In some variations, the hydrocarbon removal composition includes sorbitan sesquioleate, Tomadol 91-2.5, and di sodium octyl sulfosuccinate. In some variations, the hydrocarbon removal composition includes sorbitan sesquioleate, Tomadol 91-2.5, and sodium oleyl ether carboxylates. In some variations, the hydrocarbon removal composition includes sorbitan sesquioleate, Tomadol 91-2.5, and alkyl sulfonate. In some variations, the hydrocarbon removal composition includes sorbitan sesquioleate, Tomadol 91-2.5, and linear alkylbenzene sulfonate. In some variations, the hydrocarbon removal composition includes sorbitan sesquioleate, Tomadol 91-2.5, and a branched alkylbenzene sulfonate. In some variations, the hydrocarbon removal composition includes sorbitan sesquioleate, Tomadol 91-2.5, and a linear alkylbenzene sulfonate. In some variations, the hydrocarbon removal composition includes sorbitan sesquioleate, Tomadol 91-2.5, and Calimulse PRS. In some variations, the hydrocarbon removal composition includes sorbitan sesquioleate, Tomadol 91-2.5, and Calimulse PR. In some variations, the hydrocarbon removal composition includes sorbitan sesquioleate, Tomadol 91-2.5, and Witconate P-1059. In some variations, the hydrocarbon removal composition includes sorbitan sesquioleate, Tomadol 91-6, and sodium lauryl sulfate. In some variations, the hydrocarbon removal composition includes sorbitan sesquioleate, Tomadol 91-6, and sodium lauryl ether sulfates. In some variations, the hydrocarbon removal composition includes sorbitan sesquioleate, Tomadol 91-6, and sodium octyl sulfosuccinate. In some variations, the hydrocarbon removal composition includes sorbitan sesquioleate, Tomadol 91-6, and di sodium octyl sulfosuccinate. In some variations, the hydrocarbon removal composition includes sorbitan sesquioleate, Tomadol 91-6, and sodium oleyl ether carboxylates. In some variations, the hydrocarbon removal composition includes sorbitan sesquioleate, Tomadol 91-6, and alkyl sulfonate. In some variations, the hydrocarbon removal composition includes sorbitan sesquioleate, Tomadol 91-6, and linear alkylbenzene sulfonate. In some variations, the hydrocarbon removal composition includes sorbitan sesquioleate, Tomadol 91-6, and a branched alkylbenzene sulfonate. In some variations, the hydrocarbon removal composition includes sorbitan sesquioleate, Tomadol 91-6, and a linear alkylbenzene sulfonate. In some variations, the hydrocarbon removal composition includes sorbitan sesquioleate, Tomadol 91-6, and Calimulse PRS. In some variations, the hydrocarbon removal composition includes sorbitan sesquioleate, Tomadol 91-6, and Calimulse PR. In some variations, the hydrocarbon removal composition includes sorbitan sesquioleate, Tomadol 91-6, and Witconate P-1059. In some variations, the hydrocarbon removal composition includes sorbitan sesquioleate, Tomadol 91-8, and sodium lauryl sulfate. In some variations, the hydrocarbon removal composition includes sorbitan sesquioleate, Tomadol 91-8, and sodium lauryl ether sulfates. In some variations, the hydrocarbon removal composition includes sorbitan sesquioleate, Tomadol 91-8, and sodium octyl sulfosuccinate. In some variations, the hydrocarbon removal composition includes sorbitan sesquioleate, Tomadol 91-8, and di sodium octyl sulfosuccinate. In some variations, the hydrocarbon removal composition includes sorbitan sesquioleate, Tomadol 91-8, and sodium oleyl ether carboxylates. In some variations, the hydrocarbon removal composition includes sorbitan sesquioleate, Tomadol 91-8, and alkyl sulfonate. In some variations, the hydrocarbon removal composition includes sorbitan sesquioleate, Tomadol 91-8, and linear alkylbenzene sulfonate. In some variations, the hydrocarbon removal composition includes sorbitan sesquioleate, Tomadol 91-8, and a branched alkylbenzene sulfonate. In some variations, the hydrocarbon removal composition includes sorbitan sesquioleate, Tomadol 91-8, and a linear alkylbenzene sulfonate. In some variations, the hydrocarbon removal composition includes sorbitan sesquioleate, Tomadol 91-8, and Calimulse PRS. In some variations, the hydrocarbon removal composition includes sorbitan sesquioleate, Tomadol 91-8, and Calimulse PR. In some variations, the hydrocarbon removal composition includes sorbitan sesquioleate, Tomadol 91-8, and Witconate P-1059. In some variations, the hydrocarbon removal composition includes sorbitan sesquioleate, Tomadol 1200, and sodium lauryl sulfate. In some variations, the hydrocarbon removal composition includes sorbitan sesquioleate, Tomadol 1200, and sodium lauryl ether sulfates. In some variations, the hydrocarbon removal composition includes sorbitan sesquioleate, Tomadol 1200, and sodium octyl sulfosuccinate. In some variations, the hydrocarbon removal composition includes sorbitan sesquioleate, Tomadol 1200, and di sodium octyl sulfosuccinate. In some variations, the hydrocarbon removal composition includes sorbitan sesquioleate, Tomadol 1200, and sodium oleyl ether carboxylates. In some variations, the hydrocarbon removal composition includes sorbitan sesquioleate, Tomadol 1200, and alkyl sulfonate. In some variations, the hydrocarbon removal composition includes sorbitan sesquioleate, Tomadol 1200, and linear alkylbenzene sulfonate. In some variations, the hydrocarbon removal composition includes sorbitan sesquioleate, Tomadol 1200, and a branched alkylbenzene sulfonate. In some variations, the hydrocarbon removal composition includes sorbitan sesquioleate, Tomadol 1200, and a linear alkylbenzene sulfonate. In some variations, the hydrocarbon removal composition includes sorbitan sesquioleate, Tomadol 1200, and Calimulse PRS. In some variations, the hydrocarbon removal composition includes sorbitan sesquioleate, Tomadol 1200, and Calimulse PR. In some variations, the hydrocarbon removal composition includes sorbitan sesquioleate, Tomadol 1200, and Witconate P-1059. In some variations, the hydrocarbon removal composition includes sorbitan sesquioleate, T Det A 267, and sodium lauryl sulfate. In some variations, the hydrocarbon removal composition includes sorbitan sesquioleate, T Det A 267, and sodium lauryl ether sulfates. In some variations, the hydrocarbon removal composition includes sorbitan sesquioleate, T Det A 267, and sodium octyl sulfosuccinate. In some variations, the hydrocarbon removal composition includes sorbitan sesquioleate, T Det A 267, and di sodium octyl sulfosuccinate. In some variations, the hydrocarbon removal composition includes sorbitan sesquioleate, T Det A 267, and sodium oleyl ether carboxylates. In some variations, the hydrocarbon removal composition includes sorbitan sesquioleate, T Det A 267, and alkyl sulfonate. In some variations, the hydrocarbon removal composition includes sorbitan sesquioleate, T Det A 267, and linear alkylbenzene sulfonate. In some variations, the hydrocarbon removal composition includes sorbitan sesquioleate, T Det A 267, and a branched alkylbenzene sulfonate. In some variations, the hydrocarbon removal composition includes sorbitan sesquioleate, T Det A 267, and a linear alkylbenzene sulfonate. In some variations, the hydrocarbon removal composition includes sorbitan sesquioleate, T Det A 267, and Calimulse PRS. In some variations, the hydrocarbon removal composition includes sorbitan sesquioleate, T Det A 267, and Calimulse PR. In some variations, the hydrocarbon removal composition includes sorbitan sesquioleate, T Det A 267, and Witconate P-1059. In some variations, the hydrocarbon removal composition includes sorbitan sesquioleate, Tomadol 1-3, and sodium lauryl sulfate. In some variations, the hydrocarbon removal composition includes sorbitan sesquioleate, Tomadol 1-3, and sodium lauryl ether sulfates. In some variations, the hydrocarbon removal composition includes sorbitan sesquioleate, Tomadol 1-3, and sodium octyl sulfosuccinate. In some variations, the hydrocarbon removal composition includes sorbitan sesquioleate, Tomadol 1-3, and di sodium octyl sulfosuccinate. In some variations, the hydrocarbon removal composition includes sorbitan sesquioleate, Tomadol 1-3, and sodium oleyl ether carboxylates. In some variations, the hydrocarbon removal composition includes sorbitan sesquioleate, Tomadol 1-3, and alkyl sulfonate. In some variations, the hydrocarbon removal composition includes sorbitan sesquioleate, Tomadol 1-3, and linear alkylbenzene sulfonate. In some variations, the hydrocarbon removal composition includes sorbitan sesquioleate, Tomadol 1-3, and a branched alkylbenzene sulfonate. In some variations, the hydrocarbon removal composition includes sorbitan sesquioleate, Tomadol 1-3, and a linear alkylbenzene sulfonate. In some variations, the hydrocarbon removal composition includes sorbitan sesquioleate, Tomadol 1-3, and Calimulse PRS. In some variations, the hydrocarbon removal composition includes sorbitan sesquioleate, Tomadol 1-3, and Calimulse PR. In some variations, the hydrocarbon removal composition includes sorbitan sesquioleate, Tomadol 1-3, and Witconate P-1059.

In some variations, the hydrocarbon removal composition includes sorbitan trioleate, Dyno 607, and sodium lauryl sulfate. In some variations, the hydrocarbon removal composition includes sorbitan trioleate, Dyno 607, and sodium lauryl ether sulfates. In some variations, the hydrocarbon removal composition includes sorbitan trioleate, Dyno 607, and sodium octyl sulfosuccinate. In some variations, the hydrocarbon removal composition includes sorbitan trioleate, Dyno 607, and di sodium octyl sulfosuccinate. In some variations, the hydrocarbon removal composition includes sorbitan trioleate, Dyno 607, and sodium oleyl ether carboxylates. In some variations, the hydrocarbon removal composition includes sorbitan trioleate, Dyno 607, and alkyl sulfonate. In some variations, the hydrocarbon removal composition includes sorbitan trioleate, Dyno 607, and linear alkylbenzene sulfonate. In some variations, the hydrocarbon removal composition includes sorbitan trioleate, Dyno 607, and a branched alkylbenzene sulfonate. In some variations, the hydrocarbon removal composition includes sorbitan trioleate, Dyno 607, and a linear alkylbenzene sulfonate. In some variations, the hydrocarbon removal composition includes sorbitan trioleate, Dyno 607, and Calimulse PRS. In some variations, the hydrocarbon removal composition includes sorbitan trioleate, Dyno 607, and Calimulse PR. In some variations, the hydrocarbon removal composition includes sorbitan trioleate, Dyno 607, and Witconate P-1059. In some variations, the hydrocarbon removal composition includes sorbitan trioleate, Surfynol 420, and sodium lauryl sulfate. In some variations, the hydrocarbon removal composition includes sorbitan trioleate, Surfynol 420, and sodium lauryl ether sulfates. In some variations, the hydrocarbon removal composition includes sorbitan trioleate, Surfynol 420, and sodium octyl sulfosuccinate. In some variations, the hydrocarbon removal composition includes sorbitan trioleate, Surfynol 420, and di sodium octyl sulfosuccinate. In some variations, the hydrocarbon removal composition includes sorbitan trioleate, Surfynol 420, and sodium oleyl ether carboxylates. In some variations, the hydrocarbon removal composition includes sorbitan trioleate, Surfynol 420, and alkyl sulfonate. In some variations, the hydrocarbon removal composition includes sorbitan trioleate, Surfynol 420, and linear alkylbenzene sulfonate. In some variations, the hydrocarbon removal composition includes sorbitan trioleate, Surfynol 420, and a branched alkylbenzene sulfonate. In some variations, the hydrocarbon removal composition includes sorbitan trioleate, Surfynol 420, and a linear alkylbenzene sulfonate. In some variations, the hydrocarbon removal composition includes sorbitan trioleate, Surfynol 420, and Calimulse PRS. In some variations, the hydrocarbon removal composition includes sorbitan trioleate, Surfynol 420, and Calimulse PR. In some variations, the hydrocarbon removal composition includes sorbitan trioleate, Surfynol 420, and Witconate P-1059. In some variations, the hydrocarbon removal composition includes sorbitan trioleate, Surfynol 440, and sodium lauryl sulfate. In some variations, the hydrocarbon removal composition includes sorbitan trioleate, Surfynol 440, and sodium lauryl ether sulfates. In some variations, the hydrocarbon removal composition includes sorbitan trioleate, Surfynol 440, and sodium octyl sulfosuccinate. In some variations, the hydrocarbon removal composition includes sorbitan trioleate, Surfynol 440, and di sodium octyl sulfosuccinate. In some variations, the hydrocarbon removal composition includes sorbitan trioleate, Surfynol 440, and sodium oleyl ether carboxylates. In some variations, the hydrocarbon removal composition includes sorbitan trioleate, Surfynol 440, and alkyl sulfonate. In some variations, the hydrocarbon removal composition includes sorbitan trioleate, Surfynol 440, and linear alkylbenzene sulfonate. In some variations, the hydrocarbon removal composition includes sorbitan trioleate, Surfynol 440, and a branched alkylbenzene sulfonate. In some variations, the hydrocarbon removal composition includes sorbitan trioleate, Surfynol 440, and a linear alkylbenzene sulfonate. In some variations, the hydrocarbon removal composition includes sorbitan trioleate, Surfynol 440, and Calimulse PRS. In some variations, the hydrocarbon removal composition includes sorbitan trioleate, Surfynol 440, and Calimulse PR. In some variations, the hydrocarbon removal composition includes sorbitan trioleate, Surfynol 440, and Witconate P-1059. In some variations, the hydrocarbon removal composition includes sorbitan trioleate, Surfynol 465, and sodium lauryl sulfate. In some variations, the hydrocarbon removal composition includes sorbitan trioleate, Surfynol 465, and sodium lauryl ether sulfates. In some variations, the hydrocarbon removal composition includes sorbitan trioleate, Surfynol 465, and sodium octyl sulfosuccinate. In some variations, the hydrocarbon removal composition includes sorbitan trioleate, Surfynol 465, and di sodium octyl sulfosuccinate. In some variations, the hydrocarbon removal composition includes sorbitan trioleate, Surfynol 465, and sodium oleyl ether carboxylates. In some variations, the hydrocarbon removal composition includes sorbitan trioleate, Surfynol 465, and alkyl sulfonate. In some variations, the hydrocarbon removal composition includes sorbitan trioleate, Surfynol 465, and linear alkylbenzene sulfonate. In some variations, the hydrocarbon removal composition includes sorbitan trioleate, Surfynol 465, and a branched alkylbenzene sulfonate. In some variations, the hydrocarbon removal composition includes sorbitan trioleate, Surfynol 465, and a linear alkylbenzene sulfonate. In some variations, the hydrocarbon removal composition includes sorbitan trioleate, Surfynol 465, and Calimulse PRS. In some variations, the hydrocarbon removal composition includes sorbitan trioleate, Surfynol 465, and Calimulse PR. In some variations, the hydrocarbon removal composition includes sorbitan trioleate, Surfynol 465, and Witconate P-1059. In some variations, the hydrocarbon removal composition includes sorbitan trioleate, Surfynol 485, and sodium lauryl sulfate. In some variations, the hydrocarbon removal composition includes sorbitan trioleate, Surfynol 485, and sodium lauryl ether sulfates. In some variations, the hydrocarbon removal composition includes sorbitan trioleate, Surfynol 485, and sodium octyl sulfosuccinate. In some variations, the hydrocarbon removal composition includes sorbitan trioleate, Surfynol 485, and di sodium octyl sulfosuccinate. In some variations, the hydrocarbon removal composition includes sorbitan trioleate, Surfynol 485, and sodium oleyl ether carboxylates. In some variations, the hydrocarbon removal composition includes sorbitan trioleate, Surfynol 485, and alkyl sulfonate. In some variations, the hydrocarbon removal composition includes sorbitan trioleate, Surfynol 485, and linear alkylbenzene sulfonate. In some variations, the hydrocarbon removal composition includes sorbitan trioleate, Surfynol 485, and a branched alkylbenzene sulfonate. In some variations, the hydrocarbon removal composition includes sorbitan trioleate, Surfynol 485, and a linear alkylbenzene sulfonate. In some variations, the hydrocarbon removal composition includes sorbitan trioleate, Surfynol 485, and Calimulse PRS. In some variations, the hydrocarbon removal composition includes sorbitan trioleate, Surfynol 485, and Calimulse PR. In some variations, the hydrocarbon removal composition includes sorbitan trioleate, Surfynol 485, and Witconate P-1059. In some variations, the hydrocarbon removal composition includes sorbitan trioleate, Dyno 604, and sodium lauryl sulfate. In some variations, the hydrocarbon removal composition includes sorbitan trioleate, Dyno 604, and sodium lauryl ether sulfates. In some variations, the hydrocarbon removal composition includes sorbitan trioleate, Dyno 604, and sodium octyl sulfosuccinate. In some variations, the hydrocarbon removal composition includes sorbitan trioleate, Dyno 604, and di sodium octyl sulfosuccinate. In some variations, the hydrocarbon removal composition includes sorbitan trioleate, Dyno 604, and sodium oleyl ether carboxylates. In some variations, the hydrocarbon removal composition includes sorbitan trioleate, Dyno 604, and alkyl sulfonate. In some variations, the hydrocarbon removal composition includes sorbitan trioleate, Dyno 604, and linear alkylbenzene sulfonate. In some variations, the hydrocarbon removal composition includes sorbitan trioleate, Dyno 604, and a branched alkylbenzene sulfonate. In some variations, the hydrocarbon removal composition includes sorbitan trioleate, Dyno 604, and a linear alkylbenzene sulfonate. In some variations, the hydrocarbon removal composition includes sorbitan trioleate, Dyno 604, and Calimulse PRS. In some variations, the hydrocarbon removal composition includes sorbitan trioleate, Dyno 604, and Calimulse PR. In some variations, the hydrocarbon removal composition includes sorbitan trioleate, Dyno 604, and Witconate P-1059. In some variations, the hydrocarbon removal composition includes sorbitan trioleate, Tomadol 91-2.5, and sodium lauryl sulfate. In some variations, the hydrocarbon removal composition includes sorbitan trioleate, Tomadol 91-2.5, and sodium lauryl ether sulfates. In some variations, the hydrocarbon removal composition includes sorbitan trioleate, Tomadol 91-2.5, and sodium octyl sulfosuccinate. In some variations, the hydrocarbon removal composition includes sorbitan trioleate, Tomadol 91-2.5, and di sodium octyl sulfosuccinate. In some variations, the hydrocarbon removal composition includes sorbitan trioleate, Tomadol 91-2.5, and sodium oleyl ether carboxylates. In some variations, the hydrocarbon removal composition includes sorbitan trioleate, Tomadol 91-2.5, and alkyl sulfonate. In some variations, the hydrocarbon removal composition includes sorbitan trioleate, Tomadol 91-2.5, and linear alkylbenzene sulfonate. In some variations, the hydrocarbon removal composition includes sorbitan trioleate, Tomadol 91-2.5, and a branched alkylbenzene sulfonate. In some variations, the hydrocarbon removal composition includes sorbitan trioleate, Tomadol 91-2.5, and a linear alkylbenzene sulfonate. In some variations, the hydrocarbon removal composition includes sorbitan trioleate, Tomadol 91-2.5, and Calimulse PRS. In some variations, the hydrocarbon removal composition includes sorbitan trioleate, Tomadol 91-2.5, and Calimulse PR. In some variations, the hydrocarbon removal composition includes sorbitan trioleate, Tomadol 91-2.5, and Witconate P-1059. In some variations, the hydrocarbon removal composition includes sorbitan trioleate, Tomadol 91-6, and sodium lauryl sulfate. In some variations, the hydrocarbon removal composition includes sorbitan trioleate, Tomadol 91-6, and sodium lauryl ether sulfates. In some variations, the hydrocarbon removal composition includes sorbitan trioleate, Tomadol 91-6, and sodium octyl sulfosuccinate. In some variations, the hydrocarbon removal composition includes sorbitan trioleate, Tomadol 91-6, and di sodium octyl sulfosuccinate. In some variations, the hydrocarbon removal composition includes sorbitan trioleate, Tomadol 91-6, and sodium oleyl ether carboxylates. In some variations, the hydrocarbon removal composition includes sorbitan trioleate, Tomadol 91-6, and alkyl sulfonate. In some variations, the hydrocarbon removal composition includes sorbitan trioleate, Tomadol 91-6, and linear alkylbenzene sulfonate. In some variations, the hydrocarbon removal composition includes sorbitan trioleate, Tomadol 91-6, and a branched alkylbenzene sulfonate. In some variations, the hydrocarbon removal composition includes sorbitan trioleate, Tomadol 91-6, and a linear alkylbenzene sulfonate. In some variations, the hydrocarbon removal composition includes sorbitan trioleate, Tomadol 91-6, and Calimulse PRS. In some variations, the hydrocarbon removal composition includes sorbitan trioleate, Tomadol 91-6, and Calimulse PR. In some variations, the hydrocarbon removal composition includes sorbitan trioleate, Tomadol 91-6, and Witconate P-1059. In some variations, the hydrocarbon removal composition includes sorbitan trioleate, Tomadol 91-8, and sodium lauryl sulfate. In some variations, the hydrocarbon removal composition includes sorbitan trioleate, Tomadol 91-8, and sodium lauryl ether sulfates. In some variations, the hydrocarbon removal composition includes sorbitan trioleate, Tomadol 91-8, and sodium octyl sulfosuccinate. In some variations, the hydrocarbon removal composition includes sorbitan trioleate, Tomadol 91-8, and di sodium octyl sulfosuccinate. In some variations, the hydrocarbon removal composition includes sorbitan trioleate, Tomadol 91-8, and sodium oleyl ether carboxylates. In some variations, the hydrocarbon removal composition includes sorbitan trioleate, Tomadol 91-8, and alkyl sulfonate. In some variations, the hydrocarbon removal composition includes sorbitan trioleate, Tomadol 91-8, and linear alkylbenzene sulfonate. In some variations, the hydrocarbon removal composition includes sorbitan trioleate, Tomadol 91-8, and a branched alkylbenzene sulfonate. In some variations, the hydrocarbon removal composition includes sorbitan trioleate, Tomadol 91-8, and a linear alkylbenzene sulfonate. In some variations, the hydrocarbon removal composition includes sorbitan trioleate, Tomadol 91-8, and Calimulse PRS. In some variations, the hydrocarbon removal composition includes sorbitan trioleate, Tomadol 91-8, and Calimulse PR. In some variations, the hydrocarbon removal composition includes sorbitan trioleate, Tomadol 91-8, and Witconate P-1059. In some variations, the hydrocarbon removal composition includes sorbitan trioleate, Tomadol 1200, and sodium lauryl sulfate. In some variations, the hydrocarbon removal composition includes sorbitan trioleate, Tomadol 1200, and sodium lauryl ether sulfates. In some variations, the hydrocarbon removal composition includes sorbitan trioleate, Tomadol 1200, and sodium octyl sulfosuccinate. In some variations, the hydrocarbon removal composition includes sorbitan trioleate, Tomadol 1200, and di sodium octyl sulfosuccinate. In some variations, the hydrocarbon removal composition includes sorbitan trioleate, Tomadol 1200, and sodium oleyl ether carboxylates. In some variations, the hydrocarbon removal composition includes sorbitan trioleate, Tomadol 1200, and alkyl sulfonate. In some variations, the hydrocarbon removal composition includes sorbitan trioleate, Tomadol 1200, and linear alkylbenzene sulfonate. In some variations, the hydrocarbon removal composition includes sorbitan trioleate, Tomadol 1200, and a branched alkylbenzene sulfonate. In some variations, the hydrocarbon removal composition includes sorbitan trioleate, Tomadol 1200, and a linear alkylbenzene sulfonate. In some variations, the hydrocarbon removal composition includes sorbitan trioleate, Tomadol 1200, and Calimulse PRS. In some variations, the hydrocarbon removal composition includes sorbitan trioleate, Tomadol 1200, and Calimulse PR. In some variations, the hydrocarbon removal composition includes sorbitan trioleate, Tomadol 1200, and Witconate P-1059. In some variations, the hydrocarbon removal composition includes sorbitan trioleate, T Det A 267, and sodium lauryl sulfate. In some variations, the hydrocarbon removal composition includes sorbitan trioleate, T Det A 267, and sodium lauryl ether sulfates. In some variations, the hydrocarbon removal composition includes sorbitan trioleate, T Det A 267, and sodium octyl sulfosuccinate. In some variations, the hydrocarbon removal composition includes sorbitan trioleate, T Det A 267, and di sodium octyl sulfosuccinate. In some variations, the hydrocarbon removal composition includes sorbitan trioleate, T Det A 267, and sodium oleyl ether carboxylates. In some variations, the hydrocarbon removal composition includes sorbitan trioleate, T Det A 267, and alkyl sulfonate. In some variations, the hydrocarbon removal composition includes sorbitan trioleate, T Det A 267, and linear alkylbenzene sulfonate. In some variations, the hydrocarbon removal composition includes sorbitan trioleate, T Det A 267, and a branched alkylbenzene sulfonate. In some variations, the hydrocarbon removal composition includes sorbitan trioleate, T Det A 267, and a linear alkylbenzene sulfonate. In some variations, the hydrocarbon removal composition includes sorbitan trioleate, T Det A 267, and Calimulse PRS. In some variations, the hydrocarbon removal composition includes sorbitan trioleate, T Det A 267, and Calimulse PR. In some variations, the hydrocarbon removal composition includes sorbitan trioleate, T Det A 267, and Witconate P-1059. In some variations, the hydrocarbon removal composition includes sorbitan trioleate, Tomadol 1-3, and sodium lauryl sulfate. In some variations, the hydrocarbon removal composition includes sorbitan trioleate, Tomadol 1-3, and sodium lauryl ether sulfates. In some variations, the hydrocarbon removal composition includes sorbitan trioleate, Tomadol 1-3, and sodium octyl sulfosuccinate. In some variations, the hydrocarbon removal composition includes sorbitan trioleate, Tomadol 1-3, and di sodium octyl sulfosuccinate. In some variations, the hydrocarbon removal composition includes sorbitan trioleate, Tomadol 1-3, and sodium oleyl ether carboxylates. In some variations, the hydrocarbon removal composition includes sorbitan trioleate, Tomadol 1-3, and alkyl sulfonate. In some variations, the hydrocarbon removal composition includes sorbitan trioleate, Tomadol 1-3, and linear alkylbenzene sulfonate. In some variations, the hydrocarbon removal composition includes sorbitan trioleate, Tomadol 1-3, and a branched alkylbenzene sulfonate. In some variations, the hydrocarbon removal composition includes sorbitan trioleate, Tomadol 1-3, and a linear alkylbenzene sulfonate. In some variations, the hydrocarbon removal composition includes sorbitan trioleate, Tomadol 1-3, and Calimulse PRS. In some variations, the hydrocarbon removal composition includes sorbitan trioleate, Tomadol 1-3, and Calimulse PR. In some variations, the hydrocarbon removal composition includes sorbitan trioleate, Tomadol 1-3, and Witconate P-1059.

In some variations, the hydrocarbon removal composition includes sorbitan tristearate, Dyno 607, and sodium lauryl sulfate. In some variations, the hydrocarbon removal composition includes sorbitan tristearate, Dyno 607, and sodium lauryl ether sulfates. In some variations, the hydrocarbon removal composition includes sorbitan tristearate, Dyno 607, and sodium octyl sulfosuccinate. In some variations, the hydrocarbon removal composition includes sorbitan tristearate, Dyno 607, and di sodium octyl sulfosuccinate. In some variations, the hydrocarbon removal composition includes sorbitan tristearate, Dyno 607, and sodium oleyl ether carboxylates. In some variations, the hydrocarbon removal composition includes sorbitan tristearate, Dyno 607, and alkyl sulfonate. In some variations, the hydrocarbon removal composition includes sorbitan tristearate, Dyno 607, and linear alkylbenzene sulfonate. In some variations, the hydrocarbon removal composition includes sorbitan tristearate, Dyno 607, and a branched alkylbenzene sulfonate. In some variations, the hydrocarbon removal composition includes sorbitan tristearate, Dyno 607, and a linear alkylbenzene sulfonate. In some variations, the hydrocarbon removal composition includes sorbitan tristearate, Dyno 607, and Calimulse PRS. In some variations, the hydrocarbon removal composition includes sorbitan tristearate, Dyno 607, and Calimulse PR. In some variations, the hydrocarbon removal composition includes sorbitan tristearate, Dyno 607, and Witconate P-1059. In some variations, the hydrocarbon removal composition includes sorbitan tristearate, Surfynol 420, and sodium lauryl sulfate. In some variations, the hydrocarbon removal composition includes sorbitan tristearate, Surfynol 420, and sodium lauryl ether sulfates. In some variations, the hydrocarbon removal composition includes sorbitan tristearate, Surfynol 420, and sodium octyl sulfosuccinate. In some variations, the hydrocarbon removal composition includes sorbitan tristearate, Surfynol 420, and di sodium octyl sulfosuccinate. In some variations, the hydrocarbon removal composition includes sorbitan tristearate, Surfynol 420, and sodium oleyl ether carboxylates. In some variations, the hydrocarbon removal composition includes sorbitan tristearate, Surfynol 420, and alkyl sulfonate. In some variations, the hydrocarbon removal composition includes sorbitan tristearate, Surfynol 420, and linear alkylbenzene sulfonate. In some variations, the hydrocarbon removal composition includes sorbitan tristearate, Surfynol 420, and a branched alkylbenzene sulfonate. In some variations, the hydrocarbon removal composition includes sorbitan tristearate, Surfynol 420, and a linear alkylbenzene sulfonate. In some variations, the hydrocarbon removal composition includes sorbitan tristearate, Surfynol 420, and Calimulse PRS. In some variations, the hydrocarbon removal composition includes sorbitan tristearate, Surfynol 420, and Calimulse PR. In some variations, the hydrocarbon removal composition includes sorbitan tristearate, Surfynol 420, and Witconate P-1059. In some variations, the hydrocarbon removal composition includes sorbitan tristearate, Surfynol 440, and sodium lauryl sulfate. In some variations, the hydrocarbon removal composition includes sorbitan tristearate, Surfynol 440, and sodium lauryl ether sulfates. In some variations, the hydrocarbon removal composition includes sorbitan tristearate, Surfynol 440, and sodium octyl sulfosuccinate. In some variations, the hydrocarbon removal composition includes sorbitan tristearate, Surfynol 440, and di sodium octyl sulfosuccinate. In some variations, the hydrocarbon removal composition includes sorbitan tristearate, Surfynol 440, and sodium oleyl ether carboxylates. In some variations, the hydrocarbon removal composition includes sorbitan tristearate, Surfynol 440, and alkyl sulfonate. In some variations, the hydrocarbon removal composition includes sorbitan tristearate, Surfynol 440, and linear alkylbenzene sulfonate. In some variations, the hydrocarbon removal composition includes sorbitan tristearate, Surfynol 440, and a branched alkylbenzene sulfonate. In some variations, the hydrocarbon removal composition includes sorbitan tristearate, Surfynol 440, and a linear alkylbenzene sulfonate. In some variations, the hydrocarbon removal composition includes sorbitan tristearate, Surfynol 440, and Calimulse PRS. In some variations, the hydrocarbon removal composition includes sorbitan tristearate, Surfynol 440, and Calimulse PR. In some variations, the hydrocarbon removal composition includes sorbitan tristearate, Surfynol 440, and Witconate P-1059. In some variations, the hydrocarbon removal composition includes sorbitan tristearate, Surfynol 465, and sodium lauryl sulfate. In some variations, the hydrocarbon removal composition includes sorbitan tristearate, Surfynol 465, and sodium lauryl ether sulfates. In some variations, the hydrocarbon removal composition includes sorbitan tristearate, Surfynol 465, and sodium octyl sulfosuccinate. In some variations, the hydrocarbon removal composition includes sorbitan tristearate, Surfynol 465, and di sodium octyl sulfosuccinate. In some variations, the hydrocarbon removal composition includes sorbitan tristearate, Surfynol 465, and sodium oleyl ether carboxylates. In some variations, the hydrocarbon removal composition includes sorbitan tristearate, Surfynol 465, and alkyl sulfonate. In some variations, the hydrocarbon removal composition includes sorbitan tristearate, Surfynol 465, and linear alkylbenzene sulfonate. In some variations, the hydrocarbon removal composition includes sorbitan tristearate, Surfynol 465, and a branched alkylbenzene sulfonate. In some variations, the hydrocarbon removal composition includes sorbitan tristearate, Surfynol 465, and a linear alkylbenzene sulfonate. In some variations, the hydrocarbon removal composition includes sorbitan tristearate, Surfynol 465, and Calimulse PRS. In some variations, the hydrocarbon removal composition includes sorbitan tristearate, Surfynol 465, and Calimulse PR. In some variations, the hydrocarbon removal composition includes sorbitan tristearate, Surfynol 465, and Witconate P-1059. In some variations, the hydrocarbon removal composition includes sorbitan tristearate, Surfynol 485, and sodium lauryl sulfate. In some variations, the hydrocarbon removal composition includes sorbitan tristearate, Surfynol 485, and sodium lauryl ether sulfates. In some variations, the hydrocarbon removal composition includes sorbitan tristearate, Surfynol 485, and sodium octyl sulfosuccinate. In some variations, the hydrocarbon removal composition includes sorbitan tristearate, Surfynol 485, and di sodium octyl sulfosuccinate. In some variations, the hydrocarbon removal composition includes sorbitan tristearate, Surfynol 485, and sodium oleyl ether carboxylates. In some variations, the hydrocarbon removal composition includes sorbitan tristearate, Surfynol 485, and alkyl sulfonate. In some variations, the hydrocarbon removal composition includes sorbitan tristearate, Surfynol 485, and linear alkylbenzene sulfonate. In some variations, the hydrocarbon removal composition includes sorbitan tristearate, Surfynol 485, and a branched alkylbenzene sulfonate. In some variations, the hydrocarbon removal composition includes sorbitan tristearate, Surfynol 485, and a linear alkylbenzene sulfonate. In some variations, the hydrocarbon removal composition includes sorbitan tristearate, Surfynol 485, and Calimulse PRS. In some variations, the hydrocarbon removal composition includes sorbitan tristearate, Surfynol 485, and Calimulse PR. In some variations, the hydrocarbon removal composition includes sorbitan tristearate, Surfynol 485, and Witconate P-1059. In some variations, the hydrocarbon removal composition includes sorbitan tristearate, Dyno 604, and sodium lauryl sulfate. In some variations, the hydrocarbon removal composition includes sorbitan tristearate, Dyno 604, and sodium lauryl ether sulfates. In some variations, the hydrocarbon removal composition includes sorbitan tristearate, Dyno 604, and sodium octyl sulfosuccinate. In some variations, the hydrocarbon removal composition includes sorbitan tristearate, Dyno 604, and di sodium octyl sulfosuccinate. In some variations, the hydrocarbon removal composition includes sorbitan tristearate, Dyno 604, and sodium oleyl ether carboxylates. In some variations, the hydrocarbon removal composition includes sorbitan tristearate, Dyno 604, and alkyl sulfonate. In some variations, the hydrocarbon removal composition includes sorbitan tristearate, Dyno 604, and linear alkylbenzene sulfonate. In some variations, the hydrocarbon removal composition includes sorbitan tristearate, Dyno 604, and a branched alkylbenzene sulfonate. In some variations, the hydrocarbon removal composition includes sorbitan tristearate, Dyno 604, and a linear alkylbenzene sulfonate. In some variations, the hydrocarbon removal composition includes sorbitan tristearate, Dyno 604, and Calimulse PRS. In some variations, the hydrocarbon removal composition includes sorbitan tristearate, Dyno 604, and Calimulse PR. In some variations, the hydrocarbon removal composition includes sorbitan tristearate, Dyno 604, and Witconate P-1059. In some variations, the hydrocarbon removal composition includes sorbitan tristearate, Tomadol 91-2.5, and sodium lauryl sulfate. In some variations, the hydrocarbon removal composition includes sorbitan tristearate, Tomadol 91-2.5, and sodium lauryl ether sulfates. In some variations, the hydrocarbon removal composition includes sorbitan tristearate, Tomadol 91-2.5, and sodium octyl sulfosuccinate. In some variations, the hydrocarbon removal composition includes sorbitan tristearate, Tomadol 91-2.5, and di sodium octyl sulfosuccinate. In some variations, the hydrocarbon removal composition includes sorbitan tristearate, Tomadol 91-2.5, and sodium oleyl ether carboxylates. In some variations, the hydrocarbon removal composition includes sorbitan tristearate, Tomadol 91-2.5, and alkyl sulfonate. In some variations, the hydrocarbon removal composition includes sorbitan tristearate, Tomadol 91-2.5, and linear alkylbenzene sulfonate. In some variations, the hydrocarbon removal composition includes sorbitan tristearate, Tomadol 91-2.5, and a branched alkylbenzene sulfonate. In some variations, the hydrocarbon removal composition includes sorbitan tristearate, Tomadol 91-2.5, and a linear alkylbenzene sulfonate. In some variations, the hydrocarbon removal composition includes sorbitan tristearate, Tomadol 91-2.5, and Calimulse PRS. In some variations, the hydrocarbon removal composition includes sorbitan tristearate, Tomadol 91-2.5, and Calimulse PR. In some variations, the hydrocarbon removal composition includes sorbitan tristearate, Tomadol 91-2.5, and Witconate P-1059. In some variations, the hydrocarbon removal composition includes sorbitan tristearate, Tomadol 91-6, and sodium lauryl sulfate. In some variations, the hydrocarbon removal composition includes sorbitan tristearate, Tomadol 91-6, and sodium lauryl ether sulfates. In some variations, the hydrocarbon removal composition includes sorbitan tristearate, Tomadol 91-6, and sodium octyl sulfosuccinate. In some variations, the hydrocarbon removal composition includes sorbitan tristearate, Tomadol 91-6, and di sodium octyl sulfosuccinate. In some variations, the hydrocarbon removal composition includes sorbitan tristearate, Tomadol 91-6, and sodium oleyl ether carboxylates. In some variations, the hydrocarbon removal composition includes sorbitan tristearate, Tomadol 91-6, and alkyl sulfonate. In some variations, the hydrocarbon removal composition includes sorbitan tristearate, Tomadol 91-6, and linear alkylbenzene sulfonate. In some variations, the hydrocarbon removal composition includes sorbitan tristearate, Tomadol 91-6, and a branched alkylbenzene sulfonate. In some variations, the hydrocarbon removal composition includes sorbitan tristearate, Tomadol 91-6, and a linear alkylbenzene sulfonate. In some variations, the hydrocarbon removal composition includes sorbitan tristearate, Tomadol 91-6, and Calimulse PRS. In some variations, the hydrocarbon removal composition includes sorbitan tristearate, Tomadol 91-6, and Calimulse PR. In some variations, the hydrocarbon removal composition includes sorbitan tristearate, Tomadol 91-6, and Witconate P-1059. In some variations, the hydrocarbon removal composition includes sorbitan tristearate, Tomadol 91-8, and sodium lauryl sulfate. In some variations, the hydrocarbon removal composition includes sorbitan tristearate, Tomadol 91-8, and sodium lauryl ether sulfates. In some variations, the hydrocarbon removal composition includes sorbitan tristearate, Tomadol 91-8, and sodium octyl sulfosuccinate. In some variations, the hydrocarbon removal composition includes sorbitan tristearate, Tomadol 91-8, and di sodium octyl sulfosuccinate. In some variations, the hydrocarbon removal composition includes sorbitan tristearate, Tomadol 91-8, and sodium oleyl ether carboxylates. In some variations, the hydrocarbon removal composition includes sorbitan tristearate, Tomadol 91-8, and alkyl sulfonate. In some variations, the hydrocarbon removal composition includes sorbitan tristearate, Tomadol 91-8, and linear alkylbenzene sulfonate. In some variations, the hydrocarbon removal composition includes sorbitan tristearate, Tomadol 91-8, and a branched alkylbenzene sulfonate. In some variations, the hydrocarbon removal composition includes sorbitan tristearate, Tomadol 91-8, and a linear alkylbenzene sulfonate. In some variations, the hydrocarbon removal composition includes sorbitan tristearate, Tomadol 91-8, and Calimulse PRS. In some variations, the hydrocarbon removal composition includes sorbitan tristearate, Tomadol 91-8, and Calimulse PR. In some variations, the hydrocarbon removal composition includes sorbitan tristearate, Tomadol 91-8, and Witconate P-1059. In some variations, the hydrocarbon removal composition includes sorbitan tristearate, Tomadol 1200, and sodium lauryl sulfate. In some variations, the hydrocarbon removal composition includes sorbitan tristearate, Tomadol 1200, and sodium lauryl ether sulfates. In some variations, the hydrocarbon removal composition includes sorbitan tristearate, Tomadol 1200, and sodium octyl sulfosuccinate. In some variations, the hydrocarbon removal composition includes sorbitan tristearate, Tomadol 1200, and di sodium octyl sulfosuccinate. In some variations, the hydrocarbon removal composition includes sorbitan tristearate, Tomadol 1200, and sodium oleyl ether carboxylates. In some variations, the hydrocarbon removal composition includes sorbitan tristearate, Tomadol 1200, and alkyl sulfonate. In some variations, the hydrocarbon removal composition includes sorbitan tristearate, Tomadol 1200, and linear alkylbenzene sulfonate. In some variations, the hydrocarbon removal composition includes sorbitan tristearate, Tomadol 1200, and a branched alkylbenzene sulfonate. In some variations, the hydrocarbon removal composition includes sorbitan tristearate, Tomadol 1200, and a linear alkylbenzene sulfonate. In some variations, the hydrocarbon removal composition includes sorbitan tristearate, Tomadol 1200, and Calimulse PRS. In some variations, the hydrocarbon removal composition includes sorbitan tristearate, Tomadol 1200, and Calimulse PR. In some variations, the hydrocarbon removal composition includes sorbitan tristearate, Tomadol 1200, and Witconate P-1059. In some variations, the hydrocarbon removal composition includes sorbitan tristearate, T Det A 267, and sodium lauryl sulfate. In some variations, the hydrocarbon removal composition includes sorbitan tristearate, T Det A 267, and sodium lauryl ether sulfates. In some variations, the hydrocarbon removal composition includes sorbitan tristearate, T Det A 267, and sodium octyl sulfosuccinate. In some variations, the hydrocarbon removal composition includes sorbitan tristearate, T Det A 267, and di sodium octyl sulfosuccinate. In some variations, the hydrocarbon removal composition includes sorbitan tristearate, T Det A 267, and sodium oleyl ether carboxylates. In some variations, the hydrocarbon removal composition includes sorbitan tristearate, T Det A 267, and alkyl sulfonate. In some variations, the hydrocarbon removal composition includes sorbitan tristearate, T Det A 267, and linear alkylbenzene sulfonate. In some variations, the hydrocarbon removal composition includes sorbitan tristearate, T Det A 267, and a branched alkylbenzene sulfonate. In some variations, the hydrocarbon removal composition includes sorbitan tristearate, T Det A 267, and a linear alkylbenzene sulfonate. In some variations, the hydrocarbon removal composition includes sorbitan tristearate, T Det A 267, and Calimulse PRS. In some variations, the hydrocarbon removal composition includes sorbitan tristearate, T Det A 267, and Calimulse PR. In some variations, the hydrocarbon removal composition includes sorbitan tristearate, T Det A 267, and Witconate P-1059. In some variations, the hydrocarbon removal composition includes sorbitan tristearate, Tomadol 1-3, and sodium lauryl sulfate. In some variations, the hydrocarbon removal composition includes sorbitan tristearate, Tomadol 1-3, and sodium lauryl ether sulfates. In some variations, the hydrocarbon removal composition includes sorbitan tristearate, Tomadol 1-3, and sodium octyl sulfosuccinate. In some variations, the hydrocarbon removal composition includes sorbitan tristearate, Tomadol 1-3, and di sodium octyl sulfosuccinate. In some variations, the hydrocarbon removal composition includes sorbitan tristearate, Tomadol 1-3, and sodium oleyl ether carboxylates. In some variations, the hydrocarbon removal composition includes sorbitan tristearate, Tomadol 1-3, and alkyl sulfonate. In some variations, the hydrocarbon removal composition includes sorbitan tristearate, Tomadol 1-3, and linear alkylbenzene sulfonate. In some variations, the hydrocarbon removal composition includes sorbitan tristearate, Tomadol 1-3, and a branched alkylbenzene sulfonate. In some variations, the hydrocarbon removal composition includes sorbitan tristearate, Tomadol 1-3, and a linear alkylbenzene sulfonate. In some variations, the hydrocarbon removal composition includes sorbitan tristearate, Tomadol 1-3, and Calimulse PRS. In some variations, the hydrocarbon removal composition includes sorbitan tristearate, Tomadol 1-3, and Calimulse PR. In some variations, the hydrocarbon removal composition includes sorbitan tristearate, Tomadol 1-3, and Witconate P-1059.

In some variations, the hydrocarbon removal composition includes sorbitan laurate, Dyno 607, and sodium lauryl sulfate. In some variations, the hydrocarbon removal composition includes sorbitan laurate, Dyno 607, and sodium lauryl ether sulfates. In some variations, the hydrocarbon removal composition includes sorbitan laurate, Dyno 607, and sodium octyl sulfosuccinate. In some variations, the hydrocarbon removal composition includes sorbitan laurate, Dyno 607, and di sodium octyl sulfosuccinate. In some variations, the hydrocarbon removal composition includes sorbitan laurate, Dyno 607, and sodium oleyl ether carboxylates. In some variations, the hydrocarbon removal composition includes sorbitan laurate, Dyno 607, and alkyl sulfonate. In some variations, the hydrocarbon removal composition includes sorbitan laurate, Dyno 607, and linear alkylbenzene sulfonate. In some variations, the hydrocarbon removal composition includes sorbitan laurate, Dyno 607, and a branched alkylbenzene sulfonate. In some variations, the hydrocarbon removal composition includes sorbitan laurate, Dyno 607, and a linear alkylbenzene sulfonate. In some variations, the hydrocarbon removal composition includes sorbitan laurate, Dyno 607, and Calimulse PRS. In some variations, the hydrocarbon removal composition includes sorbitan laurate, Dyno 607, and Calimulse PR. In some variations, the hydrocarbon removal composition includes sorbitan laurate, Dyno 607, and Witconate P-1059. In some variations, the hydrocarbon removal composition includes sorbitan laurate, Surfynol 420, and sodium lauryl sulfate. In some variations, the hydrocarbon removal composition includes sorbitan laurate, Surfynol 420, and sodium lauryl ether sulfates. In some variations, the hydrocarbon removal composition includes sorbitan laurate, Surfynol 420, and sodium octyl sulfosuccinate. In some variations, the hydrocarbon removal composition includes sorbitan laurate, Surfynol 420, and di sodium octyl sulfosuccinate. In some variations, the hydrocarbon removal composition includes sorbitan laurate, Surfynol 420, and sodium oleyl ether carboxylates. In some variations, the hydrocarbon removal composition includes sorbitan laurate, Surfynol 420, and alkyl sulfonate. In some variations, the hydrocarbon removal composition includes sorbitan laurate, Surfynol 420, and linear alkylbenzene sulfonate. In some variations, the hydrocarbon removal composition includes sorbitan laurate, Surfynol 420, and a branched alkylbenzene sulfonate. In some variations, the hydrocarbon removal composition includes sorbitan laurate, Surfynol 420, and a linear alkylbenzene sulfonate. In some variations, the hydrocarbon removal composition includes sorbitan laurate, Surfynol 420, and Calimulse PRS. In some variations, the hydrocarbon removal composition includes sorbitan laurate, Surfynol 420, and Calimulse PR. In some variations, the hydrocarbon removal composition includes sorbitan laurate, Surfynol 420, and Witconate P-1059. In some variations, the hydrocarbon removal composition includes sorbitan laurate, Surfynol 440, and sodium lauryl sulfate. In some variations, the hydrocarbon removal composition includes sorbitan laurate, Surfynol 440, and sodium lauryl ether sulfates. In some variations, the hydrocarbon removal composition includes sorbitan laurate, Surfynol 440, and sodium octyl sulfosuccinate. In some variations, the hydrocarbon removal composition includes sorbitan laurate, Surfynol 440, and di sodium octyl sulfosuccinate. In some variations, the hydrocarbon removal composition includes sorbitan laurate, Surfynol 440, and sodium oleyl ether carboxylates. In some variations, the hydrocarbon removal composition includes sorbitan laurate, Surfynol 440, and alkyl sulfonate. In some variations, the hydrocarbon removal composition includes sorbitan laurate, Surfynol 440, and linear alkylbenzene sulfonate. In some variations, the hydrocarbon removal composition includes sorbitan laurate, Surfynol 440, and a branched alkylbenzene sulfonate. In some variations, the hydrocarbon removal composition includes sorbitan laurate, Surfynol 440, and a linear alkylbenzene sulfonate. In some variations, the hydrocarbon removal composition includes sorbitan laurate, Surfynol 440, and Calimulse PRS. In some variations, the hydrocarbon removal composition includes sorbitan laurate, Surfynol 440, and Calimulse PR. In some variations, the hydrocarbon removal composition includes sorbitan laurate, Surfynol 440, and Witconate P-1059. In some variations, the hydrocarbon removal composition includes sorbitan laurate, Surfynol 465, and sodium lauryl sulfate. In some variations, the hydrocarbon removal composition includes sorbitan laurate, Surfynol 465, and sodium lauryl ether sulfates. In some variations, the hydrocarbon removal composition includes sorbitan laurate, Surfynol 465, and sodium octyl sulfosuccinate. In some variations, the hydrocarbon removal composition includes sorbitan laurate, Surfynol 465, and di sodium octyl sulfosuccinate. In some variations, the hydrocarbon removal composition includes sorbitan laurate, Surfynol 465, and sodium oleyl ether carboxylates. In some variations, the hydrocarbon removal composition includes sorbitan laurate, Surfynol 465, and alkyl sulfonate. In some variations, the hydrocarbon removal composition includes sorbitan laurate, Surfynol 465, and linear alkylbenzene sulfonate. In some variations, the hydrocarbon removal composition includes sorbitan laurate, Surfynol 465, and a branched alkylbenzene sulfonate. In some variations, the hydrocarbon removal composition includes sorbitan laurate, Surfynol 465, and a linear alkylbenzene sulfonate. In some variations, the hydrocarbon removal composition includes sorbitan laurate, Surfynol 465, and Calimulse PRS. In some variations, the hydrocarbon removal composition includes sorbitan laurate, Surfynol 465, and Calimulse PR. In some variations, the hydrocarbon removal composition includes sorbitan laurate, Surfynol 465, and Witconate P-1059. In some variations, the hydrocarbon removal composition includes sorbitan laurate, Surfynol 485, and sodium lauryl sulfate. In some variations, the hydrocarbon removal composition includes sorbitan laurate, Surfynol 485, and sodium lauryl ether sulfates. In some variations, the hydrocarbon removal composition includes sorbitan laurate, Surfynol 485, and sodium octyl sulfosuccinate. In some variations, the hydrocarbon removal composition includes sorbitan laurate, Surfynol 485, and di sodium octyl sulfosuccinate. In some variations, the hydrocarbon removal composition includes sorbitan laurate, Surfynol 485, and sodium oleyl ether carboxylates. In some variations, the hydrocarbon removal composition includes sorbitan laurate, Surfynol 485, and alkyl sulfonate. In some variations, the hydrocarbon removal composition includes sorbitan laurate, Surfynol 485, and linear alkylbenzene sulfonate. In some variations, the hydrocarbon removal composition includes sorbitan laurate, Surfynol 485, and a branched alkylbenzene sulfonate. In some variations, the hydrocarbon removal composition includes sorbitan laurate, Surfynol 485, and a linear alkylbenzene sulfonate. In some variations, the hydrocarbon removal composition includes sorbitan laurate, Surfynol 485, and Calimulse PRS. In some variations, the hydrocarbon removal composition includes sorbitan laurate, Surfynol 485, and Calimulse PR. In some variations, the hydrocarbon removal composition includes sorbitan laurate, Surfynol 485, and Witconate P-1059. In some variations, the hydrocarbon removal composition includes sorbitan laurate, Dyno 604, and sodium lauryl sulfate. In some variations, the hydrocarbon removal composition includes sorbitan laurate, Dyno 604, and sodium lauryl ether sulfates. In some variations, the hydrocarbon removal composition includes sorbitan laurate, Dyno 604, and sodium octyl sulfosuccinate. In some variations, the hydrocarbon removal composition includes sorbitan laurate, Dyno 604, and di sodium octyl sulfosuccinate. In some variations, the hydrocarbon removal composition includes sorbitan laurate, Dyno 604, and sodium oleyl ether carboxylates. In some variations, the hydrocarbon removal composition includes sorbitan laurate, Dyno 604, and alkyl sulfonate. In some variations, the hydrocarbon removal composition includes sorbitan laurate, Dyno 604, and linear alkylbenzene sulfonate. In some variations, the hydrocarbon removal composition includes sorbitan laurate, Dyno 604, and a branched alkylbenzene sulfonate. In some variations, the hydrocarbon removal composition includes sorbitan laurate, Dyno 604, and a linear alkylbenzene sulfonate. In some variations, the hydrocarbon removal composition includes sorbitan laurate, Dyno 604, and Calimulse PRS. In some variations, the hydrocarbon removal composition includes sorbitan laurate, Dyno 604, and Calimulse PR. In some variations, the hydrocarbon removal composition includes sorbitan laurate, Dyno 604, and Witconate P-1059. In some variations, the hydrocarbon removal composition includes sorbitan laurate, Tomadol 91-2.5, and sodium lauryl sulfate. In some variations, the hydrocarbon removal composition includes sorbitan laurate, Tomadol 91-2.5, and sodium lauryl ether sulfates. In some variations, the hydrocarbon removal composition includes sorbitan laurate, Tomadol 91-2.5, and sodium octyl sulfosuccinate. In some variations, the hydrocarbon removal composition includes sorbitan laurate, Tomadol 91-2.5, and di sodium octyl sulfosuccinate. In some variations, the hydrocarbon removal composition includes sorbitan laurate, Tomadol 91-2.5, and sodium oleyl ether carboxylates. In some variations, the hydrocarbon removal composition includes sorbitan laurate, Tomadol 91-2.5, and alkyl sulfonate. In some variations, the hydrocarbon removal composition includes sorbitan laurate, Tomadol 91-2.5, and linear alkylbenzene sulfonate. In some variations, the hydrocarbon removal composition includes sorbitan laurate, Tomadol 91-2.5, and a branched alkylbenzene sulfonate. In some variations, the hydrocarbon removal composition includes sorbitan laurate, Tomadol 91-2.5, and a linear alkylbenzene sulfonate. In some variations, the hydrocarbon removal composition includes sorbitan laurate, Tomadol 91-2.5, and Calimulse PRS. In some variations, the hydrocarbon removal composition includes sorbitan laurate, Tomadol 91-2.5, and Calimulse PR. In some variations, the hydrocarbon removal composition includes sorbitan laurate, Tomadol 91-2.5, and Witconate P-1059. In some variations, the hydrocarbon removal composition includes sorbitan laurate, Tomadol 91-6, and sodium lauryl sulfate. In some variations, the hydrocarbon removal composition includes sorbitan laurate, Tomadol 91-6, and sodium lauryl ether sulfates. In some variations, the hydrocarbon removal composition includes sorbitan laurate, Tomadol 91-6, and sodium octyl sulfosuccinate. In some variations, the hydrocarbon removal composition includes sorbitan laurate, Tomadol 91-6, and di sodium octyl sulfosuccinate. In some variations, the hydrocarbon removal composition includes sorbitan laurate, Tomadol 91-6, and sodium oleyl ether carboxylates. In some variations, the hydrocarbon removal composition includes sorbitan laurate, Tomadol 91-6, and alkyl sulfonate. In some variations, the hydrocarbon removal composition includes sorbitan laurate, Tomadol 91-6, and linear alkylbenzene sulfonate. In some variations, the hydrocarbon removal composition includes sorbitan laurate, Tomadol 91-6, and a branched alkylbenzene sulfonate. In some variations, the hydrocarbon removal composition includes sorbitan laurate, Tomadol 91-6, and a linear alkylbenzene sulfonate. In some variations, the hydrocarbon removal composition includes sorbitan laurate, Tomadol 91-6, and Calimulse PRS. In some variations, the hydrocarbon removal composition includes sorbitan laurate, Tomadol 91-6, and Calimulse PR. In some variations, the hydrocarbon removal composition includes sorbitan laurate, Tomadol 91-6, and Witconate P-1059. In some variations, the hydrocarbon removal composition includes sorbitan laurate, Tomadol 91-8, and sodium lauryl sulfate. In some variations, the hydrocarbon removal composition includes sorbitan laurate, Tomadol 91-8, and sodium lauryl ether sulfates. In some variations, the hydrocarbon removal composition includes sorbitan laurate, Tomadol 91-8, and sodium octyl sulfosuccinate. In some variations, the hydrocarbon removal composition includes sorbitan laurate, Tomadol 91-8, and di sodium octyl sulfosuccinate. In some variations, the hydrocarbon removal composition includes sorbitan laurate, Tomadol 91-8, and sodium oleyl ether carboxylates. In some variations, the hydrocarbon removal composition includes sorbitan laurate, Tomadol 91-8, and alkyl sulfonate. In some variations, the hydrocarbon removal composition includes sorbitan laurate, Tomadol 91-8, and linear alkylbenzene sulfonate. In some variations, the hydrocarbon removal composition includes sorbitan laurate, Tomadol 91-8, and a branched alkylbenzene sulfonate. In some variations, the hydrocarbon removal composition includes sorbitan laurate, Tomadol 91-8, and a linear alkylbenzene sulfonate. In some variations, the hydrocarbon removal composition includes sorbitan laurate, Tomadol 91-8, and Calimulse PRS. In some variations, the hydrocarbon removal composition includes sorbitan laurate, Tomadol 91-8, and Calimulse PR. In some variations, the hydrocarbon removal composition includes sorbitan laurate, Tomadol 91-8, and Witconate P-1059. In some variations, the hydrocarbon removal composition includes sorbitan laurate, Tomadol 1200, and sodium lauryl sulfate. In some variations, the hydrocarbon removal composition includes sorbitan laurate, Tomadol 1200, and sodium lauryl ether sulfates. In some variations, the hydrocarbon removal composition includes sorbitan laurate, Tomadol 1200, and sodium octyl sulfosuccinate. In some variations, the hydrocarbon removal composition includes sorbitan laurate, Tomadol 1200, and di sodium octyl sulfosuccinate. In some variations, the hydrocarbon removal composition includes sorbitan laurate, Tomadol 1200, and sodium oleyl ether carboxylates. In some variations, the hydrocarbon removal composition includes sorbitan laurate, Tomadol 1200, and alkyl sulfonate. In some variations, the hydrocarbon removal composition includes sorbitan laurate, Tomadol 1200, and linear alkylbenzene sulfonate. In some variations, the hydrocarbon removal composition includes sorbitan laurate, Tomadol 1200, and a branched alkylbenzene sulfonate. In some variations, the hydrocarbon removal composition includes sorbitan laurate, Tomadol 1200, and a linear alkylbenzene sulfonate. In some variations, the hydrocarbon removal composition includes sorbitan laurate, Tomadol 1200, and Calimulse PRS. In some variations, the hydrocarbon removal composition includes sorbitan laurate, Tomadol 1200, and Calimulse PR. In some variations, the hydrocarbon removal composition includes sorbitan laurate, Tomadol 1200, and Witconate P-1059. In some variations, the hydrocarbon removal composition includes sorbitan laurate, T Det A 267, and sodium lauryl sulfate. In some variations, the hydrocarbon removal composition includes sorbitan laurate, T Det A 267, and sodium lauryl ether sulfates. In some variations, the hydrocarbon removal composition includes sorbitan laurate, T Det A 267, and sodium octyl sulfosuccinate. In some variations, the hydrocarbon removal composition includes sorbitan laurate, T Det A 267, and di sodium octyl sulfosuccinate. In some variations, the hydrocarbon removal composition includes sorbitan laurate, T Det A 267, and sodium oleyl ether carboxylates. In some variations, the hydrocarbon removal composition includes sorbitan laurate, T Det A 267, and alkyl sulfonate. In some variations, the hydrocarbon removal composition includes sorbitan laurate, T Det A 267, and linear alkylbenzene sulfonate. In some variations, the hydrocarbon removal composition includes sorbitan laurate, T Det A 267, and a branched alkylbenzene sulfonate. In some variations, the hydrocarbon removal composition includes sorbitan laurate, T Det A 267, and a linear alkylbenzene sulfonate. In some variations, the hydrocarbon removal composition includes sorbitan laurate, T Det A 267, and Calimulse PRS. In some variations, the hydrocarbon removal composition includes sorbitan laurate, T Det A 267, and Calimulse PR. In some variations, the hydrocarbon removal composition includes sorbitan laurate, T Det A 267, and Witconate P-1059. In some variations, the hydrocarbon removal composition includes sorbitan laurate, Tomadol 1-3, and sodium lauryl sulfate. In some variations, the hydrocarbon removal composition includes sorbitan laurate, Tomadol 1-3, and sodium lauryl ether sulfates. In some variations, the hydrocarbon removal composition includes sorbitan laurate, Tomadol 1-3, and sodium octyl sulfosuccinate. In some variations, the hydrocarbon removal composition includes sorbitan laurate, Tomadol 1-3, and di sodium octyl sulfosuccinate. In some variations, the hydrocarbon removal composition includes sorbitan laurate, Tomadol 1-3, and sodium oleyl ether carboxylates. In some variations, the hydrocarbon removal composition includes sorbitan laurate, Tomadol 1-3, and alkyl sulfonate. In some variations, the hydrocarbon removal composition includes sorbitan laurate, Tomadol 1-3, and linear alkylbenzene sulfonate. In some variations, the hydrocarbon removal composition includes sorbitan laurate, Tomadol 1-3, and a branched alkylbenzene sulfonate. In some variations, the hydrocarbon removal composition includes sorbitan laurate, Tomadol 1-3, and a linear alkylbenzene sulfonate. In some variations, the hydrocarbon removal composition includes sorbitan laurate, Tomadol 1-3, and Calimulse PRS. In some variations, the hydrocarbon removal composition includes sorbitan laurate, Tomadol 1-3, and Calimulse PR. In some variations, the hydrocarbon removal composition includes sorbitan laurate, Tomadol 1-3, and Witconate P-1059.

In some variations, the hydrocarbon removal composition includes Tween 80, Dyno 607, and sodium lauryl sulfate. In some variations, the hydrocarbon removal composition includes Tween 80, Dyno 607, and sodium lauryl ether sulfates. In some variations, the hydrocarbon removal composition includes Tween 80, Dyno 607, and sodium octyl sulfosuccinate. In some variations, the hydrocarbon removal composition includes Tween 80, Dyno 607, and di sodium octyl sulfosuccinate. In some variations, the hydrocarbon removal composition includes Tween 80, Dyno 607, and sodium oleyl ether carboxylates. In some variations, the hydrocarbon removal composition includes Tween 80, Dyno 607, and alkyl sulfonate. In some variations, the hydrocarbon removal composition includes Tween 80, Dyno 607, and linear alkylbenzene sulfonate. In some variations, the hydrocarbon removal composition includes Tween 80, Dyno 607, and a branched alkylbenzene sulfonate. In some variations, the hydrocarbon removal composition includes Tween 80, Dyno 607, and a linear alkylbenzene sulfonate. In some variations, the hydrocarbon removal composition includes Tween 80, Dyno 607, and Calimulse PRS. In some variations, the hydrocarbon removal composition includes Tween 80, Dyno 607, and Calimulse PR. In some variations, the hydrocarbon removal composition includes Tween 80, Dyno 607, and Witconate P-1059. In some variations, the hydrocarbon removal composition includes Tween 80, Surfynol 420, and sodium lauryl sulfate. In some variations, the hydrocarbon removal composition includes Tween 80, Surfynol 420, and sodium lauryl ether sulfates. In some variations, the hydrocarbon removal composition includes Tween 80, Surfynol 420, and sodium octyl sulfosuccinate. In some variations, the hydrocarbon removal composition includes Tween 80, Surfynol 420, and di sodium octyl sulfosuccinate. In some variations, the hydrocarbon removal composition includes Tween 80, Surfynol 420, and sodium oleyl ether carboxylates. In some variations, the hydrocarbon removal composition includes Tween 80, Surfynol 420, and alkyl sulfonate. In some variations, the hydrocarbon removal composition includes Tween 80, Surfynol 420, and linear alkylbenzene sulfonate. In some variations, the hydrocarbon removal composition includes Tween 80, Surfynol 420, and a branched alkylbenzene sulfonate. In some variations, the hydrocarbon removal composition includes Tween 80, Surfynol 420, and a linear alkylbenzene sulfonate. In some variations, the hydrocarbon removal composition includes Tween 80, Surfynol 420, and Calimulse PRS. In some variations, the hydrocarbon removal composition includes Tween 80, Surfynol 420, and Calimulse PR. In some variations, the hydrocarbon removal composition includes Tween 80, Surfynol 420, and Witconate P-1059. In some variations, the hydrocarbon removal composition includes Tween 80, Surfynol 440, and sodium lauryl sulfate. In some variations, the hydrocarbon removal composition includes Tween 80, Surfynol 440, and sodium lauryl ether sulfates. In some variations, the hydrocarbon removal composition includes Tween 80, Surfynol 440, and sodium octyl sulfosuccinate. In some variations, the hydrocarbon removal composition includes Tween 80, Surfynol 440, and di sodium octyl sulfosuccinate. In some variations, the hydrocarbon removal composition includes Tween 80, Surfynol 440, and sodium oleyl ether carboxylates. In some variations, the hydrocarbon removal composition includes Tween 80, Surfynol 440, and alkyl sulfonate. In some variations, the hydrocarbon removal composition includes Tween 80, Surfynol 440, and linear alkylbenzene sulfonate. In some variations, the hydrocarbon removal composition includes Tween 80, Surfynol 440, and a branched alkylbenzene sulfonate. In some variations, the hydrocarbon removal composition includes Tween 80, Surfynol 440, and a linear alkylbenzene sulfonate. In some variations, the hydrocarbon removal composition includes Tween 80, Surfynol 440, and Calimulse PRS. In some variations, the hydrocarbon removal composition includes Tween 80, Surfynol 440, and Calimulse PR. In some variations, the hydrocarbon removal composition includes Tween 80, Surfynol 440, and Witconate P-1059. In some variations, the hydrocarbon removal composition includes Tween 80, Surfynol 465, and sodium lauryl sulfate. In some variations, the hydrocarbon removal composition includes Tween 80, Surfynol 465, and sodium lauryl ether sulfates. In some variations, the hydrocarbon removal composition includes Tween 80, Surfynol 465, and sodium octyl sulfosuccinate. In some variations, the hydrocarbon removal composition includes Tween 80, Surfynol 465, and di sodium octyl sulfosuccinate. In some variations, the hydrocarbon removal composition includes Tween 80, Surfynol 465, and sodium oleyl ether carboxylates. In some variations, the hydrocarbon removal composition includes Tween 80, Surfynol 465, and alkyl sulfonate. In some variations, the hydrocarbon removal composition includes Tween 80, Surfynol 465, and linear alkylbenzene sulfonate. In some variations, the hydrocarbon removal composition includes Tween 80, Surfynol 465, and a branched alkylbenzene sulfonate. In some variations, the hydrocarbon removal composition includes Tween 80, Surfynol 465, and a linear alkylbenzene sulfonate. In some variations, the hydrocarbon removal composition includes Tween 80, Surfynol 465, and Calimulse PRS. In some variations, the hydrocarbon removal composition includes Tween 80, Surfynol 465, and Calimulse PR. In some variations, the hydrocarbon removal composition includes Tween 80, Surfynol 465, and Witconate P-1059. In some variations, the hydrocarbon removal composition includes Tween 80, Surfynol 485, and sodium lauryl sulfate. In some variations, the hydrocarbon removal composition includes Tween 80, Surfynol 485, and sodium lauryl ether sulfates. In some variations, the hydrocarbon removal composition includes Tween 80, Surfynol 485, and sodium octyl sulfosuccinate. In some variations, the hydrocarbon removal composition includes Tween 80, Surfynol 485, and di sodium octyl sulfosuccinate. In some variations, the hydrocarbon removal composition includes Tween 80, Surfynol 485, and sodium oleyl ether carboxylates. In some variations, the hydrocarbon removal composition includes Tween 80, Surfynol 485, and alkyl sulfonate. In some variations, the hydrocarbon removal composition includes Tween 80, Surfynol 485, and linear alkylbenzene sulfonate. In some variations, the hydrocarbon removal composition includes Tween 80, Surfynol 485, and a branched alkylbenzene sulfonate. In some variations, the hydrocarbon removal composition includes Tween 80, Surfynol 485, and a linear alkylbenzene sulfonate. In some variations, the hydrocarbon removal composition includes Tween 80, Surfynol 485, and Calimulse PRS. In some variations, the hydrocarbon removal composition includes Tween 80, Surfynol 485, and Calimulse PR. In some variations, the hydrocarbon removal composition includes Tween 80, Surfynol 485, and Witconate P-1059. In some variations, the hydrocarbon removal composition includes Tween 80, Dyno 604, and sodium lauryl sulfate. In some variations, the hydrocarbon removal composition includes Tween 80, Dyno 604, and sodium lauryl ether sulfates. In some variations, the hydrocarbon removal composition includes Tween 80, Dyno 604, and sodium octyl sulfosuccinate. In some variations, the hydrocarbon removal composition includes Tween 80, Dyno 604, and di sodium octyl sulfosuccinate. In some variations, the hydrocarbon removal composition includes Tween 80, Dyno 604, and sodium oleyl ether carboxylates. In some variations, the hydrocarbon removal composition includes Tween 80, Dyno 604, and alkyl sulfonate. In some variations, the hydrocarbon removal composition includes Tween 80, Dyno 604, and linear alkylbenzene sulfonate. In some variations, the hydrocarbon removal composition includes Tween 80, Dyno 604, and a branched alkylbenzene sulfonate. In some variations, the hydrocarbon removal composition includes Tween 80, Dyno 604, and a linear alkylbenzene sulfonate. In some variations, the hydrocarbon removal composition includes Tween 80, Dyno 604, and Calimulse PRS. In some variations, the hydrocarbon removal composition includes Tween 80, Dyno 604, and Calimulse PR. In some variations, the hydrocarbon removal composition includes Tween 80, Dyno 604, and Witconate P-1059. In some variations, the hydrocarbon removal composition includes Tween 80, Tomadol 91-2.5, and sodium lauryl sulfate. In some variations, the hydrocarbon removal composition includes Tween 80, Tomadol 91-2.5, and sodium lauryl ether sulfates. In some variations, the hydrocarbon removal composition includes Tween 80, Tomadol 91-2.5, and sodium octyl sulfosuccinate. In some variations, the hydrocarbon removal composition includes Tween 80, Tomadol 91-2.5, and di sodium octyl sulfosuccinate. In some variations, the hydrocarbon removal composition includes Tween 80, Tomadol 91-2.5, and sodium oleyl ether carboxylates. In some variations, the hydrocarbon removal composition includes Tween 80, Tomadol 91-2.5, and alkyl sulfonate. In some variations, the hydrocarbon removal composition includes Tween 80, Tomadol 91-2.5, and linear alkylbenzene sulfonate. In some variations, the hydrocarbon removal composition includes Tween 80, Tomadol 91-2.5, and a branched alkylbenzene sulfonate. In some variations, the hydrocarbon removal composition includes Tween 80, Tomadol 91-2.5, and a linear alkylbenzene sulfonate. In some variations, the hydrocarbon removal composition includes Tween 80, Tomadol 91-2.5, and Calimulse PRS. In some variations, the hydrocarbon removal composition includes Tween 80, Tomadol 91-2.5, and Calimulse PR. In some variations, the hydrocarbon removal composition includes Tween 80, Tomadol 91-2.5, and Witconate P-1059. In some variations, the hydrocarbon removal composition includes Tween 80, Tomadol 91-6, and sodium lauryl sulfate. In some variations, the hydrocarbon removal composition includes Tween 80, Tomadol 91-6, and sodium lauryl ether sulfates. In some variations, the hydrocarbon removal composition includes Tween 80, Tomadol 91-6, and sodium octyl sulfosuccinate. In some variations, the hydrocarbon removal composition includes Tween 80, Tomadol 91-6, and di sodium octyl sulfosuccinate. In some variations, the hydrocarbon removal composition includes Tween 80, Tomadol 91-6, and sodium oleyl ether carboxylates. In some variations, the hydrocarbon removal composition includes Tween 80, Tomadol 91-6, and alkyl sulfonate. In some variations, the hydrocarbon removal composition includes Tween 80, Tomadol 91-6, and linear alkylbenzene sulfonate. In some variations, the hydrocarbon removal composition includes Tween 80, Tomadol 91-6, and a branched alkylbenzene sulfonate. In some variations, the hydrocarbon removal composition includes Tween 80, Tomadol 91-6, and a linear alkylbenzene sulfonate. In some variations, the hydrocarbon removal composition includes Tween 80, Tomadol 91-6, and Calimulse PRS. In some variations, the hydrocarbon removal composition includes Tween 80, Tomadol 91-6, and Calimulse PR. In some variations, the hydrocarbon removal composition includes Tween 80, Tomadol 91-6, and Witconate P-1059. In some variations, the hydrocarbon removal composition includes Tween 80, Tomadol 91-8, and sodium lauryl sulfate. In some variations, the hydrocarbon removal composition includes Tween 80, Tomadol 91-8, and sodium lauryl ether sulfates. In some variations, the hydrocarbon removal composition includes Tween 80, Tomadol 91-8, and sodium octyl sulfosuccinate. In some variations, the hydrocarbon removal composition includes Tween 80, Tomadol 91-8, and di sodium octyl sulfosuccinate. In some variations, the hydrocarbon removal composition includes Tween 80, Tomadol 91-8, and sodium oleyl ether carboxylates. In some variations, the hydrocarbon removal composition includes Tween 80, Tomadol 91-8, and alkyl sulfonate. In some variations, the hydrocarbon removal composition includes Tween 80, Tomadol 91-8, and linear alkylbenzene sulfonate. In some variations, the hydrocarbon removal composition includes Tween 80, Tomadol 91-8, and a branched alkylbenzene sulfonate. In some variations, the hydrocarbon removal composition includes Tween 80, Tomadol 91-8, and a linear alkylbenzene sulfonate. In some variations, the hydrocarbon removal composition includes Tween 80, Tomadol 91-8, and Calimulse PRS. In some variations, the hydrocarbon removal composition includes Tween 80, Tomadol 91-8, and Calimulse PR. In some variations, the hydrocarbon removal composition includes Tween 80, Tomadol 91-8, and Witconate P-1059. In some variations, the hydrocarbon removal composition includes Tween 80, Tomadol 1200, and sodium lauryl sulfate. In some variations, the hydrocarbon removal composition includes Tween 80, Tomadol 1200, and sodium lauryl ether sulfates. In some variations, the hydrocarbon removal composition includes Tween 80, Tomadol 1200, and sodium octyl sulfosuccinate. In some variations, the hydrocarbon removal composition includes Tween 80, Tomadol 1200, and di sodium octyl sulfosuccinate. In some variations, the hydrocarbon removal composition includes Tween 80, Tomadol 1200, and sodium oleyl ether carboxylates. In some variations, the hydrocarbon removal composition includes Tween 80, Tomadol 1200, and alkyl sulfonate. In some variations, the hydrocarbon removal composition includes Tween 80, Tomadol 1200, and linear alkylbenzene sulfonate. In some variations, the hydrocarbon removal composition includes Tween 80, Tomadol 1200, and a branched alkylbenzene sulfonate. In some variations, the hydrocarbon removal composition includes Tween 80, Tomadol 1200, and a linear alkylbenzene sulfonate. In some variations, the hydrocarbon removal composition includes Tween 80, Tomadol 1200, and Calimulse PRS. In some variations, the hydrocarbon removal composition includes Tween 80, Tomadol 1200, and Calimulse PR. In some variations, the hydrocarbon removal composition includes Tween 80, Tomadol 1200, and Witconate P-1059. In some variations, the hydrocarbon removal composition includes Tween 80, T Det A 267, and sodium lauryl sulfate. In some variations, the hydrocarbon removal composition includes Tween 80, T Det A 267, and sodium lauryl ether sulfates. In some variations, the hydrocarbon removal composition includes Tween 80, T Det A 267, and sodium octyl sulfosuccinate. In some variations, the hydrocarbon removal composition includes Tween 80, T Det A 267, and di sodium octyl sulfosuccinate. In some variations, the hydrocarbon removal composition includes Tween 80, T Det A 267, and sodium oleyl ether carboxylates. In some variations, the hydrocarbon removal composition includes Tween 80, T Det A 267, and alkyl sulfonate. In some variations, the hydrocarbon removal composition includes Tween 80, T Det A 267, and linear alkylbenzene sulfonate. In some variations, the hydrocarbon removal composition includes Tween 80, T Det A 267, and a branched alkylbenzene sulfonate. In some variations, the hydrocarbon removal composition includes Tween 80, T Det A 267, and a linear alkylbenzene sulfonate. In some variations, the hydrocarbon removal composition includes Tween 80, T Det A 267, and Calimulse PRS. In some variations, the hydrocarbon removal composition includes Tween 80, T Det A 267, and Calimulse PR. In some variations, the hydrocarbon removal composition includes Tween 80, T Det A 267, and Witconate P-1059. In some variations, the hydrocarbon removal composition includes Tween 80, Tomadol 1-3, and sodium lauryl sulfate. In some variations, the hydrocarbon removal composition includes Tween 80, Tomadol 1-3, and sodium lauryl ether sulfates. In some variations, the hydrocarbon removal composition includes Tween 80, Tomadol 1-3, and sodium octyl sulfosuccinate. In some variations, the hydrocarbon removal composition includes Tween 80, Tomadol 1-3, and di sodium octyl sulfosuccinate. In some variations, the hydrocarbon removal composition includes Tween 80, Tomadol 1-3, and sodium oleyl ether carboxylates. In some variations, the hydrocarbon removal composition includes Tween 80, Tomadol 1-3, and alkyl sulfonate. In some variations, the hydrocarbon removal composition includes Tween 80, Tomadol 1-3, and linear alkylbenzene sulfonate. In some variations, the hydrocarbon removal composition includes Tween 80, Tomadol 1-3, and a branched alkylbenzene sulfonate. In some variations, the hydrocarbon removal composition includes Tween 80, Tomadol 1-3, and a linear alkylbenzene sulfonate. In some variations, the hydrocarbon removal composition includes Tween 80, Tomadol 1-3, and Calimulse PRS. In some variations, the hydrocarbon removal composition includes Tween 80, Tomadol 1-3, and Calimulse PR. In some variations, the hydrocarbon removal composition includes Tween 80, Tomadol 1-3, and Witconate P-1059.

In some variations, the hydrocarbon removal composition includes Tween 80, Ecosurf SA-7 Ethoxylated alcohol, and sodium lauryl sulfate. In some variations, the hydrocarbon removal composition includes Tween 80, Ecosurf SA-7 Ethoxylated alcohol, and sodium lauryl ether sulfates. In some variations, the hydrocarbon removal composition includes Tween 80, Ecosurf SA-7 Ethoxylated alcohol, and sodium octyl sulfosuccinate. In some variations, the hydrocarbon removal composition includes Tween 80, Ecosurf SA-7 Ethoxylated alcohol, and di sodium octyl sulfosuccinate. In some variations, the hydrocarbon removal composition includes Tween 80, Ecosurf SA-7 Ethoxylated alcohol, and sodium oleyl ether carboxylates. In some variations, the hydrocarbon removal composition includes Tween 80, Ecosurf SA-7 Ethoxylated alcohol, and alkyl sulfonate. In some variations, the hydrocarbon removal composition includes Tween 80, Ecosurf SA-7 Ethoxylated alcohol, and linear alkylbenzene sulfonate. In some variations, the hydrocarbon removal composition includes Tween 80, Ecosurf SA-7 Ethoxylated alcohol, and a branched alkylbenzene sulfonate. In some variations, the hydrocarbon removal composition includes Tween 80, Ecosurf SA-7 Ethoxylated alcohol, and a linear alkylbenzene sulfonate. In some variations, the hydrocarbon removal composition includes Tween 80, Ecosurf SA-7 Ethoxylated alcohol, and Calimulse PRS. In some variations, the hydrocarbon removal composition includes Tween 80, Ecosurf SA-7 Ethoxylated alcohol, and Calimulse PR. In some variations, the hydrocarbon removal composition includes Tween 80, Ecosurf SA-7 Ethoxylated alcohol, and Witconate P-1059.

In some variations, the hydrocarbon removal composition includes Tween 80, Ecosurf SA-9 ethoxylated alcohol, and sodium lauryl sulfate. In some variations, the hydrocarbon removal composition includes Tween 80, Ecosurf SA-9 ethoxylated alcohol, and sodium lauryl ether sulfates. In some variations, the hydrocarbon removal composition includes Tween 80, Ecosurf SA-9 ethoxylated alcohol, and sodium octyl sulfosuccinate. In some variations, the hydrocarbon removal composition includes Tween 80, Ecosurf SA-9 ethoxylated alcohol, and di sodium octyl sulfosuccinate. In some variations, the hydrocarbon removal composition includes Tween 80, Ecosurf SA-9 ethoxylated alcohol, and sodium oleyl ether carboxylates. In some variations, the hydrocarbon removal composition includes Tween 80, Ecosurf SA-9 ethoxylated alcohol, and alkyl sulfonate. In some variations, the hydrocarbon removal composition includes Tween 80, Ecosurf SA-9 ethoxylated alcohol, and linear alkylbenzene sulfonate. In some variations, the hydrocarbon removal composition includes Tween 80, Ecosurf SA-9 ethoxylated alcohol, and a branched alkylbenzene sulfonate. In some variations, the hydrocarbon removal composition includes Tween 80, Ecosurf SA-9 ethoxylated alcohol, and a linear alkylbenzene sulfonate. In some variations, the hydrocarbon removal composition includes Tween 80, Ecosurf SA-9 ethoxylated alcohol, and Calimulse PRS. In some variations, the hydrocarbon removal composition includes Tween 80, Ecosurf SA-9 ethoxylated alcohol, and Calimulse PR. In some variations, the hydrocarbon removal composition includes Tween 80, Ecosurf SA-9 ethoxylated alcohol, and Witconate P-1059.

In some variations, the hydrocarbon removal composition includes Tween 20, Dyno 607, and sodium lauryl sulfate. In some variations, the hydrocarbon removal composition includes Tween 20, Dyno 607, and sodium lauryl ether sulfates. In some variations, the hydrocarbon removal composition includes Tween 20, Dyno 607, and sodium octyl sulfosuccinate. In some variations, the hydrocarbon removal composition includes Tween 20, Dyno 607, and di sodium octyl sulfosuccinate. In some variations, the hydrocarbon removal composition includes Tween 20, Dyno 607, and sodium oleyl ether carboxylates. In some variations, the hydrocarbon removal composition includes Tween 20, Dyno 607, and alkyl sulfonate. In some variations, the hydrocarbon removal composition includes Tween 20, Dyno 607, and linear alkylbenzene sulfonate. In some variations, the hydrocarbon removal composition includes Tween 20, Dyno 607, and a branched alkylbenzene sulfonate. In some variations, the hydrocarbon removal composition includes Tween 20, Dyno 607, and a linear alkylbenzene sulfonate. In some variations, the hydrocarbon removal composition includes Tween 20, Dyno 607, and Calimulse PRS. In some variations, the hydrocarbon removal composition includes Tween 20, Dyno 607, and Calimulse PR. In some variations, the hydrocarbon removal composition includes Tween 20, Dyno 607, and Witconate P-1059. In some variations, the hydrocarbon removal composition includes Tween 20, Surfynol 420, and sodium lauryl sulfate. In some variations, the hydrocarbon removal composition includes Tween 20, Surfynol 420, and sodium lauryl ether sulfates. In some variations, the hydrocarbon removal composition includes Tween 20, Surfynol 420, and sodium octyl sulfosuccinate. In some variations, the hydrocarbon removal composition includes Tween 20, Surfynol 420, and di sodium octyl sulfosuccinate. In some variations, the hydrocarbon removal composition includes Tween 20, Surfynol 420, and sodium oleyl ether carboxylates. In some variations, the hydrocarbon removal composition includes Tween 20, Surfynol 420, and alkyl sulfonate. In some variations, the hydrocarbon removal composition includes Tween 20, Surfynol 420, and linear alkylbenzene sulfonate. In some variations, the hydrocarbon removal composition includes Tween 20, Surfynol 420, and a branched alkylbenzene sulfonate. In some variations, the hydrocarbon removal composition includes Tween 20, Surfynol 420, and a linear alkylbenzene sulfonate. In some variations, the hydrocarbon removal composition includes Tween 20, Surfynol 420, and Calimulse PRS. In some variations, the hydrocarbon removal composition includes Tween 20, Surfynol 420, and Calimulse PR. In some variations, the hydrocarbon removal composition includes Tween 20, Surfynol 420, and Witconate P-1059. In some variations, the hydrocarbon removal composition includes Tween 20, Surfynol 440, and sodium lauryl sulfate. In some variations, the hydrocarbon removal composition includes Tween 20, Surfynol 440, and sodium lauryl ether sulfates. In some variations, the hydrocarbon removal composition includes Tween 20, Surfynol 440, and sodium octyl sulfosuccinate. In some variations, the hydrocarbon removal composition includes Tween 20, Surfynol 440, and di sodium octyl sulfosuccinate. In some variations, the hydrocarbon removal composition includes Tween 20, Surfynol 440, and sodium oleyl ether carboxylates. In some variations, the hydrocarbon removal composition includes Tween 20, Surfynol 440, and alkyl sulfonate. In some variations, the hydrocarbon removal composition includes Tween 20, Surfynol 440, and linear alkylbenzene sulfonate. In some variations, the hydrocarbon removal composition includes Tween 20, Surfynol 440, and a branched alkylbenzene sulfonate. In some variations, the hydrocarbon removal composition includes Tween 20, Surfynol 440, and a linear alkylbenzene sulfonate. In some variations, the hydrocarbon removal composition includes Tween 20, Surfynol 440, and Calimulse PRS. In some variations, the hydrocarbon removal composition includes Tween 20, Surfynol 440, and Calimulse PR. In some variations, the hydrocarbon removal composition includes Tween 20, Surfynol 440, and Witconate P-1059. In some variations, the hydrocarbon removal composition includes Tween 20, Surfynol 465, and sodium lauryl sulfate. In some variations, the hydrocarbon removal composition includes Tween 20, Surfynol 465, and sodium lauryl ether sulfates. In some variations, the hydrocarbon removal composition includes Tween 20, Surfynol 465, and sodium octyl sulfosuccinate. In some variations, the hydrocarbon removal composition includes Tween 20, Surfynol 465, and di sodium octyl sulfosuccinate. In some variations, the hydrocarbon removal composition includes Tween 20, Surfynol 465, and sodium oleyl ether carboxylates. In some variations, the hydrocarbon removal composition includes Tween 20, Surfynol 465, and alkyl sulfonate. In some variations, the hydrocarbon removal composition includes Tween 20, Surfynol 465, and linear alkylbenzene sulfonate. In some variations, the hydrocarbon removal composition includes Tween 20, Surfynol 465, and a branched alkylbenzene sulfonate. In some variations, the hydrocarbon removal composition includes Tween 20, Surfynol 465, and a linear alkylbenzene sulfonate. In some variations, the hydrocarbon removal composition includes Tween 20, Surfynol 465, and Calimulse PRS. In some variations, the hydrocarbon removal composition includes Tween 20, Surfynol 465, and Calimulse PR. In some variations, the hydrocarbon removal composition includes Tween 20, Surfynol 465, and Witconate P-1059. In some variations, the hydrocarbon removal composition includes Tween 20, Surfynol 485, and sodium lauryl sulfate. In some variations, the hydrocarbon removal composition includes Tween 20, Surfynol 485, and sodium lauryl ether sulfates. In some variations, the hydrocarbon removal composition includes Tween 20, Surfynol 485, and sodium octyl sulfosuccinate. In some variations, the hydrocarbon removal composition includes Tween 20, Surfynol 485, and di sodium octyl sulfosuccinate. In some variations, the hydrocarbon removal composition includes Tween 20, Surfynol 485, and sodium oleyl ether carboxylates. In some variations, the hydrocarbon removal composition includes Tween 20, Surfynol 485, and alkyl sulfonate. In some variations, the hydrocarbon removal composition includes Tween 20, Surfynol 485, and linear alkylbenzene sulfonate. In some variations, the hydrocarbon removal composition includes Tween 20, Surfynol 485, and a branched alkylbenzene sulfonate. In some variations, the hydrocarbon removal composition includes Tween 20, Surfynol 485, and a linear alkylbenzene sulfonate. In some variations, the hydrocarbon removal composition includes Tween 20, Surfynol 485, and Calimulse PRS. In some variations, the hydrocarbon removal composition includes Tween 20, Surfynol 485, and Calimulse PR. In some variations, the hydrocarbon removal composition includes Tween 20, Surfynol 485, and Witconate P-1059. In some variations, the hydrocarbon removal composition includes Tween 20, Dyno 604, and sodium lauryl sulfate. In some variations, the hydrocarbon removal composition includes Tween 20, Dyno 604, and sodium lauryl ether sulfates. In some variations, the hydrocarbon removal composition includes Tween 20, Dyno 604, and sodium octyl sulfosuccinate. In some variations, the hydrocarbon removal composition includes Tween 20, Dyno 604, and di sodium octyl sulfosuccinate. In some variations, the hydrocarbon removal composition includes Tween 20, Dyno 604, and sodium oleyl ether carboxylates. In some variations, the hydrocarbon removal composition includes Tween 20, Dyno 604, and alkyl sulfonate. In some variations, the hydrocarbon removal composition includes Tween 20, Dyno 604, and linear alkylbenzene sulfonate. In some variations, the hydrocarbon removal composition includes Tween 20, Dyno 604, and a branched alkylbenzene sulfonate. In some variations, the hydrocarbon removal composition includes Tween 20, Dyno 604, and a linear alkylbenzene sulfonate. In some variations, the hydrocarbon removal composition includes Tween 20, Dyno 604, and Calimulse PRS. In some variations, the hydrocarbon removal composition includes Tween 20, Dyno 604, and Calimulse PR. In some variations, the hydrocarbon removal composition includes Tween 20, Dyno 604, and Witconate P-1059. In some variations, the hydrocarbon removal composition includes Tween 20, Tomadol 91-2.5, and sodium lauryl sulfate. In some variations, the hydrocarbon removal composition includes Tween 20, Tomadol 91-2.5, and sodium lauryl ether sulfates. In some variations, the hydrocarbon removal composition includes Tween 20, Tomadol 91-2.5, and sodium octyl sulfosuccinate. In some variations, the hydrocarbon removal composition includes Tween 20, Tomadol 91-2.5, and di sodium octyl sulfosuccinate. In some variations, the hydrocarbon removal composition includes Tween 20, Tomadol 91-2.5, and sodium oleyl ether carboxylates. In some variations, the hydrocarbon removal composition includes Tween 20, Tomadol 91-2.5, and alkyl sulfonate. In some variations, the hydrocarbon removal composition includes Tween 20, Tomadol 91-2.5, and linear alkylbenzene sulfonate. In some variations, the hydrocarbon removal composition includes Tween 20, Tomadol 91-2.5, and a branched alkylbenzene sulfonate. In some variations, the hydrocarbon removal composition includes Tween 20, Tomadol 91-2.5, and a linear alkylbenzene sulfonate. In some variations, the hydrocarbon removal composition includes Tween 20, Tomadol 91-2.5, and Calimulse PRS. In some variations, the hydrocarbon removal composition includes Tween 20, Tomadol 91-2.5, and Calimulse PR. In some variations, the hydrocarbon removal composition includes Tween 20, Tomadol 91-2.5, and Witconate P-1059. In some variations, the hydrocarbon removal composition includes Tween 20, Tomadol 91-6, and sodium lauryl sulfate. In some variations, the hydrocarbon removal composition includes Tween 20, Tomadol 91-6, and sodium lauryl ether sulfates. In some variations, the hydrocarbon removal composition includes Tween 20, Tomadol 91-6, and sodium octyl sulfosuccinate. In some variations, the hydrocarbon removal composition includes Tween 20, Tomadol 91-6, and di sodium octyl sulfosuccinate. In some variations, the hydrocarbon removal composition includes Tween 20, Tomadol 91-6, and sodium oleyl ether carboxylates. In some variations, the hydrocarbon removal composition includes Tween 20, Tomadol 91-6, and alkyl sulfonate. In some variations, the hydrocarbon removal composition includes Tween 20, Tomadol 91-6, and linear alkylbenzene sulfonate. In some variations, the hydrocarbon removal composition includes Tween 20, Tomadol 91-6, and a branched alkylbenzene sulfonate. In some variations, the hydrocarbon removal composition includes Tween 20, Tomadol 91-6, and a linear alkylbenzene sulfonate. In some variations, the hydrocarbon removal composition includes Tween 20, Tomadol 91-6, and Calimulse PRS. In some variations, the hydrocarbon removal composition includes Tween 20, Tomadol 91-6, and Calimulse PR. In some variations, the hydrocarbon removal composition includes Tween 20, Tomadol 91-6, and Witconate P-1059. In some variations, the hydrocarbon removal composition includes Tween 20, Tomadol 91-8, and sodium lauryl sulfate. In some variations, the hydrocarbon removal composition includes Tween 20, Tomadol 91-8, and sodium lauryl ether sulfates. In some variations, the hydrocarbon removal composition includes Tween 20, Tomadol 91-8, and sodium octyl sulfosuccinate. In some variations, the hydrocarbon removal composition includes Tween 20, Tomadol 91-8, and di sodium octyl sulfosuccinate. In some variations, the hydrocarbon removal composition includes Tween 20, Tomadol 91-8, and sodium oleyl ether carboxylates. In some variations, the hydrocarbon removal composition includes Tween 20, Tomadol 91-8, and alkyl sulfonate. In some variations, the hydrocarbon removal composition includes Tween 20, Tomadol 91-8, and linear alkylbenzene sulfonate. In some variations, the hydrocarbon removal composition includes Tween 20, Tomadol 91-8, and a branched alkylbenzene sulfonate. In some variations, the hydrocarbon removal composition includes Tween 20, Tomadol 91-8, and a linear alkylbenzene sulfonate. In some variations, the hydrocarbon removal composition includes Tween 20, Tomadol 91-8, and Calimulse PRS. In some variations, the hydrocarbon removal composition includes Tween 20, Tomadol 91-8, and Calimulse PR. In some variations, the hydrocarbon removal composition includes Tween 20, Tomadol 91-8, and Witconate P-1059. In some variations, the hydrocarbon removal composition includes Tween 20, Tomadol 1200, and sodium lauryl sulfate. In some variations, the hydrocarbon removal composition includes Tween 20, Tomadol 1200, and sodium lauryl ether sulfates. In some variations, the hydrocarbon removal composition includes Tween 20, Tomadol 1200, and sodium octyl sulfosuccinate. In some variations, the hydrocarbon removal composition includes Tween 20, Tomadol 1200, and di sodium octyl sulfosuccinate. In some variations, the hydrocarbon removal composition includes Tween 20, Tomadol 1200, and sodium oleyl ether carboxylates. In some variations, the hydrocarbon removal composition includes Tween 20, Tomadol 1200, and alkyl sulfonate. In some variations, the hydrocarbon removal composition includes Tween 20, Tomadol 1200, and linear alkylbenzene sulfonate. In some variations, the hydrocarbon removal composition includes Tween 20, Tomadol 1200, and a branched alkylbenzene sulfonate. In some variations, the hydrocarbon removal composition includes Tween 20, Tomadol 1200, and a linear alkylbenzene sulfonate. In some variations, the hydrocarbon removal composition includes Tween 20, Tomadol 1200, and Calimulse PRS. In some variations, the hydrocarbon removal composition includes Tween 20, Tomadol 1200, and Calimulse PR. In some variations, the hydrocarbon removal composition includes Tween 20, Tomadol 1200, and Witconate P-1059. In some variations, the hydrocarbon removal composition includes Tween 20, T Det A 267, and sodium lauryl sulfate. In some variations, the hydrocarbon removal composition includes Tween 20, T Det A 267, and sodium lauryl ether sulfates. In some variations, the hydrocarbon removal composition includes Tween 20, T Det A 267, and sodium octyl sulfosuccinate. In some variations, the hydrocarbon removal composition includes Tween 20, T Det A 267, and di sodium octyl sulfosuccinate. In some variations, the hydrocarbon removal composition includes Tween 20, T Det A 267, and sodium oleyl ether carboxylates. In some variations, the hydrocarbon removal composition includes Tween 20, T Det A 267, and alkyl sulfonate. In some variations, the hydrocarbon removal composition includes Tween 20, T Det A 267, and linear alkylbenzene sulfonate. In some variations, the hydrocarbon removal composition includes Tween 20, T Det A 267, and a branched alkylbenzene sulfonate. In some variations, the hydrocarbon removal composition includes Tween 20, T Det A 267, and a linear alkylbenzene sulfonate. In some variations, the hydrocarbon removal composition includes Tween 20, T Det A 267, and Calimulse PRS. In some variations, the hydrocarbon removal composition includes Tween 20, T Det A 267, and Calimulse PR. In some variations, the hydrocarbon removal composition includes Tween 20, T Det A 267, and Witconate P-1059. In some variations, the hydrocarbon removal composition includes Tween 20, Tomadol 1-3, and sodium lauryl sulfate. In some variations, the hydrocarbon removal composition includes Tween 20, Tomadol 1-3, and sodium lauryl ether sulfates. In some variations, the hydrocarbon removal composition includes Tween 20, Tomadol 1-3, and sodium octyl sulfosuccinate. In some variations, the hydrocarbon removal composition includes Tween 20, Tomadol 1-3, and di sodium octyl sulfosuccinate. In some variations, the hydrocarbon removal composition includes Tween 20, Tomadol 1-3, and sodium oleyl ether carboxylates. In some variations, the hydrocarbon removal composition includes Tween 20, Tomadol 1-3, and alkyl sulfonate. In some variations, the hydrocarbon removal composition includes Tween 20, Tomadol 1-3, and linear alkylbenzene sulfonate. In some variations, the hydrocarbon removal composition includes Tween 20, Tomadol 1-3, and a branched alkylbenzene sulfonate. In some variations, the hydrocarbon removal composition includes Tween 20, Tomadol 1-3, and a linear alkylbenzene sulfonate. In some variations, the hydrocarbon removal composition includes Tween 20, Tomadol 1-3, and Calimulse PRS. In some variations, the hydrocarbon removal composition includes Tween 20, Tomadol 1-3, and Calimulse PR. In some variations, the hydrocarbon removal composition includes Tween 20, Tomadol 1-3, and Witconate P-1059.

In some variations, the hydrocarbon removal composition includes sorbitan laurate, Dyno 607, and sodium lauryl sulfate. In some variations, the hydrocarbon removal composition includes sorbitan laurate, Dyno 607, and sodium lauryl ether sulfates. In some variations, the hydrocarbon removal composition includes sorbitan laurate, Dyno 607, and sodium octyl sulfosuccinate. In some variations, the hydrocarbon removal composition includes sorbitan laurate, Dyno 607, and di sodium octyl sulfosuccinate. In some variations, the hydrocarbon removal composition includes sorbitan laurate, Dyno 607, and sodium oleyl ether carboxylates. In some variations, the hydrocarbon removal composition includes sorbitan laurate, Dyno 607, and alkyl sulfonate. In some variations, the hydrocarbon removal composition includes sorbitan laurate, Dyno 607, and linear alkylbenzene sulfonate. In some variations, the hydrocarbon removal composition includes sorbitan laurate, Dyno 607, and a branched alkylbenzene sulfonate. In some variations, the hydrocarbon removal composition includes sorbitan laurate, Dyno 607, and a linear alkylbenzene sulfonate. In some variations, the hydrocarbon removal composition includes sorbitan laurate, Dyno 607, and Calimulse PRS. In some variations, the hydrocarbon removal composition includes sorbitan laurate, Dyno 607, and Calimulse PR. In some variations, the hydrocarbon removal composition includes sorbitan laurate, Dyno 607, and Witconate P-1059. In some variations, the hydrocarbon removal composition includes sorbitan laurate, Surfynol 420, and sodium lauryl sulfate. In some variations, the hydrocarbon removal composition includes sorbitan laurate, Surfynol 420, and sodium lauryl ether sulfates. In some variations, the hydrocarbon removal composition includes sorbitan laurate, Surfynol 420, and sodium octyl sulfosuccinate. In some variations, the hydrocarbon removal composition includes sorbitan laurate, Surfynol 420, and di sodium octyl sulfosuccinate. In some variations, the hydrocarbon removal composition includes sorbitan laurate, Surfynol 420, and sodium oleyl ether carboxylates. In some variations, the hydrocarbon removal composition includes sorbitan laurate, Surfynol 420, and alkyl sulfonate. In some variations, the hydrocarbon removal composition includes sorbitan laurate, Surfynol 420, and linear alkylbenzene sulfonate. In some variations, the hydrocarbon removal composition includes sorbitan laurate, Surfynol 420, and a branched alkylbenzene sulfonate. In some variations, the hydrocarbon removal composition includes sorbitan laurate, Surfynol 420, and a linear alkylbenzene sulfonate. In some variations, the hydrocarbon removal composition includes sorbitan laurate, Surfynol 420, and Calimulse PRS. In some variations, the hydrocarbon removal composition includes sorbitan laurate, Surfynol 420, and Calimulse PR. In some variations, the hydrocarbon removal composition includes sorbitan laurate, Surfynol 420, and Witconate P-1059. In some variations, the hydrocarbon removal composition includes sorbitan laurate, Surfynol 440, and sodium lauryl sulfate. In some variations, the hydrocarbon removal composition includes sorbitan laurate, Surfynol 440, and sodium lauryl ether sulfates. In some variations, the hydrocarbon removal composition includes sorbitan laurate, Surfynol 440, and sodium octyl sulfosuccinate. In some variations, the hydrocarbon removal composition includes sorbitan laurate, Surfynol 440, and di sodium octyl sulfosuccinate. In some variations, the hydrocarbon removal composition includes sorbitan laurate, Surfynol 440, and sodium oleyl ether carboxylates. In some variations, the hydrocarbon removal composition includes sorbitan laurate, Surfynol 440, and alkyl sulfonate. In some variations, the hydrocarbon removal composition includes sorbitan laurate, Surfynol 440, and linear alkylbenzene sulfonate. In some variations, the hydrocarbon removal composition includes sorbitan laurate, Surfynol 440, and a branched alkylbenzene sulfonate. In some variations, the hydrocarbon removal composition includes sorbitan laurate, Surfynol 440, and a linear alkylbenzene sulfonate. In some variations, the hydrocarbon removal composition includes sorbitan laurate, Surfynol 440, and Calimulse PRS. In some variations, the hydrocarbon removal composition includes sorbitan laurate, Surfynol 440, and Calimulse PR. In some variations, the hydrocarbon removal composition includes sorbitan laurate, Surfynol 440, and Witconate P-1059. In some variations, the hydrocarbon removal composition includes sorbitan laurate, Surfynol 465, and sodium lauryl sulfate. In some variations, the hydrocarbon removal composition includes sorbitan laurate, Surfynol 465, and sodium lauryl ether sulfates. In some variations, the hydrocarbon removal composition includes sorbitan laurate, Surfynol 465, and sodium octyl sulfosuccinate. In some variations, the hydrocarbon removal composition includes sorbitan laurate, Surfynol 465, and di sodium octyl sulfosuccinate. In some variations, the hydrocarbon removal composition includes sorbitan laurate, Surfynol 465, and sodium oleyl ether carboxylates. In some variations, the hydrocarbon removal composition includes sorbitan laurate, Surfynol 465, and alkyl sulfonate. In some variations, the hydrocarbon removal composition includes sorbitan laurate, Surfynol 465, and linear alkylbenzene sulfonate. In some variations, the hydrocarbon removal composition includes sorbitan laurate, Surfynol 465, and a branched alkylbenzene sulfonate. In some variations, the hydrocarbon removal composition includes sorbitan laurate, Surfynol 465, and a linear alkylbenzene sulfonate. In some variations, the hydrocarbon removal composition includes sorbitan laurate, Surfynol 465, and Calimulse PRS. In some variations, the hydrocarbon removal composition includes sorbitan laurate, Surfynol 465, and Calimulse PR. In some variations, the hydrocarbon removal composition includes sorbitan laurate, Surfynol 465, and Witconate P-1059. In some variations, the hydrocarbon removal composition includes sorbitan laurate, Surfynol 485, and sodium lauryl sulfate. In some variations, the hydrocarbon removal composition includes sorbitan laurate, Surfynol 485, and sodium lauryl ether sulfates. In some variations, the hydrocarbon removal composition includes sorbitan laurate, Surfynol 485, and sodium octyl sulfosuccinate. In some variations, the hydrocarbon removal composition includes sorbitan laurate, Surfynol 485, and di sodium octyl sulfosuccinate. In some variations, the hydrocarbon removal composition includes sorbitan laurate, Surfynol 485, and sodium oleyl ether carboxylates. In some variations, the hydrocarbon removal composition includes sorbitan laurate, Surfynol 485, and alkyl sulfonate. In some variations, the hydrocarbon removal composition includes sorbitan laurate, Surfynol 485, and linear alkylbenzene sulfonate. In some variations, the hydrocarbon removal composition includes sorbitan laurate, Surfynol 485, and a branched alkylbenzene sulfonate. In some variations, the hydrocarbon removal composition includes sorbitan laurate, Surfynol 485, and a linear alkylbenzene sulfonate. In some variations, the hydrocarbon removal composition includes sorbitan laurate, Surfynol 485, and Calimulse PRS. In some variations, the hydrocarbon removal composition includes sorbitan laurate, Surfynol 485, and Calimulse PR. In some variations, the hydrocarbon removal composition includes sorbitan laurate, Surfynol 485, and Witconate P-1059. In some variations, the hydrocarbon removal composition includes sorbitan laurate, Dyno 604, and sodium lauryl sulfate. In some variations, the hydrocarbon removal composition includes sorbitan laurate, Dyno 604, and sodium lauryl ether sulfates. In some variations, the hydrocarbon removal composition includes sorbitan laurate, Dyno 604, and sodium octyl sulfosuccinate. In some variations, the hydrocarbon removal composition includes sorbitan laurate, Dyno 604, and di sodium octyl sulfosuccinate. In some variations, the hydrocarbon removal composition includes sorbitan laurate, Dyno 604, and sodium oleyl ether carboxylates. In some variations, the hydrocarbon removal composition includes sorbitan laurate, Dyno 604, and alkyl sulfonate. In some variations, the hydrocarbon removal composition includes sorbitan laurate, Dyno 604, and linear alkylbenzene sulfonate. In some variations, the hydrocarbon removal composition includes sorbitan laurate, Dyno 604, and a branched alkylbenzene sulfonate. In some variations, the hydrocarbon removal composition includes sorbitan laurate, Dyno 604, and a linear alkylbenzene sulfonate. In some variations, the hydrocarbon removal composition includes sorbitan laurate, Dyno 604, and Calimulse PRS. In some variations, the hydrocarbon removal composition includes sorbitan laurate, Dyno 604, and Calimulse PR. In some variations, the hydrocarbon removal composition includes sorbitan laurate, Dyno 604, and Witconate P-1059. In some variations, the hydrocarbon removal composition includes sorbitan laurate, Tomadol 91-2.5, and sodium lauryl sulfate. In some variations, the hydrocarbon removal composition includes sorbitan laurate, Tomadol 91-2.5, and sodium lauryl ether sulfates. In some variations, the hydrocarbon removal composition includes sorbitan laurate, Tomadol 91-2.5, and sodium octyl sulfosuccinate. In some variations, the hydrocarbon removal composition includes sorbitan laurate, Tomadol 91-2.5, and di sodium octyl sulfosuccinate. In some variations, the hydrocarbon removal composition includes sorbitan laurate, Tomadol 91-2.5, and sodium oleyl ether carboxylates. In some variations, the hydrocarbon removal composition includes sorbitan laurate, Tomadol 91-2.5, and alkyl sulfonate. In some variations, the hydrocarbon removal composition includes sorbitan laurate, Tomadol 91-2.5, and linear alkylbenzene sulfonate. In some variations, the hydrocarbon removal composition includes sorbitan laurate, Tomadol 91-2.5, and a branched alkylbenzene sulfonate. In some variations, the hydrocarbon removal composition includes sorbitan laurate, Tomadol 91-2.5, and a linear alkylbenzene sulfonate. In some variations, the hydrocarbon removal composition includes sorbitan laurate, Tomadol 91-2.5, and Calimulse PRS. In some variations, the hydrocarbon removal composition includes sorbitan laurate, Tomadol 91-2.5, and Calimulse PR. In some variations, the hydrocarbon removal composition includes sorbitan laurate, Tomadol 91-2.5, and Witconate P-1059. In some variations, the hydrocarbon removal composition includes sorbitan laurate, Tomadol 91-6, and sodium lauryl sulfate. In some variations, the hydrocarbon removal composition includes sorbitan laurate, Tomadol 91-6, and sodium lauryl ether sulfates. In some variations, the hydrocarbon removal composition includes sorbitan laurate, Tomadol 91-6, and sodium octyl sulfosuccinate. In some variations, the hydrocarbon removal composition includes sorbitan laurate, Tomadol 91-6, and di sodium octyl sulfosuccinate. In some variations, the hydrocarbon removal composition includes sorbitan laurate, Tomadol 91-6, and sodium oleyl ether carboxylates. In some variations, the hydrocarbon removal composition includes sorbitan laurate, Tomadol 91-6, and alkyl sulfonate. In some variations, the hydrocarbon removal composition includes sorbitan laurate, Tomadol 91-6, and linear alkylbenzene sulfonate. In some variations, the hydrocarbon removal composition includes sorbitan laurate, Tomadol 91-6, and a branched alkylbenzene sulfonate. In some variations, the hydrocarbon removal composition includes sorbitan laurate, Tomadol 91-6, and a linear alkylbenzene sulfonate. In some variations, the hydrocarbon removal composition includes sorbitan laurate, Tomadol 91-6, and Calimulse PRS. In some variations, the hydrocarbon removal composition includes sorbitan laurate, Tomadol 91-6, and Calimulse PR. In some variations, the hydrocarbon removal composition includes sorbitan laurate, Tomadol 91-6, and Witconate P-1059. In some variations, the hydrocarbon removal composition includes sorbitan laurate, Tomadol 91-8, and sodium lauryl sulfate. In some variations, the hydrocarbon removal composition includes sorbitan laurate, Tomadol 91-8, and sodium lauryl ether sulfates. In some variations, the hydrocarbon removal composition includes sorbitan laurate, Tomadol 91-8, and sodium octyl sulfosuccinate. In some variations, the hydrocarbon removal composition includes sorbitan laurate, Tomadol 91-8, and di sodium octyl sulfosuccinate. In some variations, the hydrocarbon removal composition includes sorbitan laurate, Tomadol 91-8, and sodium oleyl ether carboxylates. In some variations, the hydrocarbon removal composition includes sorbitan laurate, Tomadol 91-8, and alkyl sulfonate. In some variations, the hydrocarbon removal composition includes sorbitan laurate, Tomadol 91-8, and linear alkylbenzene sulfonate. In some variations, the hydrocarbon removal composition includes sorbitan laurate, Tomadol 91-8, and a branched alkylbenzene sulfonate. In some variations, the hydrocarbon removal composition includes sorbitan laurate, Tomadol 91-8, and a linear alkylbenzene sulfonate. In some variations, the hydrocarbon removal composition includes sorbitan laurate, Tomadol 91-8, and Calimulse PRS. In some variations, the hydrocarbon removal composition includes sorbitan laurate, Tomadol 91-8, and Calimulse PR. In some variations, the hydrocarbon removal composition includes sorbitan laurate, Tomadol 91-8, and Witconate P-1059. In some variations, the hydrocarbon removal composition includes sorbitan laurate, Tomadol 1200, and sodium lauryl sulfate. In some variations, the hydrocarbon removal composition includes sorbitan laurate, Tomadol 1200, and sodium lauryl ether sulfates. In some variations, the hydrocarbon removal composition includes sorbitan laurate, Tomadol 1200, and sodium octyl sulfosuccinate. In some variations, the hydrocarbon removal composition includes sorbitan laurate, Tomadol 1200, and di sodium octyl sulfosuccinate. In some variations, the hydrocarbon removal composition includes sorbitan laurate, Tomadol 1200, and sodium oleyl ether carboxylates. In some variations, the hydrocarbon removal composition includes sorbitan laurate, Tomadol 1200, and alkyl sulfonate. In some variations, the hydrocarbon removal composition includes sorbitan laurate, Tomadol 1200, and linear alkylbenzene sulfonate. In some variations, the hydrocarbon removal composition includes sorbitan laurate, Tomadol 1200, and a branched alkylbenzene sulfonate. In some variations, the hydrocarbon removal composition includes sorbitan laurate, Tomadol 1200, and a linear alkylbenzene sulfonate. In some variations, the hydrocarbon removal composition includes sorbitan laurate, Tomadol 1200, and Calimulse PRS. In some variations, the hydrocarbon removal composition includes sorbitan laurate, Tomadol 1200, and Calimulse PR. In some variations, the hydrocarbon removal composition includes sorbitan laurate, Tomadol 1200, and Witconate P-1059. In some variations, the hydrocarbon removal composition includes sorbitan laurate, T Det A 267, and sodium lauryl sulfate. In some variations, the hydrocarbon removal composition includes sorbitan laurate, T Det A 267, and sodium lauryl ether sulfates. In some variations, the hydrocarbon removal composition includes sorbitan laurate, T Det A 267, and sodium octyl sulfosuccinate. In some variations, the hydrocarbon removal composition includes sorbitan laurate, T Det A 267, and di sodium octyl sulfosuccinate. In some variations, the hydrocarbon removal composition includes sorbitan laurate, T Det A 267, and sodium oleyl ether carboxylates. In some variations, the hydrocarbon removal composition includes sorbitan laurate, T Det A 267, and alkyl sulfonate. In some variations, the hydrocarbon removal composition includes sorbitan laurate, T Det A 267, and linear alkylbenzene sulfonate. In some variations, the hydrocarbon removal composition includes sorbitan laurate, T Det A 267, and a branched alkylbenzene sulfonate. In some variations, the hydrocarbon removal composition includes sorbitan laurate, T Det A 267, and a linear alkylbenzene sulfonate. In some variations, the hydrocarbon removal composition includes sorbitan laurate, T Det A 267, and Calimulse PRS. In some variations, the hydrocarbon removal composition includes sorbitan laurate, T Det A 267, and Calimulse PR. In some variations, the hydrocarbon removal composition includes sorbitan laurate, T Det A 267, and Witconate P-1059. In some variations, the hydrocarbon removal composition includes sorbitan laurate, Tomadol 1-3, and sodium lauryl sulfate. In some variations, the hydrocarbon removal composition includes sorbitan laurate, Tomadol 1-3, and sodium lauryl ether sulfates. In some variations, the hydrocarbon removal composition includes sorbitan laurate, Tomadol 1-3, and sodium octyl sulfosuccinate. In some variations, the hydrocarbon removal composition includes sorbitan laurate, Tomadol 1-3, and di sodium octyl sulfosuccinate. In some variations, the hydrocarbon removal composition includes sorbitan laurate, Tomadol 1-3, and sodium oleyl ether carboxylates. In some variations, the hydrocarbon removal composition includes sorbitan laurate, Tomadol 1-3, and alkyl sulfonate. In some variations, the hydrocarbon removal composition includes sorbitan laurate, Tomadol 1-3, and linear alkylbenzene sulfonate. In some variations, the hydrocarbon removal composition includes sorbitan laurate, Tomadol 1-3, and a branched alkylbenzene sulfonate. In some variations, the hydrocarbon removal composition includes sorbitan laurate, Tomadol 1-3, and a linear alkylbenzene sulfonate. In some variations, the hydrocarbon removal composition includes sorbitan laurate, Tomadol 1-3, and Calimulse PRS. In some variations, the hydrocarbon removal composition includes sorbitan laurate, Tomadol 1-3, and Calimulse PR. In some variations, the hydrocarbon removal composition includes sorbitan laurate, Tomadol 1-3, and Witconate P-1059.

In some variations, the hydrocarbon removal composition includes Avapol 80, Dyno 607, and sodium lauryl sulfate. In some variations, the hydrocarbon removal composition includes Avapol 80, Dyno 607, and sodium lauryl ether sulfates. In some variations, the hydrocarbon removal composition includes Avapol 80, Dyno 607, and sodium octyl sulfosuccinate. In some variations, the hydrocarbon removal composition includes Avapol 80, Dyno 607, and di sodium octyl sulfosuccinate. In some variations, the hydrocarbon removal composition includes Avapol 80, Dyno 607, and sodium oleyl ether carboxylates. In some variations, the hydrocarbon removal composition includes Avapol 80, Dyno 607, and alkyl sulfonate. In some variations, the hydrocarbon removal composition includes Avapol 80, Dyno 607, and linear alkylbenzene sulfonate. In some variations, the hydrocarbon removal composition includes Avapol 80, Dyno 607, and a branched alkylbenzene sulfonate. In some variations, the hydrocarbon removal composition includes Avapol 80, Dyno 607, and a linear alkylbenzene sulfonate. In some variations, the hydrocarbon removal composition includes Avapol 80, Dyno 607, and Calimulse PRS. In some variations, the hydrocarbon removal composition includes Avapol 80, Dyno 607, and Calimulse PR. In some variations, the hydrocarbon removal composition includes Avapol 80, Dyno 607, and Witconate P-1059. In some variations, the hydrocarbon removal composition includes Avapol 80, Surfynol 420, and sodium lauryl sulfate. In some variations, the hydrocarbon removal composition includes Avapol 80, Surfynol 420, and sodium lauryl ether sulfates. In some variations, the hydrocarbon removal composition includes Avapol 80, Surfynol 420, and sodium octyl sulfosuccinate. In some variations, the hydrocarbon removal composition includes Avapol 80, Surfynol 420, and di sodium octyl sulfosuccinate. In some variations, the hydrocarbon removal composition includes Avapol 80, Surfynol 420, and sodium oleyl ether carboxylates. In some variations, the hydrocarbon removal composition includes Avapol 80, Surfynol 420, and alkyl sulfonate. In some variations, the hydrocarbon removal composition includes Avapol 80, Surfynol 420, and linear alkylbenzene sulfonate. In some variations, the hydrocarbon removal composition includes Avapol 80, Surfynol 420, and a branched alkylbenzene sulfonate. In some variations, the hydrocarbon removal composition includes Avapol 80, Surfynol 420, and a linear alkylbenzene sulfonate. In some variations, the hydrocarbon removal composition includes Avapol 80, Surfynol 420, and Calimulse PRS. In some variations, the hydrocarbon removal composition includes Avapol 80, Surfynol 420, and Calimulse PR. In some variations, the hydrocarbon removal composition includes Avapol 80, Surfynol 420, and Witconate P-1059. In some variations, the hydrocarbon removal composition includes Avapol 80, Surfynol 440, and sodium lauryl sulfate. In some variations, the hydrocarbon removal composition includes Avapol 80, Surfynol 440, and sodium lauryl ether sulfates. In some variations, the hydrocarbon removal composition includes Avapol 80, Surfynol 440, and sodium octyl sulfosuccinate. In some variations, the hydrocarbon removal composition includes Avapol 80, Surfynol 440, and di sodium octyl sulfosuccinate. In some variations, the hydrocarbon removal composition includes Avapol 80, Surfynol 440, and sodium oleyl ether carboxylates. In some variations, the hydrocarbon removal composition includes Avapol 80, Surfynol 440, and alkyl sulfonate. In some variations, the hydrocarbon removal composition includes Avapol 80, Surfynol 440, and linear alkylbenzene sulfonate. In some variations, the hydrocarbon removal composition includes Avapol 80, Surfynol 440, and a branched alkylbenzene sulfonate. In some variations, the hydrocarbon removal composition includes Avapol 80, Surfynol 440, and a linear alkylbenzene sulfonate. In some variations, the hydrocarbon removal composition includes Avapol 80, Surfynol 440, and Calimulse PRS. In some variations, the hydrocarbon removal composition includes Avapol 80, Surfynol 440, and Calimulse PR. In some variations, the hydrocarbon removal composition includes Avapol 80, Surfynol 440, and Witconate P-1059. In some variations, the hydrocarbon removal composition includes Avapol 80, Surfynol 465, and sodium lauryl sulfate. In some variations, the hydrocarbon removal composition includes Avapol 80, Surfynol 465, and sodium lauryl ether sulfates. In some variations, the hydrocarbon removal composition includes Avapol 80, Surfynol 465, and sodium octyl sulfosuccinate. In some variations, the hydrocarbon removal composition includes Avapol 80, Surfynol 465, and di sodium octyl sulfosuccinate. In some variations, the hydrocarbon removal composition includes Avapol 80, Surfynol 465, and sodium oleyl ether carboxylates. In some variations, the hydrocarbon removal composition includes Avapol 80, Surfynol 465, and alkyl sulfonate. In some variations, the hydrocarbon removal composition includes Avapol 80, Surfynol 465, and linear alkylbenzene sulfonate. In some variations, the hydrocarbon removal composition includes Avapol 80, Surfynol 465, and a branched alkylbenzene sulfonate. In some variations, the hydrocarbon removal composition includes Avapol 80, Surfynol 465, and a linear alkylbenzene sulfonate. In some variations, the hydrocarbon removal composition includes Avapol 80, Surfynol 465, and Calimulse PRS. In some variations, the hydrocarbon removal composition includes Avapol 80, Surfynol 465, and Calimulse PR. In some variations, the hydrocarbon removal composition includes Avapol 80, Surfynol 465, and Witconate P-1059. In some variations, the hydrocarbon removal composition includes Avapol 80, Surfynol 485, and sodium lauryl sulfate. In some variations, the hydrocarbon removal composition includes Avapol 80, Surfynol 485, and sodium lauryl ether sulfates. In some variations, the hydrocarbon removal composition includes Avapol 80, Surfynol 485, and sodium octyl sulfosuccinate. In some variations, the hydrocarbon removal composition includes Avapol 80, Surfynol 485, and di sodium octyl sulfosuccinate. In some variations, the hydrocarbon removal composition includes Avapol 80, Surfynol 485, and sodium oleyl ether carboxylates. In some variations, the hydrocarbon removal composition includes Avapol 80, Surfynol 485, and alkyl sulfonate. In some variations, the hydrocarbon removal composition includes Avapol 80, Surfynol 485, and linear alkylbenzene sulfonate. In some variations, the hydrocarbon removal composition includes Avapol 80, Surfynol 485, and a branched alkylbenzene sulfonate. In some variations, the hydrocarbon removal composition includes Avapol 80, Surfynol 485, and a linear alkylbenzene sulfonate. In some variations, the hydrocarbon removal composition includes Avapol 80, Surfynol 485, and Calimulse PRS. In some variations, the hydrocarbon removal composition includes Avapol 80, Surfynol 485, and Calimulse PR. In some variations, the hydrocarbon removal composition includes Avapol 80, Surfynol 485, and Witconate P-1059. In some variations, the hydrocarbon removal composition includes Avapol 80, Dyno 604, and sodium lauryl sulfate. In some variations, the hydrocarbon removal composition includes Avapol 80, Dyno 604, and sodium lauryl ether sulfates. In some variations, the hydrocarbon removal composition includes Avapol 80, Dyno 604, and sodium octyl sulfosuccinate. In some variations, the hydrocarbon removal composition includes Avapol 80, Dyno 604, and di sodium octyl sulfosuccinate. In some variations, the hydrocarbon removal composition includes Avapol 80, Dyno 604, and sodium oleyl ether carboxylates. In some variations, the hydrocarbon removal composition includes Avapol 80, Dyno 604, and alkyl sulfonate. In some variations, the hydrocarbon removal composition includes Avapol 80, Dyno 604, and linear alkylbenzene sulfonate. In some variations, the hydrocarbon removal composition includes Avapol 80, Dyno 604, and a branched alkylbenzene sulfonate. In some variations, the hydrocarbon removal composition includes Avapol 80, Dyno 604, and a linear alkylbenzene sulfonate. In some variations, the hydrocarbon removal composition includes Avapol 80, Dyno 604, and Calimulse PRS. In some variations, the hydrocarbon removal composition includes Avapol 80, Dyno 604, and Calimulse PR. In some variations, the hydrocarbon removal composition includes Avapol 80, Dyno 604, and Witconate P-1059. In some variations, the hydrocarbon removal composition includes Avapol 80, Tomadol 91-2.5, and sodium lauryl sulfate. In some variations, the hydrocarbon removal composition includes Avapol 80, Tomadol 91-2.5, and sodium lauryl ether sulfates. In some variations, the hydrocarbon removal composition includes Avapol 80, Tomadol 91-2.5, and sodium octyl sulfosuccinate. In some variations, the hydrocarbon removal composition includes Avapol 80, Tomadol 91-2.5, and di sodium octyl sulfosuccinate. In some variations, the hydrocarbon removal composition includes Avapol 80, Tomadol 91-2.5, and sodium oleyl ether carboxylates. In some variations, the hydrocarbon removal composition includes Avapol 80, Tomadol 91-2.5, and alkyl sulfonate. In some variations, the hydrocarbon removal composition includes Avapol 80, Tomadol 91-2.5, and linear alkylbenzene sulfonate. In some variations, the hydrocarbon removal composition includes Avapol 80, Tomadol 91-2.5, and a branched alkylbenzene sulfonate. In some variations, the hydrocarbon removal composition includes Avapol 80, Tomadol 91-2.5, and a linear alkylbenzene sulfonate. In some variations, the hydrocarbon removal composition includes Avapol 80, Tomadol 91-2.5, and Calimulse PRS. In some variations, the hydrocarbon removal composition includes Avapol 80, Tomadol 91-2.5, and Calimulse PR. In some variations, the hydrocarbon removal composition includes Avapol 80, Tomadol 91-2.5, and Witconate P-1059. In some variations, the hydrocarbon removal composition includes Avapol 80, Tomadol 91-6, and sodium lauryl sulfate. In some variations, the hydrocarbon removal composition includes Avapol 80, Tomadol 91-6, and sodium lauryl ether sulfates. In some variations, the hydrocarbon removal composition includes Avapol 80, Tomadol 91-6, and sodium octyl sulfosuccinate. In some variations, the hydrocarbon removal composition includes Avapol 80, Tomadol 91-6, and di sodium octyl sulfosuccinate. In some variations, the hydrocarbon removal composition includes Avapol 80, Tomadol 91-6, and sodium oleyl ether carboxylates. In some variations, the hydrocarbon removal composition includes Avapol 80, Tomadol 91-6, and alkyl sulfonate. In some variations, the hydrocarbon removal composition includes Avapol 80, Tomadol 91-6, and linear alkylbenzene sulfonate. In some variations, the hydrocarbon removal composition includes Avapol 80, Tomadol 91-6, and a branched alkylbenzene sulfonate. In some variations, the hydrocarbon removal composition includes Avapol 80, Tomadol 91-6, and a linear alkylbenzene sulfonate. In some variations, the hydrocarbon removal composition includes Avapol 80, Tomadol 91-6, and Calimulse PRS. In some variations, the hydrocarbon removal composition includes Avapol 80, Tomadol 91-6, and Calimulse PR. In some variations, the hydrocarbon removal composition includes Avapol 80, Tomadol 91-6, and Witconate P-1059. In some variations, the hydrocarbon removal composition includes Avapol 80, Tomadol 91-8, and sodium lauryl sulfate. In some variations, the hydrocarbon removal composition includes Avapol 80, Tomadol 91-8, and sodium lauryl ether sulfates. In some variations, the hydrocarbon removal composition includes Avapol 80, Tomadol 91-8, and sodium octyl sulfosuccinate. In some variations, the hydrocarbon removal composition includes Avapol 80, Tomadol 91-8, and di sodium octyl sulfosuccinate. In some variations, the hydrocarbon removal composition includes Avapol 80, Tomadol 91-8, and sodium oleyl ether carboxylates. In some variations, the hydrocarbon removal composition includes Avapol 80, Tomadol 91-8, and alkyl sulfonate. In some variations, the hydrocarbon removal composition includes Avapol 80, Tomadol 91-8, and linear alkylbenzene sulfonate. In some variations, the hydrocarbon removal composition includes Avapol 80, Tomadol 91-8, and a branched alkylbenzene sulfonate. In some variations, the hydrocarbon removal composition includes Avapol 80, Tomadol 91-8, and a linear alkylbenzene sulfonate. In some variations, the hydrocarbon removal composition includes Avapol 80, Tomadol 91-8, and Calimulse PRS. In some variations, the hydrocarbon removal composition includes Avapol 80, Tomadol 91-8, and Calimulse PR. In some variations, the hydrocarbon removal composition includes Avapol 80, Tomadol 91-8, and Witconate P-1059. In some variations, the hydrocarbon removal composition includes Avapol 80, Tomadol 1200, and sodium lauryl sulfate. In some variations, the hydrocarbon removal composition includes Avapol 80, Tomadol 1200, and sodium lauryl ether sulfates. In some variations, the hydrocarbon removal composition includes Avapol 80, Tomadol 1200, and sodium octyl sulfosuccinate. In some variations, the hydrocarbon removal composition includes Avapol 80, Tomadol 1200, and di sodium octyl sulfosuccinate. In some variations, the hydrocarbon removal composition includes Avapol 80, Tomadol 1200, and sodium oleyl ether carboxylates. In some variations, the hydrocarbon removal composition includes Avapol 80, Tomadol 1200, and alkyl sulfonate. In some variations, the hydrocarbon removal composition includes Avapol 80, Tomadol 1200, and linear alkylbenzene sulfonate. In some variations, the hydrocarbon removal composition includes Avapol 80, Tomadol 1200, and a branched alkylbenzene sulfonate. In some variations, the hydrocarbon removal composition includes Avapol 80, Tomadol 1200, and a linear alkylbenzene sulfonate. In some variations, the hydrocarbon removal composition includes Avapol 80, Tomadol 1200, and Calimulse PRS. In some variations, the hydrocarbon removal composition includes Avapol 80, Tomadol 1200, and Calimulse PR. In some variations, the hydrocarbon removal composition includes Avapol 80, Tomadol 1200, and Witconate P-1059. In some variations, the hydrocarbon removal composition includes Avapol 80, T Det A 267, and sodium lauryl sulfate. In some variations, the hydrocarbon removal composition includes Avapol 80, T Det A 267, and sodium lauryl ether sulfates. In some variations, the hydrocarbon removal composition includes Avapol 80, T Det A 267, and sodium octyl sulfosuccinate. In some variations, the hydrocarbon removal composition includes Avapol 80, T Det A 267, and di sodium octyl sulfosuccinate. In some variations, the hydrocarbon removal composition includes Avapol 80, T Det A 267, and sodium oleyl ether carboxylates. In some variations, the hydrocarbon removal composition includes Avapol 80, T Det A 267, and alkyl sulfonate. In some variations, the hydrocarbon removal composition includes Avapol 80, T Det A 267, and linear alkylbenzene sulfonate. In some variations, the hydrocarbon removal composition includes Avapol 80, T Det A 267, and a branched alkylbenzene sulfonate. In some variations, the hydrocarbon removal composition includes Avapol 80, T Det A 267, and a linear alkylbenzene sulfonate. In some variations, the hydrocarbon removal composition includes Avapol 80, T Det A 267, and Calimulse PRS. In some variations, the hydrocarbon removal composition includes Avapol 80, T Det A 267, and Calimulse PR. In some variations, the hydrocarbon removal composition includes Avapol 80, T Det A 267, and Witconate P-1059. In some variations, the hydrocarbon removal composition includes Avapol 80, Tomadol 1-3, and sodium lauryl sulfate. In some variations, the hydrocarbon removal composition includes Avapol 80, Tomadol 1-3, and sodium lauryl ether sulfates. In some variations, the hydrocarbon removal composition includes Avapol 80, Tomadol 1-3, and sodium octyl sulfosuccinate. In some variations, the hydrocarbon removal composition includes Avapol 80, Tomadol 1-3, and di sodium octyl sulfosuccinate. In some variations, the hydrocarbon removal composition includes Avapol 80, Tomadol 1-3, and sodium oleyl ether carboxylates. In some variations, the hydrocarbon removal composition includes Avapol 80, Tomadol 1-3, and alkyl sulfonate. In some variations, the hydrocarbon removal composition includes Avapol 80, Tomadol 1-3, and linear alkylbenzene sulfonate. In some variations, the hydrocarbon removal composition includes Avapol 80, Tomadol 1-3, and a branched alkylbenzene sulfonate. In some variations, the hydrocarbon removal composition includes Avapol 80, Tomadol 1-3, and a linear alkylbenzene sulfonate. In some variations, the hydrocarbon removal composition includes Avapol 80, Tomadol 1-3, and Calimulse PRS. In some variations, the hydrocarbon removal composition includes Avapol 80, Tomadol 1-3, and Calimulse PR. In some variations, the hydrocarbon removal composition includes Avapol 80, Tomadol 1-3, and Witconate P-1059.

In various embodiments, detergent is in a ratio of 30-50% w/w. In various embodiments, the detergent is in a ratio from 40-50% w/w. In various embodiments, the detergent is selected from any detergent described herein. In various embodiments, the C₉₋₁₁, C₁₀₋₁₆ ethoxylated wetting agent is provided in a ratio of 20-40% w/w. In various embodiments, the ethoxylated wetting agent is in a ratio of 27% to 35%. In various embodiments, the sorbitan ethoxylate is provided in a ratio of 10-30% w/w. In various embodiments, the sorbitan ethoxylate is provided in a ratio of 16-25% w/w. It will be recognized that any combination of detergent, ethoxylated wetting agent, and sorbitan emulsifier can be in any of the combinations recited herein. In various embodiments, the hydrocarbon removal composition can include a variety of additives. In some embodiments, the hydrocarbon removal composition includes methyl ester solvents, such as those derived from plants. Such solvents include methyl palmitate stearate. Alternative solvents include methyl esters from such sources as rapeseed, sunflower, soy, canola, corn, linseed or olives. Additives include metal chelators and/or product acidifiers such as citric acid, malic acid, ascorbic acid, boric acid, nitric acid, phytochelatin, EDTA, malate, and glutamic acid. Additional additives include pH buffer, scale remover and/or a viscosifier compounds, such sodium hydroxide, potassium hydroxide, calcium hydroxide, magnesium hydroxide, and vinegar. In various further embodiments, the hydrocarbon removal composition can include freeze point modulators such as propylene glycol or glycerine, in various dilutions. Further additives include nitrites such as sodium or potassium nitrite, sodium hexametaphosphate, tetrasodium pyrophosphate, sodium silicate and sodium hypochlorite used as a corrosion inhibitor and/or bacteriocide. Additional additives include nitrates such as fertilizer or substrate for bacterial growth.

In various embodiments, such as flowback applications described herein, the hydrocarbon removal composition is 10-30% w/w detergent, 30-50% ethoxylated wetting agent, and 10-30% w/w sorbitan emulsifier. The various hydrocarbon removal compositions described herein reduce water tension to below BRIJ 35 (35 dynes/cm). BRIJ 35 is a well-known wetting agent standard in the art. In various embodiments, the hydrocarbon removal composition is a combination of components described above or equal to and diluted in water. In various compositions, the hydrocarbon removal composition is diluted in a ratio of above or equal to 1/50. In various compositions, the hydrocarbon removal composition is diluted in a ratio of above or equal to 1/75. In various compositions, the hydrocarbon removal composition is diluted in a ratio of above or equal to 1/100. In various compositions, the hydrocarbon removal composition is diluted in a ratio of above or equal to 1/150. In various compositions, the hydrocarbon removal composition is diluted in a ratio of above or equal to 1/200. In various compositions, the hydrocarbon removal composition is diluted in a ratio of above 1/250. In various compositions, the hydrocarbon removal composition is diluted in a ratio of less than or equal to 1/300. In various compositions, the hydrocarbon removal composition is diluted in a ratio of less than or equal to 1/250. In various compositions, the hydrocarbon removal composition is diluted in a ratio of less than or equal to 1/200. In various compositions, the hydrocarbon removal composition is diluted in a ratio of less than or equal to 1/150. In various compositions, the hydrocarbon removal composition is diluted in a ratio of less than or equal to 1/100. The ratio of dilution can be based on a variety of factors, including the amount of water already present in an existing well.

In various embodiments, such as guar slurry applications described herein, the hydrocarbon removal composition includes isopropylamine linear alkylbenzene sulfonate provided in a ratio of 10-30% w/w. In various embodiments, the C₁₋₁₁, C₁₀₋₁₆ ethoxylated alcohol is provided in a ratio of 30-50% w/w. In various embodiments, the polyoxyethylene (20) sorbitan monooleateis provided in a ratio of 30-50% w/w.

In various embodiments, such as guar slurry embodiments, the hydrocarbon removal composition includes detergent, ethoxylated wetting agent, and sorbitan emulsifier. In various embodiments, the detergent is a ratio of 20-35% w/w. In various embodiments, the detergent is in a ratio from 25-30% w/w. In various embodiments, the detergent is selected from any detergent described herein. In various embodiments, the C₉₋₁₁, C₁₀₋₁₆ ethoxylated wetting agent is provided in a ratio of 25-50% w/w. In various embodiments, the ethoxylated wetting agent is in a ratio of 30-40% w/w. In various embodiments, the sorbitan ethoxylate is provided in a ratio of 25-50% w/w. In various embodiments, the sorbitan ethoxylate agent is in a ratio of 30-40% w/w. The above components of the hydrocarbon removal composition can be any component described herein, in any ratio described above, in any combination. In such embodiments, the additive is removed in half the time, and recovers substantially more hydrocarbon.

In various additional embodiments, such as oil field applications, components are included in the hydrocarbon removal composition that enhance nitrate-producing bacteria, which out-compete sulfate-reducing bacteria. The components can be nitrate and/or nitrites. Such components can change an oil field from sour to sweet. Alternatively, such compositions can be used to control corrosion. A nitrate can be included in a diluted base composition comprising detergent, ethoxylated wetting agent, and sorbitan emulsifier. In various embodiments, 5% or less of a nitrate is added to a diluted base composition. In various embodiments, 3% or less of a nitrate is added to a diluted base composition. In various embodiments, 1% or less of a nitrate is added to a diluted base composition. In various embodiments, 0.5% or less of a nitrate is added to a diluted base composition. In various embodiments, 0.1% or less of a nitrate is added to a diluted base composition. In various embodiments, 0.1% or greater of a nitrate is added to diluted base composition. In various embodiments, 0.5% or greater of a nitrate is added to diluted base composition. In various embodiments, 1% or greater of a nitrate is added to diluted base composition. In various embodiments, 3% or greater of a nitrate is added to diluted base composition. In various embodiments, 5% or less of a nitrate is added to a diluted base composition. Likewise, a nitrite can be included in a diluted base composition comprising detergent, ethoxylated wetting agent, and sorbitan emulsifier. In various embodiments, 0.5% or less of a nitrate is added to a diluted base composition. In various embodiments, 0.3% or less of a nitrite is added to a diluted base composition. In various embodiments, 0.1% or less of a nitrite is added to a diluted base composition. In various embodiments, 0.05% or less of a nitrite is added to a diluted base composition. In various embodiments, 0.01% or less of a nitrite is added to a diluted base composition. In various embodiments, 0.01% or greater of a nitrite is added to diluted base composition. In various embodiments, 0.05% or greater of a nitrite is added to diluted base composition. In various embodiments, 0.1% or greater of a nitrite is added to diluted base composition. In various embodiments, 0.3% or greater of a nitrite is added to diluted base composition. In various embodiments, 0.5% or less of a nitrite is added to a diluted base composition.

In various embodiments, such as cleaning or pipeline cleaning applications, the hydrocarbon removal composition includes a detergent, ethoxylated wetting agent, sorbitan emulsifier, and a solvent. In certain embodiments, the detergent is in a ratio of 10-30% w/w. In various embodiments, the detergent is in a ratio from 20-25% w/w. In various embodiments, the detergent is selected from any detergent described herein. In various embodiments, the ethoxylated wetting agent is provided in a ratio of 10-30% w/w. In various embodiments, the ethoxylated wetting agent is in a ratio of 15-20%. In various embodiments, the sorbitan ethoxylated is provided in a ratio of 10-30% w/w. In various embodiments, the sorbitan ethoxylated is provided in a ratio of 16-25% w/w. In various embodiments, the solvent is in a ratio of 40-60% w/w. In various further embodiments, the solvent is in a ratio of 45-50% w/w. Solvents can include, e.g. methyl palmitate stearate. It will be recognized that any combination of detergent, ethoxylated wetting agent, sorbitan emulsifier, and solvent can be in any of the combinations recited herein. Such embodiments can be used for a variety of uses, including commercial household de-greasers. In various further embodiments, such hydrocarbon removal compositions can include metal chelators such as citric acid, and scale removers such as sodium hydroxide. The hydrocarbon removal compostions can also be used as a degreaser.

In various embodiments, the hydrocarbon removal composition includes a detergent, ethoxylated wetting agent, and a solvent, with no sorbitan emulsifier. Uses for such compostions include soil cleaning applications. In various embodiments, detergent is in a ratio of 25-50% w/w. In various embodiments, the detergent is in a ratio from 30-40% w/w. In various embodiments, the detergent is selected from any detergent described herein. In various embodiments, the ethoxylated wetting agent is provided in a ratio of 20-40% w/w. In various embodiments, the ethoxylated wetting agent is in a ratio of 27% to 35%. In various embodiments, the solvent is provided in a ratio of 25-50% w/w. In various embodiments, the sorbitan ethoxylated is provided in a ratio of 30-40% w/w. It will be recognized that any combination of detergent, ethoxylated wetting agent, and solvent can be in any of the combinations recited herein. Such compositions are often diluted to very high dilution levels of between 1/500 and 1/1500.

In various embodiments, the hydrocarbon removal composition includes a detergent, ethoxylated wetting agent, a sorbitan emulsifier, and a solvent. In various embodiments, detergent is in a ratio of 20-35% w/w. In various embodiments, the detergent is in a ratio from 25-30% w/w. In various embodiments, the detergent is selected from any detergent described herein. In various embodiments, the ethoxylated wetting agent is provided in a ratio of 20-35% w/w. In various embodiments, the ethoxylated wetting agent is in a ratio of 25-30%. In various embodiments, the sorbitan emulsifier is in a ratio of 10-30% w/w. In various embodiments, the sorbitan emulsifier is in a ratio of 15-25% w/w. In various embodiments, the methyl ester solvent is provided in a ratio of 20-30% w/w.

Use of Components in Extraction Methods

After primary and secondary hydrocarbon recovery, a substantial quantity of hydrocarbons remains in inaccessible locations. Hydrocarbons such as oil, natural gas, etc., may be obtained from a subterranean geologic formation, by drilling a well that penetrates the hydrocarbon-bearing formation laterally, allowing a flowpath for hydrocarbons to reach a wellbore (and ultimately to the surface). Extraction efficiency increases substantially if hydrocarbons are dissolved and provided with an unimpeded flow path to reach the wellbore. Extraction efficiency further increases if the hydrocarbons are dissolved sufficiently to enter an aqueous medium, but also contained in an unstable emulsion that dissolves the hydrocarbon but is not sufficient to form a permanent emulsion, thereby releasing the hydrocarbon from the aqueous medium.

The hydrocarbon removal compositions can be provided into the wellbore by any methods known in the art. In some embodiments, the hydrocarbon removal composition is added in combination with a guar slurry combined with a proppant. In other aspects, the hydrocarbon removal compositions can be combined with aqueous media, and placed down a wellbore as a flowback agent.

Employing the hydrocarbon removal compositions described herein improves penetration into the reservoir, allows better flow-back and drainage, improves load recovery, and reduces damage due to phase trapping, in addition to providing a safe, environmentally friendly alternative to existing flowback agents. Other applications of the formulation of the instantaneous invention include Enhanced Oil Recovery (EOR), wettability alteration, well cleanout, and work-over. In various embodiments, the hydrocarbon removal composition is added to a well to reduce water blockage when injected into a fractured reservoir.

In various embodiments, the hydrocarbon removal compositions described herein can be administered in any manner known in the art. In some instances, hydrocarbon removal compositions can be added at any time during secondary and tertiary hydrocarbon recovery. The hydrocarbon removal compositions can be combined with viscous slurry components, such as in guar slurry preparation, and added to a wellbore. The hydrocarbon removal compositions can be administered during recovery operations. Alternatively, recovery operations can be suspended, the hydrocarbon removal compositions added, and recovery continued. In various aspects, an additional flush can be applied to drive the hydrocarbon removal compositions deeper into a fractured formation.

Hydrocarbon Removal Composition Properties

The hydrophobic-lipophilic balance (HLB) of the hydrocarbon removal composition can be adjusted. In various embodiments, the ethoxylated wetting agent can be developed to have a viscosity suited to have a higher or lower viscosity at a specific temperature.

Without wishing to be limited to any theory or mode of action, in various embodiments a higher HLB can result in an increased ability of the hydrocarbon removal composition to emulsify and release heavy oils. A higher HLB can be used to emulsify and/or release more viscous contaminant (e.g. a higher viscosity oil). Conversely, a lower HLB can be used to emulsify and/or release a less viscous contaminant (e.g. a lower viscosity oil). The HLB of the hydrocarbon removal composition can be selected based on the HLB of the contaminant.

Table 1 depicts the HLB of a variety of contaminants. In various embodiments, the content of the hydrocarbon removal composition can be chosen to match the HLB of the contaminant. HLB can be achieved by selection of ethoxylated wetting agent, detergent, and/or sorbital wetting agent, and/or relative amount of each of the ethoxylated wetting agent, detergent, and/or sorbital wetting agent. Various values are known to those skilled in the art, and be adjusted.

TABLE 1
HLB for contaminant compounds

| Compound | HLB | Compound | HLB | Compound | HLB | Compound | HLB |
|---|---|---|---|---|---|---|---|
| Aceotpheone | 14 | Carbon | 16 | Isopropyl | 11-12 | N,N-diethyl-m- | 7-8 |
| | | Tetrachloride | | Myristate | | toluamide | |
| Dimer acid | 14 | Carnauba | 15 | Isopropyl | 14 | Nonyl Phenol | 14 |
| | | Wax | | Lanolate | | | |
| Isostearic acid | 15-16 | Castor Oil | 14 | Isopropyl | 11-12 | Otthodichlorobenzene | 13 |
| | | | | Palmitate | | | |
| Lauric Acid | 16 | Ceresine | 8 | Jojoba Oil | 6-7 | Palm Oil | 10 |
| | | Wax | | | | | |
| Linoleic Acid | 16 | Chlorinated | 12-14 | Kerosene | 12 | Paraffin wax | 10 |
| | | paraffin | | | | | |
| Oleic Acid | 17 | Chlorobenzene | 13 | Anhydrous | 9 | Petrolatum | 7-8 |
| | | | | lanolin | | | |
| Ricinoleic acid | 16 | Cocoa butter | 6 | Liquid lanolin | 9 | Petroleum naphtha | 14 |
| Cetyl Alcohol | 15-16 | Corn oil | 10 | Lard | 5 | Pine oil | 16 |
| Decyl alcohol | 15 | Cottonseed | 5-6 | Lauryl amine | 12 | Polyethylene wax | 15 |
| | | oil | | | | | |
| Hexadecyl | 11-12 | Cyclohexane | 15 | Menhaden oil | 12 | Polyxoypropylene 30 | 10-11 |
| alcohol | | | | | | cetyl ether | |
| Isodecyl | 14 | Decahydro | 15 | Methyl | 7 | Tetramer propene | 14 |
| alcohol | | naphthalene | | phenyl | | | |
| | | | | silicone | | | |
| Isohexadecyl | 11-12 | Decyl acetate | 11 | Methyl | 11 | Rapeseed oil | 6 |
| alcohol | | | | silicone | | | |
| Lauryl Sulfate | 14 | Diethyl aniline | 14 | Mineral oil | 11-12 | Silicone oil | 7-8 |
| | | | | (light) | | (volatile) | |
| | | | | napthenic | | | |
| Oleyl alcohol | 13-14 | Diisooctyl | 13 | Mineral oil, | 10 | Soybean oil | 6 |
| | | phthalate | | paraffinic | | | |
| Stearyl | 15-16 | Diisopropyl | 9 | Mineral oil | 10-11 | Styrene | 15 |
| alcohol | | adipate | | (light) | | | |
| | | | | paraffinic | | | |
| Tridecyl | 14 | Diisopropyl | 15 | Mineral oil | 9 | toluene | 15 |
| alcohol | | benzene | | (medium) | | | |
| | | | | paraffinic | | | |
| Arachidyl | 7 | Dimethyl | 9 | Mineral | 14 | trichlorotrifluoroethane | 14 |
| propionate | | silicone | | spirits | | | |
| Arlamol E | 7 | Ethyl aniline | 13 | Mink oil | 5 | Tricresyl phosphate | 14 |
| Beeswax | 9 | Ethyl | 13 | Nitrobenzene | 13 | xylene | 14 |
| benzoate | | | | | | | |
| Benzene | 15 | Fenchone | 12 | | | | |
| Bensonitrile | 14 | Glycerol | 13 | | | | |
| | | monostaearate | | | | | |
| Bromobenzene | 13 | Hydrogenated | 6-7 | | | | |
| | | peanut oil | | | | | |
| Butyl stearate | 11 | | | | | | |

In various instances, the HLB of the hydrocarbon removal composition is at least 5.5. In various instances, the HLB of the hydrocarbon removal composition is at least 6.0. In various instances, the HLB of the hydrocarbon removal composition is at least 6.5. In various instances, the HLB of the hydrocarbon removal composition is at least 7.0. In various instances, the HLB of the hydrocarbon removal composition is at least 7.5. In various instances, the HLB of the hydrocarbon removal composition is at least 8.0. In various instances, the HLB of the hydrocarbon removal composition is at least 8.5. In various instances, the HLB of the hydrocarbon removal composition is at least 9.0. In further instances, the HLB of the hydrocarbon removal composition is at least 9.5. In further instances, the HLB of the hydrocarbon removal composition is at least 10. In further instances, the HLB of the hydrocarbon removal composition is at least 10.5. In further instances, the HLB of the hydrocarbon removal composition is at least 11.0. In further instances, the HLB of the hydrocarbon removal composition is at least 11.5. In further instances, the HLB of the hydrocarbon removal composition is at least 12.5. In various instances, the HLB of the hydrocarbon removal composition is at least 13.0. In various instances, the HLB of the hydrocarbon removal composition is at least 13.5. In various instances, the HLB of the hydrocarbon removal composition is at least 14.0. In various instances, the HLB of the hydrocarbon removal composition is at least 14.5. In various instances, the HLB of the hydrocarbon removal composition is at least 15.0. In various instances, the HLB of the hydrocarbon removal composition is at least 15.5. In various instances, the HLB of the hydrocarbon removal composition is at least 16.0. In various instances, the HLB of the hydrocarbon removal composition is at least 16.5. In various instances, the HLB of the hydrocarbon removal composition is at least 17.0.

In further embodiments, the HLB of the hydrocarbon removal composition is less than 17.5. In further embodiments, the HLB of the hydrocarbon removal composition is less than 17.0. In further embodiments, the HLB of the hydrocarbon removal composition is less than 16.5. In further embodiments, the HLB of the hydrocarbon removal composition is less than 16.0. In further embodiments, the HLB of the hydrocarbon removal composition is less than 15.5. In further embodiments, the HLB of the hydrocarbon removal composition is less than 15.0. In further embodiments, the HLB of the hydrocarbon removal composition is less than 14.5. In further embodiments, the HLB of the hydrocarbon removal composition is less than 14.0. In further embodiments, the HLB of the hydrocarbon removal composition is less than 13.5. In further embodiments, the HLB of the hydrocarbon removal composition is less than 13.0. In further embodiments, the HLB of the hydrocarbon removal composition is less than 12.5. In further embodiments, the HLB of the hydrocarbon removal composition is less than 12.0. In further embodiments, the HLB of the hydrocarbon removal composition is less than 11.5. In further embodiments, the HLB of the hydrocarbon removal composition is less than 11.0. In further embodiments, the HLB of the hydrocarbon removal composition is less than 10.5. In further embodiments, the HLB of the hydrocarbon removal composition is less than 10.0. In further embodiments, the HLB of the hydrocarbon removal composition is less than 9.5. In further embodiments, the HLB of the hydrocarbon removal composition is less than 9.0. In further embodiments, the HLB of the hydrocarbon removal composition is less than 8.5. In further embodiments, the HLB of the hydrocarbon removal composition is less than 8.0. In further embodiments, the HLB of the hydrocarbon removal composition is less than 7.5. In further embodiments, the HLB of the hydrocarbon removal composition is less than 7.0. In further embodiments, the HLB of the hydrocarbon removal composition is less than 6.5. In further embodiments, the HLB of the hydrocarbon removal composition is less than 6.0.

In certain variations, the cloud point of the hydrocarbon removal compositions, or components thereof, can be adjusted. The cloud point refers to the lowest temperature of the solution before the components separate into phases and thus becoming cloudy. The cloud point can have an effect on the salinity in oil removal and recovery (“down hole”) applications because high salinity lowers the cloud point of components, including detergents such as nonionic surfactants. The higher the cloud point, the more stable the chemical will be in a high salt environment.

In various embodiments, certain components are salt containing/high brine/electrolyte components. Salts such as Mg and Ca in the hydrocarbon environment can displace the sodium, thereby salting out components of the hydrocarbon removal composition. Without relying on any theory or mechanism, the steric hindrance of such substitutions limit the ability of the hydrocarbon to emulsification of hydrocarbons and/or removal of hydrocarbons from emulsion. Likewise, detergents can fall out of solution at a low cloud point.

Accordingly, components of the composition can be selected to have a high cloud point, thereby reducing salting out of the solution. The composition component, and/or amount of composition component, can be selected by any method known in the art.

In various additional embodiments, the component can be selected to have a low pour point. In cold environments, a lower pour point can allow application of the liquid hydrocarbon removal compositions into a downhole area, or in a contaminated area. In various embodiments, lower pour points can be selected for each separate component. The hydrocarbon removal composition can thus be used.

Viscous Slurries

In various aspects, the compositions can be combined with viscous treatment fluids in viscous slurries used during fracturing.

As noted above, fracturing methods typically involved hydrocarbon extraction from horizontal formations. The fracturing fluid typically includes proppants, or particles, that are deposited in the fractures. The proppant limits or prevents the fractures from fully closing upon the release of hydraulic pressure, thereby forming channels that allow fluids to flow to the wellbore. The proppant transport ability of a base fluid depends on the type of viscosifying additives added to the water base. In various aspects, fracturing fluid may be “broken” (i.e., the viscosity of the fluid reduced), and the fracturing fluid can be recovered from the formation.

The present hydrocarbon removal compositions can be combined with any viscous fracturing compound. In conventional methods, a breaker is added to the slurry so that the viscous gel can be degraded and flowback, leaving the proppant to create a large flow area and a highly conductive pathway for hydrocarbons to flow into the wellbore. The ability of the hydrocarbon removal compounds to remove hydrocarbons from proppants allows the hydrocarbons unimpeded access to the well bore. By the addition of hydrocarbon removal compounds into the slurry, the increased guar hydration and flowback characteristics allow an operator to invest less time and manpower into this stage of the process.

Guar slurries are the predominant viscous compounds in the industry. The presently disclosed hydrocarbon removal compositions can be combined with the viscous fracturing compound. When added in combination with the presently disclosed compounds, the viscosity of the guar slurry increases substantially. The improved viscosity of the viscous slurries is described in various examples disclosed herein.

A variety of methods are used to create the viscous treatment fluids typically used in subterranean operation. Generally, a polysaccharide or synthetic polymer gelling agent is used to impart viscosity to the treatment fluid to, among other things, enhance proppant or gravel transport and reduce fluid loss from the treatment fluid into the formation. In various aspects, the presently disclosed hydrocarbon removal compositions do not require non-biodegradable crosslinking agents, such as metal ions with organic or inorganic counter-ions, organometallic, or organic compounds.

Guar is a naturally occurring galactomannan polymer. Guar forms a hydrocolloid that swells upon contact with water to provide viscosity and fluid loss control. The following table describes exemplary components and concentrations of used in guar slurry.

TABLE 2

| | |
|---|---|
| Galactomannans | 84-87% |
| Moisture | 8-10% |
| Protein | 3.5-4.5% |
| Fiber | 1.0-1.5% |
| Ash | 0.6-0.7% |

Guar has a molar mass of 220 kDalton, and it consists of mannose in the main chain and galactose in the side chain. Guar is widely used to viscosify fracturing fluids because of their desirable rheological properties, economics and ease of hydration. It has been shown that anionic galactomannans, which are derived from guar gum by partially esterifying hydroxyl groups with sulfonate groups that result from AMPS (2-acrylamido-2-methylpropyl sulfonic acid), are suitable thickeners.

Guar gum is typically prepared by mechanically and/or chemically treating guar beans to liberate the guar seed endosperm, or ‘guar splits,’ from the beans. Guar splits primarily comprise a polymannose backbone with galactose side chains and mannose, and contain a fair concentration of contaminates, such as cellulose, protein, and glycolipids. The guar splits are generally treated under high pressures and temperatures with chemicals, after which they are subjected to multiple washings to remove impurities and salts (which are byproducts of some of the treatments) from the splits. The treated and washed splits are then ground and dried to yield derivatized guars.

The guar powders can be dispersed into a water-based fluid, such as a 2% KCl solution, and allowed time to hydrate. This dispersion may be accomplished by adding the powdered guar directly to water, or by first creating a liquid slurry, or liquid gel concentrate (‘LGC’), of the powder in a non-hydrating solvent, such as diesel. After hydration, the guar slurry is significantly higher in viscosity, making it possible to transport high-density propping agents through pumping equipment and into a subterranean formation. As shown in the examples, addition of the hydrocarbon removal compositions increases the viscosity of guar slurries.

In guar slurry applications, the addition of the hydrocarbon removal composition to the guar slurry will consistently increase viscosity 3-4 cps over the traditional slurry formulation as demonstrated in the Examples. This provides substantial increase in flow rate and resulting hydrocarbon recovery. For example, an increase of viscosity from 0.777 cp to 1.05 cp represents up to a 33% decrease in flow rate at the same shear stress. The hydrocarbon removal compositions do not does not affect crosslink viscosity, which means there is no incompatibility with anionic slurry formulations.

In some aspects, the hydrocarbon removal composition is combined with a portion of the mineral oil and clay to form a concentrate. This can be stored for a long period of time without adding guar or remaining mineral oil. At the appropriate time, the remaining mineral oil and guar is added to the concentrate and used in the methods described herein.

Various proppants can be used in conjunction viscous slurries to incorporate the hydrocarbon removal compositions disclosed herein. The proppant type can be sand, intermediate strength ceramic proppants (available from Carbo Ceramics, Norton Proppants, etc.), sintered bauxites and other materials known to the industry. Any of these base proppants can further be coated with a resin (available from Santrol, a Division of Fairmount Industries, Borden Chemical, etc.) to potentially improve the clustering ability of the proppant. By selecting proppants having a contrast in one of such properties such as density, size and concentrations, different settling rates will be achieved.

Flowback Agent

The hydrocarbon removal composition disclosed herein can be used as a flowback agent.

When the proppant and viscous treatment fluids are in place, hydrocarbon containing fluids can be recovered into the wellbore. As such, in various embodiments the hydrocarbon removal compositions do not introduce contaminants such as acidized treatments, scale inhibitors, filter cake remover, non-biodegradable surfactants, and gas hydrate inhibitors.

The hydrocarbon removal composition can be introduced into a well by any one of methods. In a small well field, the hydrocarbon removal compositions can be direct injected into the wellbore or broadcast throughout the site via in-situ water flood mechanisms. Moreover, the hydrocarbon removal compositions can be diluted for specific site characteristics. For higher molecular weight hydrocarbons, such as bunker C oil, a higher concentration solution can be used. For example, a concentration above 0.4% or 0.5% of hydrocarbon removal composition in water can be used. For lower molecular weight hydrocarbons such as Texas sweet crude, a concentration of 0.1-0.2% of hydrocarbon removal composition can be used.

In various aspects, the hydrocarbon removal composition is diluted in water before addition to the wellbore. The concentration can depend on the reservoir conditions used. In one aspect, the hydrocarbon removal composition is added at a concentration of greater than 0.1% by total volume. In another aspect, the hydrocarbon removal composition is added at a concentration of greater than 0.2% by total volume. In another aspect, the hydrocarbon removal composition is added at a concentration of greater than 0.3% by total volume. In another aspect, the hydrocarbon removal composition is added at a concentration of greater than 0.4% by total volume. In another aspect, the hydrocarbon removal composition is added at a concentration of greater than 0.5% by total volume. In another aspect, the hydrocarbon removal composition is added at a concentration of greater than 0.6% by total volume.

In some aspects, the hydrocarbon removal composition is added to the well bore in a concentration of less than 2% by total volume. In another aspect, the hydrocarbon removal composition is added to the well bore in a concentration of less than 1.8% by total volume. In another aspect, the hydrocarbon removal composition is added to the well bore in a concentration of less than 1.6% by total volume. In another aspect, the hydrocarbon removal composition is added to the well bore in a concentration of less than 1.4% by total volume. In another aspect, the hydrocarbon removal composition is added to the well bore in a concentration of less than 1.2% by total volume. In another aspect, the hydrocarbon removal composition is added to the well bore in a concentration of less than 1.0% by total volume. In another aspect, the hydrocarbon removal composition is added to the well bore in a concentration of less than 0.8% by total volume. In another aspect, the hydrocarbon removal composition is added to the well bore in a concentration of less than 0.7% by total volume. In another aspect, the hydrocarbon removal composition is added to the well bore in a concentration of less than 0.6% by total volume. In another aspect, the hydrocarbon removal composition is added to the well bore in a concentration of less than 0.5% by total volume. In another aspect, the hydrocarbon removal composition is added to the well bore in a concentration of less than 0.4% by total volume. In another aspect, the hydrocarbon removal composition is added to the well bore in a concentration of less than 0.3% by total volume. It will be recognized that the upper and lower boundaries of concentration can be combined in any combination.

In another aspect, the hydrocarbon removal composition is added to a fracturing formulation at concentrations of 1 to 5 gallons per 1000 gallons of injection fluid depending on reservoir conditions to obtain the desired flowback performance.

The hydrocarbon removal compositions remove hydrocarbons from the formation and decrease the interfacial tension between the oil phase and the surrounding geologic formation. Because the hydrocarbon removal composition lowers the surface tension of the flowback fluid, it is possible to enter the pore space between soil particles and facilitate detachment of the hydrocarbon, allowing for greater recovery yields.

Moreover, removal through aqueous media can be achieved. Aqueous media can block hydrocarbons from reaching the wellbore. The hydrocarbon removal compositions provided herein allow hydrocarbons to be encompassed in an imperfect emulsion, conducted through the aqueous media, and release into the well for acquisition at the well surface.

The presently disclosed hydrocarbon removal compositions can be used as flowback agents to provide for improved solubility of the compositions.

Remediation

In various embodiments, the composition is a remediation composition. Remediation compositions can be used to remediate contaminated sites. The remediation formulation is non-toxic and biodegradable within 28 days. The enzymes reduce the need to add bacteria to a contamination site.

The compositions described herein include a detergent as disclosed herein, an ethoxylated wetting agent, one or more enzymes, and an alkylester. The detergent and ethyxolate wetting agent can be any compound disclosed herein.

In various embodiments, the enzyme can be selected from a number of possible enzymes. Non-limiting examples of enzymes include hydrocarbon degradation monooxygenase, epoxide hydrolase, OSE II, glutathione transferase, UDP glucuronosyltransferase, sulfotransferase, and dioxygenase. In various embodiments, enzymes can be introduced in commercial products that contain enzymes. Examples of such products include nontox and petroclean.

In various embodiments, the alkyl ester can be a linear or branched ester. In various embodiments, the alkyl ester can be a lower alkyl ester or higher alkyl ester. The ester can be a methyl ester, ethyl ester, propyl ester, butyl ester, pentyl ester, or hexyl ester. In various embodiments, the alkyl ester can be a C₁-C₁₂ alkyl ester. The can be substituted with C₁-C₁₂ alkyl groups at any carbon.

In some aspects, the composition is used in the initial stage of in-situ remediation. The composition can be used to clean and remove plumes of hydrocarbon contaminants under buildings, highways and subsurface debris. The composition allows desorption of soils without producing heavy emulsions. This enables full plume control, captures free product and frees unknown pockets of hydrocarbon contaminant mass.

In various embodiments, the composition is added in one part composition per 25-500 parts water. In one example, one part of the remedial mix is added to 100 parts water for light chain hydrocarbons (e.g. gasoline and diesel fuel). In other embodiments such as for heavy chain hydrocarbons (e.g. oil), the composition is added one part in 50 parts water.

In various embodiments, the remediation composition can include a carbon source which aids bacterial growth. The carbon source can aid bacterial growth. In various aspects, the compositions disclosed herein can adhere to the hydrocarbon binding site, lowering the hydrocarbons adhesion properties and allowing indigenous bacteria to capture and digest the hydrocarbon contaminants. The by-products include carbon dioxide and water.

Additional Components

The injection fluid may contain, in addition to the described hydrocarbon removal composition or remediation composition, other compounds used in hydrocarbon production including but not limited to corrosion inhibitors, acids, dispersants, viscosifiers, lubricity agents.

In some aspects, additional components of the hydrocarbon removal composition or remediation composition can include an additional surfactant. The surfactant can be selected based on its hydrophobic-lipophilic balance (HLB) number to correspond to the intended use. When the hydrocarbon removal composition used as a flowback agent, the HLB of the additional surfactant can be high, reflecting its hydrophilic, lipophobic character. Alternatively, when the hydrocarbon removal composition used as a viscous slurry, the HLB of the additional surfactant is low reflecting its more hydrophobic character. In various aspects, the HLB number of the total composition for a guar slurry is greater than 12. In some instances, the HLB of the guar slurry is greater than 13. In specific instances, the HLB of the guar slurry is greater than 14. Examples of additional commercial surfactants include Lumizorb and the ethoxylated tridecyl alcohol TDA-9.

In some aspects, soluble borate can be added to guar slurry embodiments. The temperature stability of fracturing fluids containing galactomannans polymers is increased by adding a soluble borate. This provides a source of boron for solubilizing at elevated temperatures, thus enhancing the crosslinking of the galactomannans polymer. Once the guar slurry reaches the desired viscosity, a proppant can be added to keep the fractures from closing.

To reduce the pour point of various aqueous products, glycerin or propylene glycol can be added. In some embodiments, a 50/50 glycerin/water mixture is added.

To reduce the foaming characteristics of the product, antifoam 8810 FG, food grade simethicone can be added. Various concentrations known in the art can be used, for example from 2-5%.

### EXAMPLES

The following examples illustrate various aspects of the disclosure. It will be apparent to those skilled in the art that many modifications, both to materials and methods, may be practiced without departing from the scope of the disclosure.

### Example 1A

### Optimization of Formulation Components and Ratios

A detergent, an ethoxylated wetting agent, and three different sorbitan emulsifiers (labeled 1-3) were combined in different quantities in Sample Formulations A-J according to Table A. For each sample formulation, each product was introduced to an off-the-counter mixer and mixed under medium shear thoroughly at medium shear. The remaining chemicals were added and mixed until the resulting formulation was a consistent color and exhibited only one phase for a five-minute duration.

TABLE A

| Component | Sample Formulation | | | | | | | | | |
|---|---|---|---|---|---|---|---|---|---|---|
| (% by volume) | A | B | C | D | E | F | G | H | I | J |
| Detergent | 25 | 25 | 20 | 33 | | 50 | 40 | 40 | 45 | 45 |
| Ethoxylated | 25 | 25 | 20 | | 33 | 50 | 33 | | 33 | 33 |
| Wetting Agent | | | | | | | | | | |
| Sorbitan | 25 | | 20 | 33 | | | | 33 | 22 | |
| Emulsifier A | | | | | | | | | | |
| Sorbitan | | 25 | 20 | | 33 | | 33 | 33 | | 22 |
| Emulsifier B | | | | | | | | | | |
| Sorbitan | 25 | 25 | 20 | 33 | 33 | | | | | |
| Emulsifier C | | | | | | | | | | |

Each sample formulation was allowed to stand for 24 hours, after which time the following visual observations of phase separation were made.

Sample Formulations A, B, C, D and E exhibited phase separation. Sample Formulations F, G, H, I and J did not exhibit phase separation. Sample Formulations A, B, C, D and E contained sorbitan emulsifier 3, but none of Sample Formulations F, G, H, I and J contained sorbitan emulsifier 3, indicating that sorbitan emulsifier 3 resulted in phase separation. Sample Formulations A, B, C, D and E were not further refined.

Sample Formulations F, G, H, I and J were then tested for their ability to clean oil from sand. For each sample formulation, 5 ml of #6 crude (bunker C) oil was added to 20 g of beach sand and mixed thoroughly. The resulting mixture was placed in a 500 ml Erlenmeyer flask. For each sample formulation, a 5% v/v solution of a sample formulation in 200 ml water was added to a flask containing the oil and sand blend. Each Erlenmeyer flask was hand swirled for 10 minutes and allowed to settle for 10 minutes. Each supernatant was then poured off. The resulting sand was scored on a 10-point scale reflecting how clean (i.e. free of oil) the remaining sand was. On the scale, a score of “1” indicates that the sand was not clean (i.e. all or substantially all of the oil remained) and a score of “10” indicates that the sand was very clean (i.e. no or substantially no oil remained). Results are presented in Table B.

TABLE B

| Sample | | |
|---|---|---|
| Formulation | Observations | Score |
| F | oil spotting on flask; stringy oil tendrils permeated | 2 |
| | to oil/water interphase | |
| G | clean sand; emulsion would not easily break | 7 |
| H | oil spotting on flask; stringy oil tendrils permeated | 4 |
| | to oil/water interphase | |
| I | semi-clean sand; emulsion would not easily break | 6 |
| J | clean sand; emulsion would not easily break | 9 |

Of Sample Formulations F, G, H, I and J, Sample Formulation J exhibited the best characteristics, based on the results presented in Table B.

Additionally, it was observed that none of the sample formulations released the oil out of solution. The flocculant Al(OH)₃ was added to help release the oil from each sample formulation.

### Example 1B

### Replacement of Detergent

The detergent in Sample Formulation J was replaced with a different detergent based on stability emulsification properties. The resulting formulation (i.e. 45% detergent, 33% ethoxylated wetting agent, and 22% sorbitan emulsifier (v/v)) (hereinafter “Sample Formulation K”) was tested for its ability to clean oil from sand as described in Example 1A. Sample Formulation K cleaned the sand as well as Sample Formulation J. Sample Formulation K also released oil from the sand without the addition of a flocculant.

### Example 1C

### Testing of Formulation Concentration

Various concentrations of Sample Formulation K were tested for their ability to clean oil from sand. For each formulation solution, 5 ml of #6 crude (bunker C) oil was added to 20 g of beach sand and mixed thoroughly. The resulting mixture was placed in a 500 ml Erlenmeyer flask. Various amounts of Sample Formulation K were added to 200 ml of tap water to produce Sample Formulation K solutions at various concentrations, as presented in Table C.

Each formulation solution was added to a flask containing the oil and sand blend. Each Erlenmeyer flask was hand swirled for 10 minutes and allowed to settle for 10 minutes. Each supernatant was then poured off. The resulting sand was scored on a 10-point scale reflecting how clean (i.e. free of oil) the remaining sand was. On the scale, a score of “1” indicates that the sand was not clean (i.e. all or substantially all of the oil remained) and a score of “10” indicates that the sand was very clean (i.e. no or substantially no oil remained). Results are presented in Table C.

TABLE C

| Sample | | |
|---|---|---|
| Formulation K | | |
| (% v/v) | Observations | Score |
| .10 | sand was not clean; very little foam | 1 |
| .50 | sand was slightly cleaned; small amount of oil | 2 |
| | recovered; foam | |
| 1 | sand mostly cleaned; some oil recovered; foam | 7 |
| 2 | sand cleaned; oil recovered; foam | 10 |
| 3 | sand cleaned; oil strings present; oil recovered; | 9 |
| | foam | |
| 5 | sand cleaned; oil strings present; foam | 8 |
| 7 | sand cleaned; oil strings present; foam | 8 |
| 10 | sand cleaned; oil strings present; emulsion | 8 |
| | slower to release; foam | |

Only the sand-oil-formulation mixture with a 0.10% (v/v) solution of Sample Formulation K did not produce foam, which indicated that the concentration of Sample Formulation K was too low. Based on the results presented in Table C, the highest Sample Formulation K efficiency was a 2% (v/v) solution.

### Example 2A

### Compatibility of Sample Formulation with an Anionic Slurry Formulation

Biocides, borate delayed cross-linker, boric acid, clay stabilizers, delayed temperature activated cross-linker, guar, oxygen scavenger, scale inhibitors, and sodium thiosulfate were combined to form a guar slurry. 0.53% of Sample Formulation K was added to the slurry. The slurry was run on a Grace 5600 HPHC rheometer.

The various components of the gaur slurry are 0.5 gpt DBMPA (biocide), 0.25 gpt scale corrosion inhibitor, 2 gpt choline chloride 70% (clay stabilizer), 3 gpt buffer KOH/KCO3, 0.5 gpt permanent clay stabilizer, 30% sodium thiosulfate (anionic surfactant for dispersion), 3 gpt ulexite slurry (delayed temperature dependent cross linker), 2 gpt delayed borate, 1 gpt surface borate, and 2 gpt Formulation K (hydrocarbon removal agent). The mineral oil used in guar slurry was ShellSol D80. It will be understood that with the exception of the hydrocarbon removal composition, various compositions can be substituted for the slurry as described in the art.

Results are presented in FIG. 1A. Sample Formulation K did not affect cross-link viscosity, which indicates complete compatibility with the anionic slurry formulation.

### Example 2B

### Comparison of Dry Guar Formulations with Sample Formulation K Formulations

Samples of a dry guar hydration with and without Sample Formulation K (see FIG. 1B); dry guar hydration and slurry hydration (see FIG. 1C); and base slurry formulation and Sample Formulation K super slurry were run on a Grace 3600 rheometer/viscometer for hydration testing (see FIGS. 1D and 1E). Results are presented in FIGS. 1B-1F as viscosity versus time graphs. Three different experiments, labeled T1, T2, and T3 were conducted.

In FIG. 1B, the dry guar with 0.1 gpt measured approximately 31 mPa·s at T₀ and increased to approximately 37 mPa·s at 10 minutes. By contrast, the dry guar hydration measured approximately 28 mPa·s at T₀ and increased to approximately 34.5 mPa·s at 10 minutes.

In FIG. 1C the super slurry exhibited 1-2 cP greater than the dry guar hydration during the entire 10-minute time course. In FIG. 1D, the super slurry exhibited 1-2 cP greater than the base slurry starting at approximately 4 minutes and continuing for the remainder of the 30-minute time course.

In FIG. 1E, the super slurry measured approximately 44 cP at T₀ and increased to approximately 47.5 cP after 30 minutes. By contrast, the dry guar measured approximately 1 cP at T₀ and increased to approximately 44.5 cP after 30 minutes. Best-fit lines for the same data are presented in FIG. 1F.

The results presented in FIGS. 1B-1F demonstrate that Sample Formulation K increases hydration efficiency by fully cross-linking guar, which leads to higher viscosity and less formation unhydrated polymers during in blending. Increased viscosity provides for increased hydrocarbon production. The addition of Sample Formulation K allows for the use of 75% less detergent while consistently achieving 1-2 cps improvement over dry guar. Further, the addition of Sample Formulation K allows for the use of 0.4-0.9% less clay due to the ability of Sample Formulation K to fully cross-link guar, which leads to increased stability in the slurry. This translated to a savings of about USD $6000 for 68,500 g of guar slurry are also realized.

Still further, due to the ability of the Sample Formulation K super slurry to hydrate quickly and efficiently, the slurry can be prepared and concentrated with half the oil matrix and no guar. The remainder of the oil and guar are added on site and can be quickly blended and pumped into the wellbore. This method decreases cost of storage for the slurry as well as decreases transportation costs for the operator.

### Example 3A

### Comparison of Sample Formulation to Commercially Available Products

Sample Formulation K and at least 20 commercially available cleaning products, most of which contain harsh environmentally unfriendly chemicals, were each tested for their ability to clean oil from sand.

For each test sample, 5 ml of #6 crude (bunker C) oil was added to 20 g of beach sand. Two hundred ml of tap water was added to each oil-sand mixture. One ml of Sample Formulation K or 1 ml of a commercially available product was added to an oil-sand-water mixture, and then mixed in a low shear blender at 200 rpm for 10 minutes. Each supernatant was then poured off. The resulting sand was scored on a 10-point scale reflecting how clean (i.e. free of oil) the remaining sand was. On the scale, a score of “1” indicates that the sand was not clean (i.e. all or substantially all of the oil remained) and a score of “10” indicates that the sand was very clean (i.e. no or substantially no oil remained. Results are presented in Table D.

TABLE D

| Test Sample | Chemical Composition | Score |
|---|---|---|
| Sample Formulation K | | 10 |
| Formula 409 ® All-Purpose | Alkyl (40% C12, 50% C14, 10% C16) dimethyl benzyl, | 7 |
| Cleaner | ammonium chloride, Lauramine oxide. | |
| Clorox ® green works ® | alkyl polyglucoside, ethanol, potassium carbonate, potassium | 7 |
| | citrate. | |
| Dawn ® | Triclosan, water, magnesium, sodium dodecylbenzene | 4 |
| | sulfonate, ammonium laureth sulfate, lauryl polyglucose, | |
| | lauramidopropylanine oxide, SD Alcohol 3A, sodium xylene | |
| | sulfonate, sodium chloride, fragrance, pentasodium pentetate, | |
| | sodium bisulfite, quaternium 15, D&C Orange 4. | |
| Dawn ® + OxiClean ®? or Dawn ® | Sodium carbonate 30%-50%, Sodium carbonate peroxide | |
| Oxi | 50%-70% | |
| | Sodium | |
| Dove ® | Stearic acid, Sodium stearate, Trisodium etidronate, Sodium | 3 |
| | chloride | |
| | Sodium tallowate, Titanium dioxide, Sodium | |
| | dodecylbenzenesulfonate | |
| | Coconut fatty acids, Sodium cocoate, Sodium palm kernelate | |
| Fantastik ® All-Purpose Cleaner | C12,5% C18)dimethylbenzyl ammoniumchloride, D- | 5 |
| | glucopyranoside, C9-11alkyl, oligome, n- | |
| | Alkyl(60% C14,30% C16,5%, dimethylethylbenzylammonium | |
| Greased Lightning ® Orange | 1-(2-butoxy-1-methylethoxy)propan-2-ol, Undecan-1-ol, | 5 |
| Blast Super Strength Cleaner & | ethoxylated, R)-p-mentha-1,8-diene, Benzenesulfonic acid, | |
| Degreaser | C10-16-alkyl derivs | |
| Home Remedy Plus ™ | Isopropyl Alcohol, Ammonium Hydroxide | 5 |
| Tide ® liquid detergent | Ethyl alcohol, 2-Aminoethanol, Anionic Surfactants | 5 |
| | (monoethanolamine salt), Nonionic Surfactants(Benzene | |
| | sulfonic acid). | |
| Lysol ® | Benzalkonium chloride, Ethanol, Potassium hydroxide, Lactic | 4 |
| | acid | |
| Method ® All-Purpose Cleaner | decyl glucoside, lauryl glucoside, sodium carbonate, sodium | 5 |
| | gluconate, lauryl ethoxylate, potassium citrate | |
| Mr. Clean ® Multi Surface | Alcohol Ethoxylate, Sodium Cumene Sulfonate, Sodium | 6 |
| | Citrate, Sodium Carbonate, Diethylenetriamine Pentaacetate, | |
| | sodium salt, Fatty acid, soap, Benzisothiazolinone | |
| non-tox | | 2 |
| organic kitchen cleaner | A proprietary mixture of fruit acids, natural proteins and water | 3 |
| Palmolive ® | Water, Ammonium C12-15 Pareth Sulfate, Magnesium | 4 |
| | Isododecylbenzenesulfonate, Lauramidopropylamine Oxide, | |
| | SD Alcohol 3-A, Sodium Xylenesulfonate, Sodium Chloride, | |
| | Fragrance, Pentasodium Pentetate, DMDM Hydantoin, | |
| | Sodium Bisulfite, D&C Orange No. 4 (active ingredients: | |
| | Triclosan 0.12%). | |
| Palmolive ® Oxy ™ Power | Ethanol/SD Alcohol 40, Pentasodium pentetate, Magnesium | 4 |
| Degreaser | sulfate, Sodium bisulfate, Sodium chloride, | |
| | Lauramidopropylamine oxide, Ammonium C12-15 Pareth | |
| | Sulfate, Poloxamer 124, | |
| Perfect Solution ® Cleaner- | | 5 |
| Degreaser | | |
| Pine-Sol ® Cleaner | Pine oil, Alkyl alcohol ethoxylates, Isopropyl alcohol, Sodium | 6 |
| | petroleum sulfonate. | |
| Purple Power ® | | 4 |
| Cleaner/Degreaser | | |
| Simple Green ® | | 9 |

Based on the results presented in Table C, Sample Formulation K exhibited superior cleaning performance compared to all commercial products tested.

### Example 3B

### Analysis of Sand Samples: Percent Oil Present

Samples of virgin sand, oil-contaminated sand, and cleaned sand were characterized to determine the amount of oil present. Testing was performed at the University of West Florida Mass Spectrometry Laboratory.

For each sand sample, the sand was packed in a glass column, which was eluted with acetone followed by methylene chloride. Following elution, both the column and the eluted material were weighed. The weight loss of the column and weight gain of the eluted material were used to determine the amount of original sand, the amount of water present in the sand, and the amount of oil remaining in the sand. The Partially Cleaned Sand and Further Cleaned Sand samples had each undergone a cleaning process and were wet. Results are presented in Table E.

TABLE E

| | Virgin | Oil-contaminated | Partially | Further |
|---|---|---|---|---|
| | Sand | Sand | Cleaned Sand | Cleaned Sand |
| % Water | ND | 0.3 | 26.7 | 22.5 |
| % Oil | 0.01 | 7.8 | 2.1 | 0.14 |

The samples were prepared as in Example 1, and they were washed three times.

### Example 3C

### Analysis of Sand Samples: Mass Spectrometry

Samples of virgin sand, oil-contaminated sand, and cleaned sand were characterized to determine the amount of oil present. Testing was performed at the University of West Florida Mass Spectrometry Laboratory.

Each sand sample was analyzed by direct probe mass spectrometry. Several micrograms of a given sand sample were placed in a miniature glass vial. The vial was inserted into a heated direct insertion probe and taken into the ion source of a Finnigan 4500 mass spectrometer. The probe was heated from room temperature to 350° C. in three minutes. The ion source of the mass spectrometer was operated in the chemical ionization mode using methane as the reagent gas. Scans were collected every 0.25 seconds covering a mass range of 50 to 700 Daltons. Data was collected and reduced using a ProLabs Vector 2 system.

Results are presented in FIGS. 2-6. FIG. 2 shows the results for the Virgin Sand sample. Only at low probe temperatures is a limited amount of material present, which is likely related to the minimal biological material in the sand.

FIG. 3 shows the results for the Contaminated Sand sample. The contaminated sand exhibits the classic patterns of lower (m/z 71, 85) and higher (m/z 197) molecular weight alkanes as well as cyclic hydrocarbons (m/z 207).

FIG. 4 shows the results for the Partially Cleaned Sand sample. The Partially Cleaned Sand sample exhibits the same pattern of alkanes and cyclic hydrocarbons as for the Contaminated Sand sample in FIG. 3, but at reduced levels.

FIG. 5 shows the results for the Further Cleaned Sand sample. The pattern of alkanes and cyclic hydrocarbons are significantly reduced as compared to FIGS. 3 and 4. These results are consistent with the results shown in Table E.

FIG. 6 shows the results for Sample Formulation K when used to clean the sand. The spectrum for this agent shows a classic pattern for an ethoxylated compound, which is characterized by the repeating ethoxylation of a base molecule (m/z 261, 305, 349, 393, 437). This pattern was not observed for any of the sand samples (i.e. FIGS. 2-5), which indicates that the components of Formulation K are not present in virgin sand or contaminated sand, nor is Formulation K left behind on the sand after being used to clean the sand.

What is claimed is:

1. A hydrocarbon removal composition comprising:
a sorbitan emulsifier,
an ethoxylated wetting agent, and
a detergent.

2. The hydrocarbon removal composition of claim 1 further comprising water.

3. The hydrocarbon removal composition according to claim 1, wherein the sorbitan emulsifier is from about 10 to 35% w/w of the total composition.

4. The hydrocarbon removal composition according to claim 1, wherein ethoxylated wetting agent is from about 20 to 40 w/w % of the composition.

5. The hydrocarbon removal composition according to claim 1, wherein the detergent is from about 10 to 35 w/w % of the composition.

6. The hydrocarbon removal composition according to claim 1, wherein the isopropylamine linear alkylbenzene sulfonate provided in a ratio of 10-30% w/w.

7. The hydrocarbon removal composition according to claim 1, wherein ethoxylated alcohol is in a ratio of 30-50% w/w.

8. The hydrocarbon removal composition according to claim 1, wherein the polyoxyethylene (20) sorbitan monooleateis provided in a ratio of 30-50% w/w.

9. The hydrocarbon removal composition according to claim 1, further comprising potassium chloride, sodium chloride, or brine.

10. The hydrocarbon removal composition according to claim 1, further comprising hydrocarbons.

11. A guar slurry comprising guar and a hydrocarbon removal composition according to claim 1.

12. A slurry comprising an oil a hydrocarbon removal composition according to claim 1.

13. A composition comprising the hydrocarbon removal composition and a hydrocarbon.

14. A method of removing hydrocarbons comprising:
adding a hydrocarbon removal composition according to claim 1 to a well;
removing hydrocarbons from the well.

15. The method according to claim 14, wherein the hydrocarbon removal composition is provided in an injection fluid.

16. The method according to claim 15, wherein the hydrocarbon removal composition is at a concentration of greater than 1 part per thousand per total fluid volume and less than 5 parts per thousand per total fluid volume.
